(19) United States
(12) Patent Application Publication
(10) Pub. No.: US 2011/0246675 A1
(43) Pub. Date: Oct. 6, 2011

(54) DATA PROCESSING APPARATUS, SYSTEM THEREOF, METHOD THEREOF, AND RECORDING MEDIUM IN WHICH THAT PROGRAM HAS BEEN RECORDED

(75) Inventor: Yukihiro Fukami, Kanagawa (JP)

(73) Assignee: PIONEER CORPORATION, Kawasaki-shi, Kanagawa (JP)

(21) Appl. No.: 13/132,147

(22) PCT Filed: Nov. 24, 2009
(86) PCT No.: PCT/JP2009/069811

§ 371 Date: Jun. 21, 2011

(30) Foreign Application Priority Data
Dec. 1, 2008 (JP) PCT/JP2008/071805

(51) Int. Cl. G06F 13/14

(52) U.S. Cl. 710/8

(57) ABSTRACT

Upon receipt of CEC frame data from a PDP, a first radio unit of an HDMI system refers to the content of a reception-side logical address area and recognizes that the destination of this CEC frame data is a second BDP among a plurality of devices connected to a second radio unit. When the first radio unit recognizes that the second BDP is connected to the second radio unit based on second logical address information of a shared device list, the first radio unit substitutes for the second BDP to give an ACK response for reporting the reception of the CEC frame data by the second BDP, and also sends the CEC frame data to the second BDP.

### TECHNICAL FIELD

The present invention relates to a data processor, a system therefor, a method therefor, a program therefor, and a storage medium storing the program.

### BACKGROUND ART

There has been typically known an arrangement for executing processing based on a CEC (Consumer Electronics Control) frame format complying with the HDMI (High-Definition Multimedia Interface) standard (see, e.g., Patent Literatures 1 and 2).

Patent Literature 1 discloses a radio communication system including a source unit and a sink unit. The source unit includes a controller, a ROM, a RAM, a DVD player, a CEC controller, a radio transmitting/receiving circuit and an antenna. The sink unit includes a controller, a ROM, a speaker, a display, a CEC controller, a radio transmitting/receiving circuit, an antenna, a RAM and a processing circuit for audio signals and video signals.

After receiving a wireless packet from the source unit, the sink unit wirelessly sends a wireless ACK packet to the source unit when the logical address of the destination contained in the received CEC frame data coincides with the local logical address of the sink unit. Since each of the source unit and the sink unit disclosed in Patent Literature 1 has an arrangement in which the CEC device, the CEC controller and the radio transmitting/receiving circuit are integrally provided (hereinafter referred to as “integral type”), the radio transmitting/receiving circuit can easily recognize the local logical address in the source unit or sink unit.

Patent Literature 1 also discloses an arrangement in which each of the source unit and the sink unit is separately provided from the radio transmitting/receiving circuit (hereinafter referred to as “separate type”).

Patent Literature 2 discloses a technique used when a radio system is provided in a wired CEC network so as to allow CEC devices to acquire respective logical addresses, which are essential for CEC communication, without any duplication.

According to an arrangement disclosed in Patent Literature 3, there is disclosed a technique in which even when the same address as that of a terminal 1 of a network 1 exists in a terminal 2 of a network 2, a relay unit between the network 1 and the network 2 is allowed to realize normal communication between the terminal 1 of the network 1 and the terminal 2 of the network 2 without altering the default address of the terminal 2 (the detail of this technique is as follows). Specifically, it is disclosed that the address of the terminal 2 of the network 2 is replaced with another address and the replaced address is stored in association with the address existing in the network 2 so that when the terminal 1 of the network 1 sends a packet the destination of which is the replaced terminal 2 of the network 2, the relay device sends the packet to the terminal 2 of the network 2 associated with the replaced address by replacing the destination address with the address existing in the network 2 associated with the replaced address.

### CITATION LIST

### Patent Literatures

Patent Literature 1: JP-A-2008-109711
Patent Literature 2: JP-A-2008-295069
Patent Literature 3: JP-A-2008-148243

### SUMMARY OF THE INVENTION

### Problems to be Solved by the Invention

In the integral type as disclosed in Patent Literature 1, when there are a plurality of sink devices, all the sink devices are necessarily provided with respective radio transmitting/receiving circuits, which complicates the arrangement of each sink device.

Further, in the integral type, it is disclosed that when a radio transmitting/receiving device connected to a source-side CEC signal line receives a CEC signal directed to a sink-side CEC signal line from the source-side CEC signal line, the radio transmitting/receiving device connected to the source-side CEC signal line converts the received CEC signal into a wireless data packet and transfers it to the radio transmitting/receiving device connected to the sink-side CEC signal line, and when receiving a wireless ACK packet from the radio transmitting/receiving device connected to sink-side CEC signal line, the radio transmitting/receiving device connected to the sink-side CEC signal line sends an ACK signal back to the source-side CEC signal line. In such a method, however, since an ACK signal is sent back before the sink-side CEC device specified by the CEC signal responses, the response is given before the logical address of the sink-side CEC device is unconfirmed.

In contrast, a separate type as disclosed in Patent Literature 1 requires an interface for confirming the logical address of a CEC device. As a method of interface, a radio transmitting/receiving circuit connected to a CEC device via a CEC signal line is thought about. In this case, when the radio transmitting/receiving circuit receives a wireless packet from a different radio transmitting/receiving circuit, the radio transmitting/receiving circuit needs to convert the received wireless packet into a CEC signal and to transfer it to the CEC signal line for confirming whether or not the logical address of the destination of the received CEC frame data coincides with the logical address of the CEC device connected to the CEC signal line. When an ACK signal is sent back in response to such a CEC signal, the radio transmitting/receiving circuit wirelessly sends a wireless ACK packet to the different radio transmitting/receiving circuit.

According to the above manner, when receiving the wireless packet from the different radio transmitting/receiving device, the radio transmitting/receiving device connected to a sink unit-side CEC signal line converts the received wireless packet into a CEC signal and sends it to the sink-side CEC signal line. When an ACK signal is sent back in response to the CEC signal, the radio transmitting/receiving circuit wirelessly sends a wireless ACK packet to the different radio transmitting/receiving circuit.

Such a long process makes responsivity poor.

Further, when the different radio transmitting/receiving device is connected to a source-side CEC signal line and a CEC signal directed to the sink-side CEC signal line is sent from the source-side CEC signal line to the CEC signal line, the process becomes longer. Specifically, when a CEC signal is sent to the source-side CEC signal line, the radio transmitting/receiving device connected to the source-side CEC signal line converts this CEC signal into a wireless packet and wirelessly sends it to the radio transmitting/receiving device connected to the sink-side CEC signal line. When receiving the wireless packet, the radio transmitting/receiving device connected to the sink-side CEC signal line converts the wireless packet into a CEC signal and sends it to the sink-side CEC signal line. When an ACK signal is sent back in response to the CEC signal, the radio transmitting/receiving device connected to the sink-side CEC signal line sends a wireless ACK packet to the radio transmitting/receiving device connected to the source-side CEC signal line. When receiving the wireless ACK packet, the radio transmitting/receiving device connected to the source-side CEC signal line waits for the CEC signal first received by the source-side CEC line to be resent, and then sends back an ACK signal in response to the resent CEC signal. In addition to such a poor responsivity, the CEC device that first sent a CEC signal directed to the sink-side CEC signal line from the source-side CEC signal line has to resend the CEC signal after waiting for 12 msec or more because no ACK signal is sent back in response to the first-sent CEC signal. When no ACK signal is sent back even after the CEC signal is resent at a predetermined number of times, the CEC signal is discarded. Thus, if the radio transmitting/receiving device connected to the source-side CEC signal line receives a wireless ACK packet in response to the first CEC signal but this CEC signal has been discarded by the time of the reception of the wireless ACK packet, the ACK signal cannot be sent back to the source-side CEC signal line.

The above problems are not limited to data packet communication between radio transmitting/receiving devices.

Assuming that there are provided a first CEC signal line and a second CEC signal line disconnected from the first CEC signal line, the above problems are caused when communication between a first transmitting/receiving device connected to the first CEC signal line and a second transmitting/receiving device connected to the second CEC signal line is performed so as to transfer a CEC signal sent to the first CEC signal line to the second CEC signal line. A communication line provided between the first transmitting/receiving device and the second transmitting/receiving device may be radio communication, optical communication or any other cable communication, which is different from a CEC signal line.

According to an arrangement disclosed in Patent Literature 2, a unit for managing the respective logical addresses of CEC devices recognizes each device at a timing when the device is newly connected to acquire a physical address and a logical address and automatically sends a report physical address command. The timing is thus limited. Thus, when a device for managing a logical address list is turned on afterward, no report physical address command may be acquired.

In view of the above, this arrangement requires a user to install, connect and start devices in a restricted order, which considerably annoys the user. In addition, this arrangement is not likely to solve the above problem of Patent Literature 2 such as assigning logical addresses without any duplication.

According to the arrangement disclosed in Patent Literature 3, what is selected as the replaced address is an available address on the assumption that the terminal 2 of the network 2 acquires an address in the network 1. In other words, the replaced address is assumably an unused address in the network 1. However, in the situation where the network 1 has “Address 1” while the network 2 does not have “Address 1”, when “Address 1” is selected as the replaced address, further address duplication, i.e., duplication between the existing address in the network 2 and the replaced address, may be caused. Patent Literature 3 provides examples of how a user (e.g., a network manager) sets a method and/or process for finding and specifying the replaced address and a method and/or process for storing the replaced address and the existing address in association with each other based on a manual using GUI or the like. However, Patent Literature 3 fails to clearly provide specific details regarding automatic selection and/or automatic generation. Patent Literature 3 is thus ambiguous.

The addresses described above are IP addresses mainly in Patent Literature 3. Thus, it is a general way (and the easiest way) to use a value obtained by adding the existing address value with 1 (increment) as a value newly assigned as the replaced address. However, since the addresses for HDMI CEC communication are selected from available addresses determined depending on the production categories of devices, the selected addresses need to be unused and to correspond to the production categories, which requires an additional determining process. In view of the above, in application to HDMI CEC communication protocol, an address that should not have been acquired is likely to be acquired as the replaced address.

Further, in Patent Literature 3, when communication from the terminal 1 of the network 1 to the terminal 2 of the network 2, the terminal 1 of the network 1 requires a pre-communication process for making an inquiry to the relay unit that stores a table for replacement so as to set the address of the terminal 2 of the network 2 (i.e., the destination) in a communication packet, so that a lot of steps are required before an actual communication is started. In view of the above, the arrangement of Patent Literature 3 is time-consumable, complicated and annoying.

An object of the invention is to provide a data processor, a system therefor, a method therefor, a program therefor, and a storage medium that stores the program, the data processor being capable of receiving an ACK response in response to processing data sent from a first device with high responsivity without a complicated arrangement and appropriately sending the processing data to a predetermined one of a plurality of second devices. Another object of the invention is to provide a data processor, a system therefor, a method therefor, a program therefor, and a storage medium that stores the program, the data processor unessentially preventing duplication between logical addresses when a radio system is provided in a wired CEC network and being capable of overcoming the above problems and allowing devices to perform CEC communication without any user's particular operation. Still another object of the invention is to provide a data processor, a system therefor, a method therefor, a program therefor, and a storage medium that stores the program, the data processor being capable of overcoming the above problems and rapidly performing an address replacing process without annoying a user even when some CEC devices in an entire network are necessarily assigned with duplicate logical addresses for allowing the devices to smoothly perform CEC communication without any user's particular operation.

### Means for Solving the Problems

According to an aspect of the invention, a data processor that receives CEC frame data containing second device information specifying a second device designated as a destination from a first device as processing data, and sends the processing data to a predetermined one of a plurality of second devices adapted to perform a process based on the processing data, first device information specifying the first device and the second device information each having one of a plurality of contents preset depending on types of the first device and the second devices, the data processor includes: a processing-side memory storing the first device information and the second device information; a reset command generator recognizing whether or not there is any second device information having the same content as a content of the first device information in the processing-side memory, and generating a first reset command to instruct the first device specified by the first device information having the same content as the content of the second device information to reacquire the first device information or generating a second reset command to instruct the second device specified by the second device information having the same content as the content of the first device information to reacquire the first device information; and a reset command transmitter transmitting the first reset command to the first device corresponding to the first reset command or transmitting the second reset command to the second device corresponding to the second reset command.

According to another aspect of the invention, a data processor that receives CEC frame data containing second device information specifying a second device designated as a destination from a first device as processing data, and sends the processing data to a predetermined one of a plurality of second devices adapted to perform a process based on the processing data, first device information specifying the first device and the second device information each having one of a plurality of contents preset depending on types of the first device and the second devices, the data processor includes: a processing-side memory storing the first device information and the second device information; a replaced information association processor recognizing whether or not there is any second device information having the same content as a content of the first device information in the processing-side memory, and instructing the processing-side memory to store the second device information having the same content in association with replaced second device information obtained by replacing the content of the second device information with another content preset for the type of the second device specified by the second device information; a data receiver receiving the processing data from the first device; an ACK response substitution executor operating when the data receiver receives the processing data and the second device information contained in the processing data is included in the processing-side memory to give an ACK response for reporting reception of the processing data by the second device specified by the second device information in place of the second device specified by the second device information; and a data transmitter transmitting the processing data received by the data receiver to the second device specified by the second device information, in which the first device transmits processing data containing non-replaced second device information being not associated with the replaced second device information or containing the replaced second device information, the ACK response substitution executor operates when the processing data received by the data receiver contains the non-replaced second device information to give the ACK response for reporting reception of the processing data by the second device specified by the non-replaced second device information, and operates when the received processing data contains the replaced second device information to give the ACK response for reporting reception of the processing data by the second device specified by the second device information associated with the replaced second device information, and the data transmitter operates when the received processing data contains the non-replaced second device information to transmit the processing data to the second device specified by the non-replaced second device information, and operates when the received processing data contains the replaced second device information to transmit the processing data to the second device specified by the second device information associated with the replaced second device information.

According to still another aspect of the invention, a data processor that receives CEC frame data containing second device information specifying a second device designated as a destination from a first device as processing data, and sends the processing data to a predetermined one of a plurality of second devices adapted to perform a process based on the processing data, first device information specifying the first device and the second device information each having one of a plurality of contents preset depending on types of the first device and the second devices, the data processor includes: a processing-side memory storing the first device information and the second device information; and a hotplug processor recognizing whether or not there is any second device information having the same content as a content of the first device information in the processing-side memory, and switching a hotplug of the first device specified by the first device information having the same content as the content of the second device information or the second device specified by the second device information having the same content of the content of the first device information from HIGH to LOW for a predetermined period of time.

According to still another aspect of the invention, a data processing system includes: a data transfer device including a data transferer that receives CEC frame data containing second device information specifying a second device designated as a destination from a first device as processing data and is connected to a plurality of second devices adapted to perform a process based on the processing data to transfer the processing data to one of the second devices specified by the second device information; and one of the above data processors being connected to the first device and the data transfer device to send the processing data from the first device to the second device via the data transfer device.

According to still another aspect of the invention, a data processing method for receiving CEC frame data containing second device information specifying a second device designated as a destination from a first device as processing data and sending the processing data to a predetermined one of a plurality of second devices adapted to perform a process based on the processing data by using a computer, first device information specifying the first device and the second device information each having one of a plurality of contents preset depending on types of the first device and the second devices, the computer including a processing-side memory storing the first device information and the second device information, the method includes: a rest command generating step recognizing whether or not there is any second device information having the same content as a content of the first device information, and generating a first reset command to instruct the first device specified by the first device information having the same content as the content of the second device information to reacquire the first device information or generating a second reset command to instruct the second device specified by the second device information having the same content as the content of the first device information to reacquire the first device information; and a reset command transmitting step transmitting the first reset command to the first device corresponding to the first reset command or transmitting the second reset command to the second device corresponding to the second reset command.

According to still another aspect of the invention, a data processing method for receiving CEC frame data containing second device information specifying a second device designated as a destination from a first device as processing data and sending the processing data to a predetermined one of a plurality of second devices adapted to perform a process based on the processing data by using a computer, first device information specifying the first device and the second device information each having one of a plurality of contents preset depending on types of the first device and the second devices, the computer including a processing-side memory storing the first device information and the second device information, the method includes: a replaced information association processing step recognizing whether or not there is any second device information having the same content as a content of the first device information in the processing-side memory, and instructing the processing-side memory to store the second device information having the same content in association with replaced second device information obtained by replacing the content of the second device information with another content preset for the type of the second device specified by the second device information; a data receiving step receiving the processing data from the first device; an ACK response substitution executing step giving an ACK response for reporting reception of the processing data by the second device specified by the second device information in place of the second device when the processing data is received in the data receiving step and the second device information contained in the processing data is included in the processing-side memory; and a data transmitting step transmitting the processing data received in the data receiving step to the second device specified by the second device information, in which the first device transmits processing data containing non-replaced second device information being not associated with the replaced second device information or containing the replaced second device information, in the ACK response substitution executing step, the ACK response for reporting reception of the processing data by the second device specified by the non-replaced second device information is given when the processing data received by the data receiver contains the non-replaced second device information, and the ACK response for reporting reception of the processing data by the second device specified by the second device information associated with the replaced second device information is given when the received processing data contains the replaced second device information, and in the data transmitting step, the processing data is transmitted to the second device specified by the non-replaced second device information when the received processing data contains the non-replaced second device information, and the processing data is transmitted to the second device specified by the second device information associated with the replaced second device information when the received processing data contains the replaced second device information.

According to still another aspect of the invention, a data processing method for receiving CEC frame data containing second device information specifying a second device designated as a destination from a first device as processing data and sending the processing data to a predetermined one of a plurality of second devices adapted to perform a process based on the processing data by using a computer, first device information specifying the first device and the second device information each having one of a plurality of contents preset depending on types of the first device and the second devices, the computer including a processing-side memory storing the first device information and the second device information, the method includes a hotplug processing step recognizing whether or not there is any second device information having the same content as a content of the first device information in the processing-side memory, and switching a hotplug of the first device specified by the first device information having the same content as the content of the second device information or the second device specified by the second device information having the same content of the content of the first device information from HIGH to LOW for a predetermined period of time.

According to still another aspect of the invention, a data processing program allows a computer to perform one of the above data processing methods.

According to still another aspect of the invention, a data processing program allows a computer to function as one of the above data processors.

According to still another aspect of the invention, a storage medium stores the above data processing program in a computer-readable manner.

### BRIEF DESCRIPTION OF DRAWINGS

FIG. 1 schematically shows an arrangement of a logical address assignment information according to first to third exemplary embodiments of the invention.

FIG. 2 schematically shows CEC frame data according to the first to third exemplary embodiments of the invention.

FIG. 3 schematically shows a general arrangement of an HDMI system according to the first exemplary embodiment.

FIG. 4 is a block diagram showing a general arrangement of a first radio unit according to the first exemplary embodiment and the second and third exemplary embodiments of the invention.

FIG. 5 schematically shows a shared device list according to the first exemplary embodiment.

FIG. 6 is a block diagram showing a general arrangement of a second radio unit according to the first to third exemplary embodiments.

FIG. 7 schematically shows a device connection status and a logical address assignment status before the first radio unit and the second radio unit are connected according to the first to third exemplary embodiments.

FIG. 8 schematically shows a device connection status and a logical address assignment status after the first radio unit and the second radio unit are connected according to the first and second exemplary embodiments.

FIG. 9 is a timing chart showing an operation performed when the first radio unit and the second radio unit are connected according to the first exemplary embodiment.

FIG. 10 is a timing chart showing the operation performed when the first radio unit and the second radio unit are connected according to the first exemplary embodiment.

FIG. 11 is a timing chart showing the operation performed when the first radio unit and the second radio unit are connected according to the first exemplary embodiment.

FIG. 12 schematically shows a PDP recognition list according to the first exemplary embodiment.

FIG. 13 schematically shows a device connection status and a logical address assignment status before the first radio unit and a first BDP are connected or after the first radio unit and the first BDP are disconnected according to the first exemplary embodiment.

FIG. 14 schematically shows an updated status of the shared device list before the first radio unit and the first BDP are connected or after the first radio unit and the first BDP are disconnected according to the first exemplary embodiment.

FIG. 15 schematically shows a device connection status and a logical address assignment status after the first radio unit and the first BDP are connected and before the first radio unit and the first BDP are disconnected according to the first exemplary embodiment.

FIG. 16 schematically shows an updated status of the shared device list after the first radio unit and the first BDP are connected and before the first radio unit and the first BDP are disconnected according to the first exemplary embodiment.

FIG. 17 schematically shows a device connection status and a logical address assignment status before the second radio unit and a second BDP are connected or after the second radio unit and the second BDP are disconnected according to the first exemplary embodiment.

FIG. 18 schematically shows an updated status of the shared device list before the second radio unit and the second BDP are connected or after the second radio unit and the second BDP are disconnected according to the first exemplary embodiment.

FIG. 19 schematically shows a device connection status and a logical address assignment status after the second radio unit and the second BDP are connected and before the second radio unit and the second BDP are disconnected according to the first exemplary embodiment.

FIG. 20 schematically shows an updated status of the shared device list after the second radio unit and the second BDP are connected and before the second radio unit and the second BDP are disconnected according to the first exemplary embodiment.

FIG. 21 schematically shows a device connection status and a logical address assignment status when there is logical address duplication between first devices and second devices according to the first exemplary embodiment.

FIG. 22 schematically shows a shared device list generated when there is logical address duplication between the first devices and the second devices according to the first and second exemplary embodiments.

FIG. 23 is a timing chart showing an operation for sending and receiving the CEC frame data performed when there is no logical address duplication between the first devices and the second devices according to the first exemplary embodiment.

FIG. 24 is a timing chart showing an operation for sending and receiving the CEC frame data performed when there is logical address duplication between the first devices and the second devices according to the first exemplary embodiment.

FIG. 25 is a timing chart showing an operation performed when the first radio unit and the second radio unit are connected according to the second exemplary embodiment.

FIG. 26 is a timing chart showing the operation performed when the first radio, unit and the second radio unit are connected according to the second exemplary embodiment.

FIG. 27 is a timing chart showing the operation performed when the first radio unit and the second radio unit are connected according to the second exemplary embodiment.

FIG. 28 schematically shows a PDP recognition list according to the second exemplary embodiment.

FIG. 29 schematically shows a device connection status and a logical address assignment status before the first radio unit and the first BDP are connected or after the first radio unit and the first BDP are disconnected according to the second exemplary embodiment.

FIG. 30 schematically shows an updated status of the shared device list before the first radio unit and the first BDP are connected or after the first radio unit and the first BDP are disconnected according to the second exemplary embodiment.

FIG. 31 schematically shows a device connection status and a logical address assignment status after the first radio unit and the first BDP are connected and before the first radio unit and the first BDP are disconnected according to the second exemplary embodiment.

FIG. 32 schematically shows an updated status of the shared device list after the first radio unit and the first BDP are connected and before the first radio unit and the first BDP are disconnected according to the second exemplary embodiment.

FIG. 33 schematically shows a device connection status and a logical address assignment status before the second radio unit and the second BDP are connected or after the second radio unit and the second BDP are disconnected according to the second exemplary embodiment.

FIG. 34 schematically shows an updated status of the shared device list before the second radio unit and the second BDP are connected or after the second radio unit and the second BDP are disconnected according to the second exemplary embodiment.

FIG. 35 schematically shows a device connection status and a logical address assignment status after the second radio unit and the second BDP are connected and before the second radio unit and the second BDP are disconnected according to the second exemplary embodiment.

FIG. 36 schematically shows an updated status of the shared device list after the second radio unit and the second BDP are connected and before the second radio unit and the second BDP are disconnected according to the second exemplary embodiment.

FIG. 37 schematically shows a shared device list generated in relation to the first devices and the second devices according to the third exemplary embodiment.

FIG. 38 is a timing chart showing an operation performed when the first radio unit and the second radio unit are connected according to the third exemplary embodiment.

FIG. 39 schematically shows a device connection status and a logical address assignment status after the first radio unit and the second radio unit are connected according to the third exemplary embodiment.

FIG. 40 is a timing chart showing the operation performed when the first radio unit and the second radio unit are connected according to the third exemplary embodiment.

FIG. 41 is a timing chart showing the operation performed when the first radio unit and the second radio unit are connected according to the third exemplary embodiment.

FIG. 42 is a timing chart showing the operation performed when the first radio unit and the second radio unit are connected according to the third exemplary embodiment.

FIG. 43 is a timing chart showing the operation performed when the first radio unit and the second radio unit are connected according to the third exemplary embodiment.

FIG. 44 schematically shows a PDP recognition list according to the third exemplary embodiment.

### DESCRIPTION OF THE EXEMPLARY EMBODIMENTS

### First Exemplary Embodiment

A first exemplary embodiment of the invention will be described below with reference to the attached drawings.

In any of the first exemplary embodiment and the below-described second and third exemplary embodiments, a data processing system according to the invention is exemplified by an HDMI system adapted to perform processing based on a CEC (Consumer Electronics Control) frame format complying with the HDMI (High-Definition Multimedia Interface) standard.

### Arrangement of Logical Address Assignment Information

Initially, description will be made on an arrangement of logical address assignment information usable when devices in the HDMI system attempt to acquire respective logical addresses.

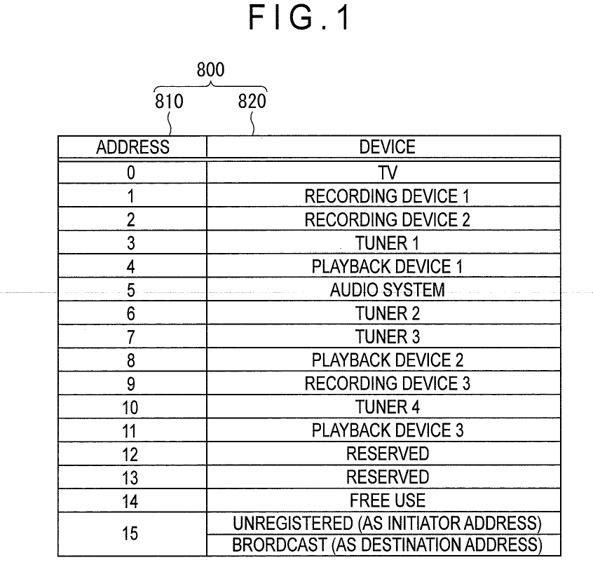

FIG. 1 schematically shows an arrangement of logical address assignment information.

As shown in FIG. 1, logical address assignment information 800 includes address information 810 showing logical addresses represented by numerals 0 to 15 and device information 820 showing devices to which the logical addresses in the address information 810 are to be assigned.

Based on the logical address assignment information 800, devices acquire logical addresses preset depending on the functions, respectively. Each device preferentially acquires the logical address having the smallest value among the logical addresses that are available but have not been acquired by other devices.

### Arrangement of CEC Frame Data

Next, description will be made on an arrangement of CEC frame data usable in the HDMI system.

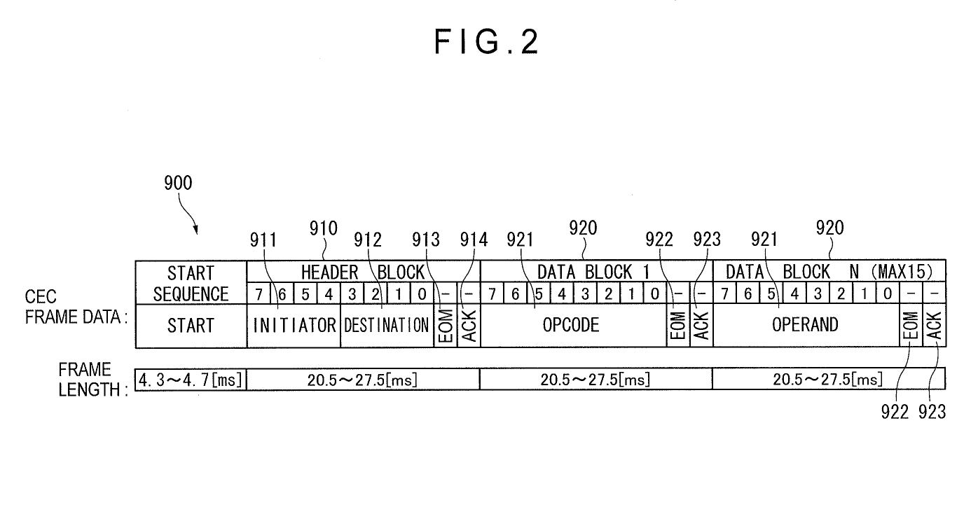

FIG. 2 schematically shows the CEC frame data.

As shown in FIG. 2, CEC frame data 900 as processing data includes a header block 910 and 0 to 15 of variable-length data block(s) 920.

The header block 910 includes a transmission-side logical address area 911, a reception-side logical address area 912, an EOM (End of Message) area 913 and an ACK area 914. Entered in the transmission-side logical address area 911 is a logical address as first device information for specifying an initiator device from which the CEC frame data 900 is sent. Entered in the transmission-side logical address area 912 is a logical address as second device information for specifying a destination device to which the CEC frame data 900 is sent. When the header block 910 is the last block in the CEC frame data 900, information indicating that the header block 910 is the last block is entered in the EOM area 913. The ACK area 914 is usable for performing an ACK response process for reporting the reception of the header block 910. The ACK response process is a process for keeping the ACK area 914 at high impedance (hereinafter also referred to as “HIGH”) during a predetermined period of time when a transmission-side device sends the CEC frame data 900, and fixing the ACK area 914 at low impedance (hereinafter also referred to as “LOW”) during the predetermined period of time when a reception-side device receives the CEC frame data 900. The transmission-side device performs monitoring through this period of time. When it is LOW, the transmission-side device recognizes that the reception-side device received (ACK response). When it is HIGH, the transmission-side device recognizes that the reception-side device did not receive (NACK response).

The data block 920 includes a command area 921, an EOM area 922 and an ACK area 923. In the command area 921, information regarding a command directed to the device is entered. In the EOM area 922 and the ACK area 923, contents similar to those of the EOM area 913 and the ACK area 914 are entered and processed, respectively. A command requiring a response is hereinafter referred to as a “CEC Give command” when described.

### Arrangement of HDMI System

Next, description will be made on an arrangement of the HDMI system.

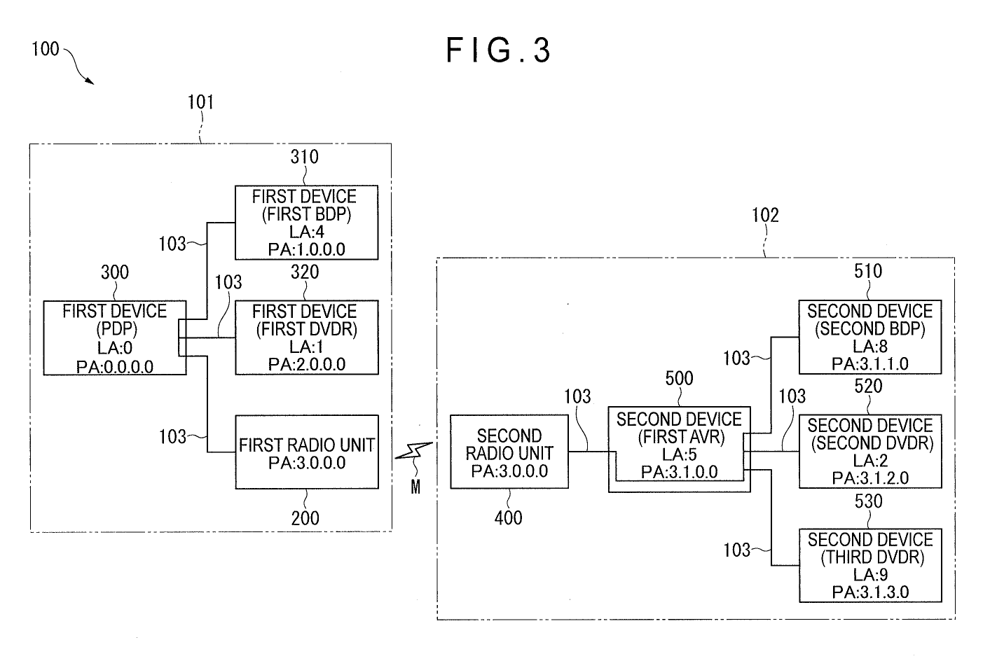

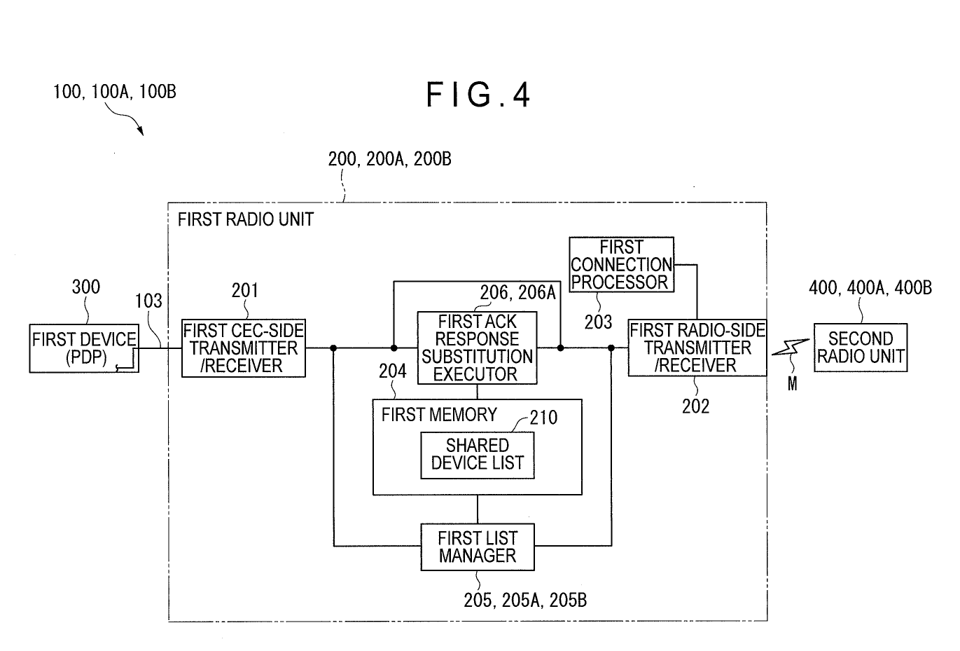

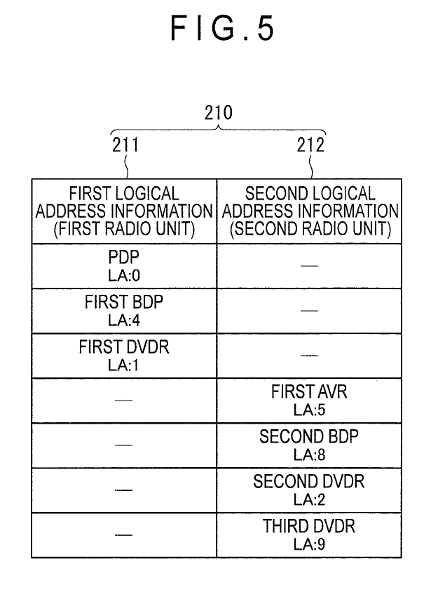

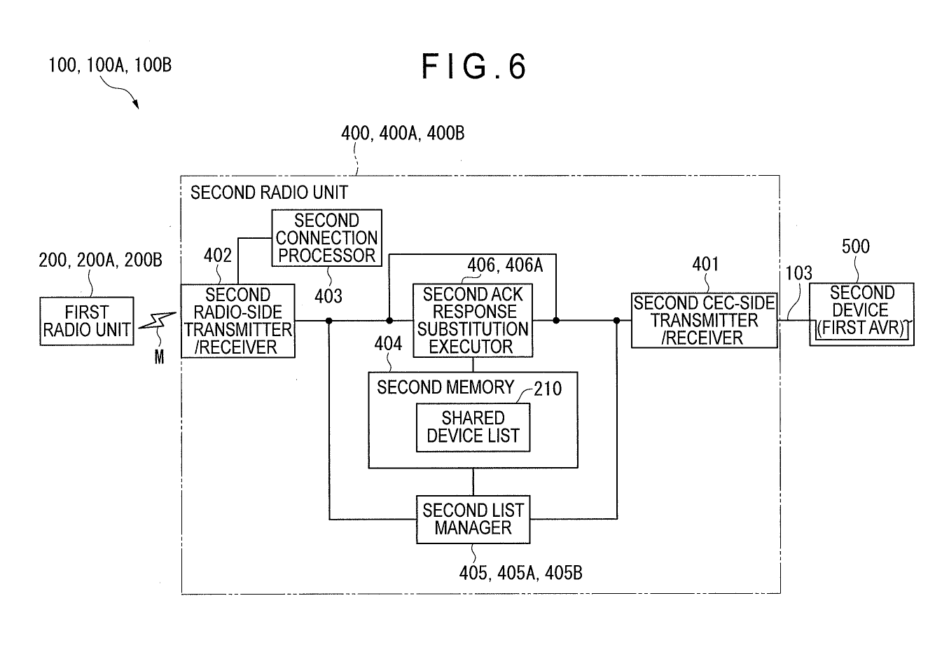

FIG. 3 schematically shows a general arrangement of the HDMI system. FIG. 4 is a block diagram showing a general arrangement of a first radio unit. FIG. 5 schematically shows a shared device list FIG. 6 is a block diagram showing a general arrangement of a second radio unit.

As shown in FIG. 3, an HDMI system 100 includes a first radio unit 200 as a data processor and a computer, first devices 300, 310 and 320, a second radio unit 400 as a data transfer device, and second devices 500, 510, 520 and 530.

The first devices 300, 310 and 320, being respectively a PDP (Plasma Display Panel), a first BDP (Blu-ray Disc Player) and a first DVDR (Digital Versatile Disc Recorder), are combined with the first radio unit 200 to provide a first CEC network 101. The second devices 500, 510, 520 and 530, being respectively a first AVR (Audio Visual Receiver), a second BDP, a second DVDR and a third DVDR, are combined with the second radio unit 400 to provide a second CEC network 102.

Each of the first devices 300, 310 and 320 and the second devices 500, 510, 520 and 530 is provided with a function to generate and send the CEC frame data 900, a function to give an ACK response in response to the CEC frame data 900, a function to perform a process in response to a command, a function to send back the result of the process performed in response to a CEC Give command as a CEC Report command, and the like. Here, what is sent back as a CEC Report command is exemplified by the physical address or ASCII code characters representing the manufacturer ID or product series name of the second device 500, 510, 520 or 530.

Each device in the first CEC network 101 is connected to a shared CEC signal line 103. Each device in the second CEC network 102 is connected to another shared CEC signal line 103. Each of the first devices 300, 310 and 320, the first radio unit 200, the second devices 500, 510, 520 and 530, and the second radio unit 400 converts data, information or the like into the CEC frame data 900, and then sends or receives it via the CEC signal line 103.

When recognizing that an ACK response is not given (NACK response) after sending the CEC frame data 900, each of the first devices 300, 310 and 320, the first radio unit 200, the second devices 500, 510, 520 and 530, and the second radio unit 400 sends the same CEC frame data 900 again. When recognizing that an ACK response is not given (NACK response) even after sending the same CEC frame data 900 at a predetermined number of times, each of the first devices 300, 310 and 320, the first radio unit 200, the second devices 500, 510, 520 and 530, and the second radio unit 400 discards this CEC frame data 900.

When CEC frame data 900 is sent by broadcast transmission requiring no specific destination device (in this case, “15” UNREGISTERED/BROADCAST is entered in the reception-side logical address area 912 with reference to the logical address assignment information 800), a device that received the data gives a negative ACK response (i.e., an ACK response having the opposite polarity to that of the above ACK response) and a device that sent the data determines that the transmission has succeeded based on the negative ACK response.

Here, in FIG. 3, LA represents a logical address assigned to each device and PA represents a physical address assigned to each device. For instance, the first device (first BDP) 310, which is a playback device, acquires a logical address “4” with reference to the logical address assignment information 800. A physical address “1.0.0.0” is assigned to the first device 310.

For acquiring an own logical address, each device sends a polling command to the devices connected via the shared CEC signal lines 103 on the first and second CEC networks 101 and 102, the polling command not having the data block 920 but only having the header block 910, in which a desired logical address is entered in both the transmission-side logical address area 911 and the reception-side logical address area 912. Then, when receiving a NACK response, the device recognizes that the desired logical address is available and, thus, acquires it. Such a polling command is hereinafter referred to as a polling command [acquirement].

For discovering connected devices on the CEC networks, each device sends a polling command to the devices connected via the shared CEC signal lines 103 on the first and second CEC networks 101 and 102. The polling command not having the data block 920 but only having the header block 910, in which its own logical address is entered in the transmission-side logical address area 911 while a target logical address for connection confirmation is entered in the reception-side logical address area 912. Depending on whether ACK responses or NACK responses are given from the devices, it is recognized whether or not connection to the devices exist. Such a polling command is hereinafter referred to as a polling command [recognition].

The first radio unit 200 is connected to the first CEC network 101 via the shared CEC signal line 103. The first radio unit 200 obtains data such as the CEC frame data 900, information or the like sent from the first device 300 or the like via the CEC signal line 103, and sends it to the second radio unit 400 via a radio medium M. The first radio unit 200 also obtains data, information or the like sent from the second radio unit 400 via the radio medium M, and sends it to the first device 300. The first radio unit 200 is provided with a variety of programs and includes a first CEC-side transmitter/receiver 201 as a data receiver, a first radio-side transmitter/receiver 202 as a data transmitter, a first connection processor 203, a first memory 204 as a processing-side memory, a first list manager 205 functioning also as a replaced-information-relating processor, and a first ACK response substitution executor 206, as shown in FIG. 4.

The first CEC-side transmitter/receiver 201 is connected to the first device 300 via the shared CEC signal line 103.

The first CEC-side transmitter/receiver 201 converts the CEC frame data 900 from the first device 300 into data or the like, and sends it to the first radio-side transmitter/receiver 202, the first list manager 205 or the first ACK response substitution executor 206. The first CEC-side transmitter/receiver 201 also converts data from the first radio-side transmitter/receiver 202, the first list manager 205 or the first ACK response substitution executor 206 into the CEC frame data 900, and sends it to the first device 300 or the like.

When no ACK response is given in response to the CEC frame data 900 (except if the CEC frame data 900 is broadcasted), the same CEC frame data 900 is sent again. Such a process is repeated at a predetermined number of times until the ACK response is given. When the predetermined number of times is exceeded, this CEC frame data 900 is discarded.

The first radio-side transmitter/receiver 202 converts data from the first connection processor 203, the first list manager 205 or the first ACK response substitution executor 206 into a wireless packet, and sends it to the second radio unit 400. When no wireless packet reception response is obtained from the reception side after the wireless packet is sent, the same wireless packet is sent again. Such a process is repeated at a predetermined number of times until the wireless packet reception response is obtained. When the predetermined number of times is exceeded, this wireless packet is discarded. The first radio-side transmitter/receiver 202 also converts a wireless packet from the second radio unit 400 into data, and sends it to the first connection processor 203, the first list manager 205 or the first ACK response substitution executor 206.

The first connection processor 203 performs a connecting process to the second radio unit 400.

The first memory 204 stores a shared device list 210 as shown in FIG. 5. The shared device list 210 includes first logical address information 211 and second logical address information 212.

Registered in the first logical address information 211 are the first devices 300, 310 and 320 capable of data communication with the first radio unit 200 and the respective logical addresses assigned to these devices. For instance, in FIG. 5, “FIRST 1BDP LA: 4” means that a logical address assigned to the first device 310 is 4.

Registered in the second logical address information 212 are the second devices 500, 510, 520 and 530 each capable of data communication with the second radio unit 200 and the respective logical addresses assigned to these devices.

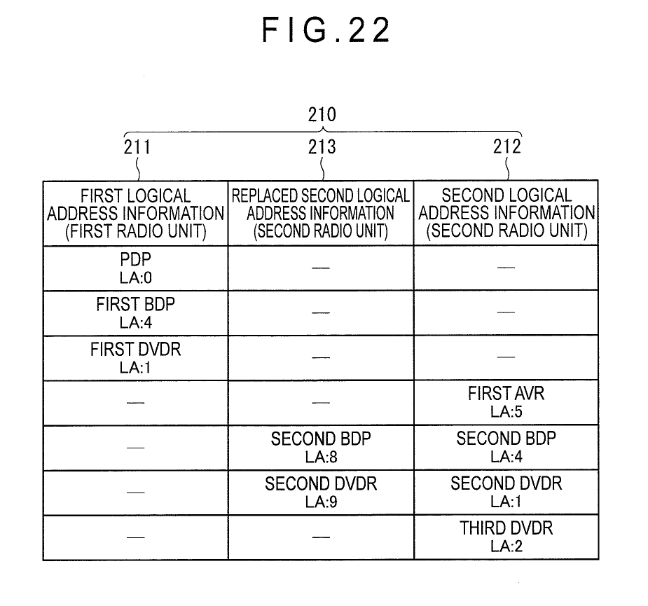

In some cases, the shared device list 210 also includes a replaced second logical address information 213 (see FIG. 22) in addition to the first logical address information 211 and the second logical address information 212. Although the shared device list 210 exemplarily shows only the logical addresses, the shared device list 210 may also show device-specific information of the first and second devices 300, 310, 320, 500, 510, 520 and 530 in association with the logical addresses thereof, the device-specific information including physical addresses, manufacturer IDs, the character strings of product series names, device types, information regarding CEC version, and the like.

When the first radio unit 200 and the second radio unit 400 are connected to each other to allow data transmission and reception therebetween, when the first radio unit 200 and the first devices 310 and 320 are connected together to allow data transmission and reception therebetween, or when the second radio unit 400 and the second devices 500, 510, 520 and 530 are connected together to allow data transmission and reception therebetween, the first list manager 205 appropriately makes or updates the shared device list 210 in the first memory 204.

The operation of the first list manager 205 will be described below in detail.

When the first ACK response substitution executor 206 obtains the CEC frame data 900 including information to the second device 500, 510, 520 or 530 sent from the first device 300 or the like, the first ACK response substitution executor 206 recognizes the second device 500, 510, 520 or 530 (the destination of the CEC frame data 900) with reference to the logical address in the reception-side logical address area 912 of the header block 910. When the destination is, for instance, the second device 510, the first ACK response substitution executor 206 operates to give an ACK response based on an ACK generating signal to report the reception of the CEC frame data 900 by the second device 510. Further, the first ACK response substitution executor 206 alters the content of the reception-side logical address area 912 if needed, and sends it to the first radio-side transmitter/receiver 202.

The operation of the first ACK response substitution executor 206 will be described below in detail.

The second radio unit 400, which is connected to the second network 102 via the shared CEC signal line 103, obtains data, information or the like sent from the second device 500 via the CEC signal line 103, and sends it to the first radio unit 200 via the radio medium M. The second radio unit 400 also obtains data, information or the like sent from the first radio unit 200 via the radio medium M, and sends it to the first device 500. The second radio unit 400 is provided with a variety of programs and includes a second CEC-side transmitter/receiver 401, a second radio-side transmitter/receiver 402, a second connection processor 403, a second memory 404 as a transfer-side memory, a second list manager 405 functioning also as a second device information generator, and a second ACK response substitution executor 406 functioning also as a data transferer, as shown in FIG. 6.

The second CEC-side transmitter/receiver 401 is connected to the second device 500 via the shared CEC signal line 103. The second CEC-side transmitter/receiver 401 converts the CEC frame data 900 from the second device 500 into data or the like, and sends it to the second list manager 405 and the second ACK response substitution executor 406. The second CEC-side transmitter/receiver 401 also converts data from the second list manager 405 and the second ACK response substitution executor 406 into the CEC frame data 900, and sends it to the second device 500. When no ACK response is given in response to the CEC frame data 900 (except if the CEC frame data 900 is broadcasted), the same CEC frame data 900 is sent again. Such a process is repeated at a predetermined number of times until the ACK response is given. When the predetermined number of times is exceeded, this CEC frame data 900 is discarded.

The second radio-side transmitter/receiver 402 converts data from the second connection processor 403, the second list manager 405 or the second ACK response substitution executor 406 into a wireless packet, and sends it to the first radio unit 200. When no wireless packet reception response is obtained from the reception side after the wireless packet is sent, the same wireless packet is sent again. Such a process is repeated at a predetermined number of times until the reception response is obtained. When the predetermined number of times is exceeded, this wireless packet is discarded. The second radio-side transmitter/receiver 402 also converts a wireless packet from the first radio unit 200 into data, and sends it to the second connection processor 403, the second list manager 405 or the second ACK response substitution executor 406.

The second connection processor 403 performs a connecting process to the first radio unit 200.

The second memory 404 stores the same shared device list 210 as that of the first memory 204.

The second list manager 405 appropriately makes or updates the shared device list 210 in the second memory 404 at the same timing as that of the first list manager 205.

The operation of the second list manager 405 will be described below in detail.

The second ACK response substitution executor 406 performs the same process as that of the first ACK response substitution executor 206 of the first radio unit 200.

The operation of the second ACK response substitution executor 406 will be described below in detail.

The second radio unit 400 includes a hotplug (not shown) adapted to operate on the same principle as one disclosed in, for instance, JP-A-2008-271460. Such a hotplug line is connected to a collector of a transistor and is switched to HIGH status or LOW status when the second CEC-side transmitter/receiver 401 controls the base voltage of the transistor. Here, in order to independently control a plurality of connectors to which the second devices 500, 510, 520 and 530 are connectable, the connectors may be provided with respective transistors. In order to simultaneously control, the plurality of connectors may be provided with a single transistor in common.

### Operations of HDMI System

Next, description will be made on operations of the HDMI system. The first devices 300, 310 and 320 and the second devices 500, 510, 520 and 530 are hereinafter referred to respectively as a PDP 300, a first BDP 310, a first DVDR 320, a first AVR 500, a second BDP 510, a second DVDR 520 and a third DVDR 530, as needed.

Operation when First Radio Unit and Second Radio Unit are Connected

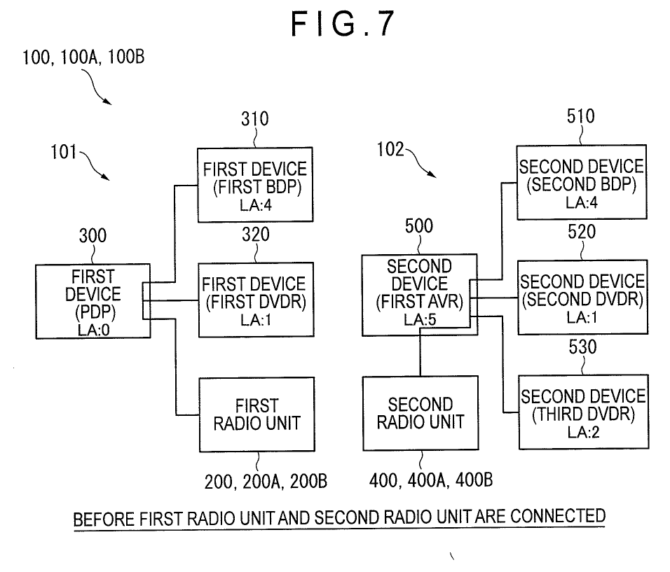

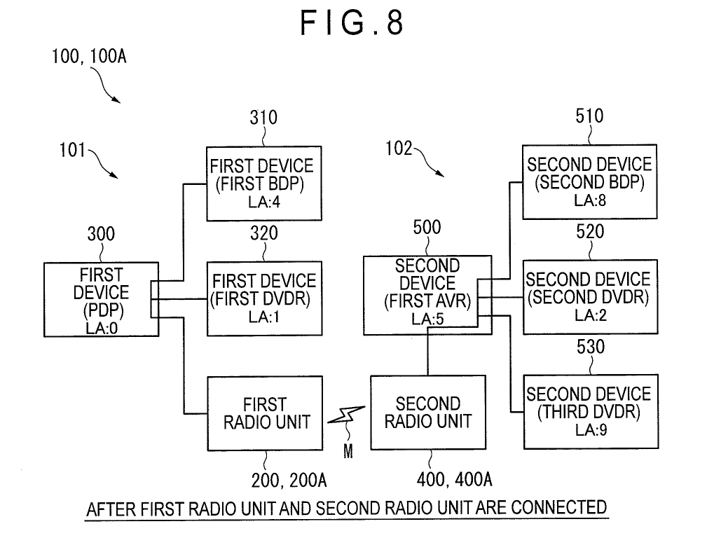

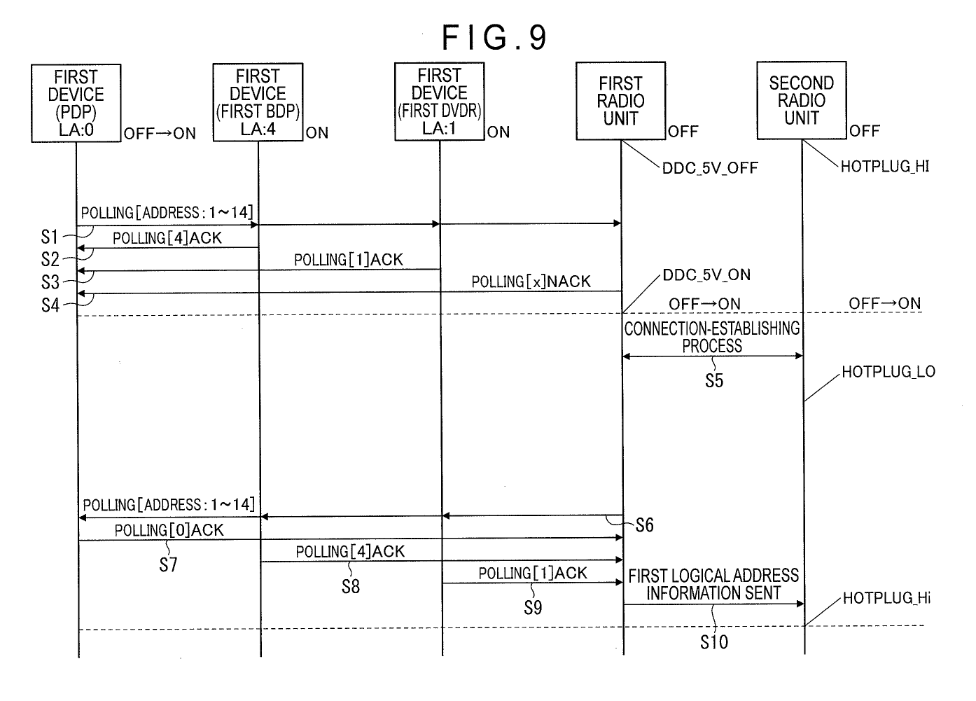

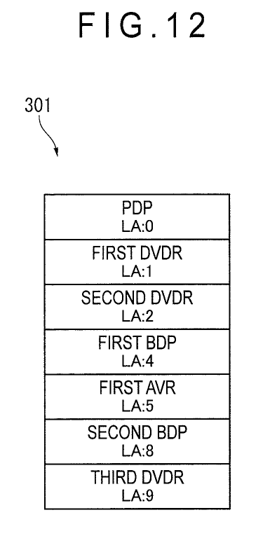

FIG. 7 schematically shows a device connection status and a logical address assignment status before the first radio unit and the second radio unit are connected to each other. FIG. 8 schematically shows a device connection status and a logical address assignment status after the first radio unit and the second radio unit are connected to each other. FIGS. 9 to 11 are timing charts showing an operation performed when the first radio unit and the second radio unit are connected. FIG. 12 schematically shows a PDP recognition list.

In the situation where the first radio unit 200 to which the first devices 300, 310 and 320 are connected is disconnected from the second radio unit 400 to which the second devices 500, 510, 520 and 530 are connected (the radio medium M is not shown) as shown in FIG. 7, for instance, as shown in FIG. 9, when the PDP is switched from OFF to ON while: the first BDP 310 and the first DVDR 320 are ON; the first radio unit 200 is OFF and DDC_{—}5V is OFF (represented by “DDC_{—}5V_OFF” in FIG. 9); and the second radio unit 400 is OFF and the hotplug is set HIGH, the PDP 300 performs a polling command [recognition] process to the first radio unit 200, the first BDP 310 and the first DVDR 320 in order to recognize the device or devices connected after the PDP 300 acquires its logical address “0” (step S1). Specifically, the PDP 300 sequentially sends to the first CEC network 101 the polling command [recognition] of the CEC frame data 900 having the logical address of the PDP 300 entered in the transmission-side logical address area 911 and any one of “1 to 14” entered in the reception-side logical address area 912. The polling command [recognition] processes for the reserved logical addresses “12” and “13” may be omitted.

When the first BDP 310 receives the header block 910 having the logical address “4” entered in the reception-side logical address area 912, the first BDP 310 gives an ACK response for reporting the reception (step S2). Likewise, the first DVDR 320 gives an ACK response for reporting the reception of the header block 910 having the logical address “1” entered in the reception-side logical address area 912 (step S3). The first radio unit 200 gives a NACK response because the first radio unit 200 is OFF (step S4).

Then, when the first and second radio units 200 and 400 are switched from OFF to ON, the DDC_{—}5V of the first radio unit 200 becomes ON. Further, the first connection processor 203 starts an initialization process, thereby providing a communicatable status via the radio medium M as shown in FIG. 8, and also performs a connection-establishing process with the second connection processor 403 of the second radio unit 400 as shown in FIG. 9 (step S5). In the connection-establishing process, an HDMI repeater process is performed. The HDMI repeater process includes a process for switching the hotplug of the second radio unit 400 from HIGH to LOW, a process for reading or writing the EDID of the PDP 300, and the like. Depending on a change in the hotplug status at this time, the second devices 500, 510, 520 and 530 discard respective own logical addresses having been acquired (i.e., the respective logical addresses of these devices become “15” UNREGISTERED).

In order to recognize the connected device or devices, the first list manager 205 of the first radio unit 200 sequentially performs the polling command [recognition] process to the first CEC network 101 in the same manner as the process by the PDP 300 in step S1 (step S6). In response to the polling command [recognition] process, the PDP 300 gives an ACK response for reporting the reception of the header block 910 with the logical address “0” being entered therein, the first BDP 310 gives an ACK response for reporting the reception of the header block 910 with the logical address “4” being entered therein, and the first DVDR 320 gives an ACK response for reporting the reception of the header block 910 with the logical address “1” being entered therein (steps S7, S8 and S9). When the first CEC-side transmitter/receiver 201 confirms these ACK responses, the first list manager 205 generates the first logical address information 211 indicating that the respective logical addresses of the PDP 300, the first BDP 310 and the first DVDR 320 are set at “0”, “4” and “1”, and sends it to the second list manager 405 of the second radio unit 400 (step S10).

Specifically, the first list manager 205 of the first radio unit 200 generates the first logical address information 211 by associating the logical addresses entered in the reception-side logical address area 912 of the header block 910 of the sequentially performed polling command [recognition] process with ACK response/NACK response results in the ACK area 914 processed by the reception-side devices. The polling command [recognition] process may be omitted for the related logical addresses “12” and “13”.

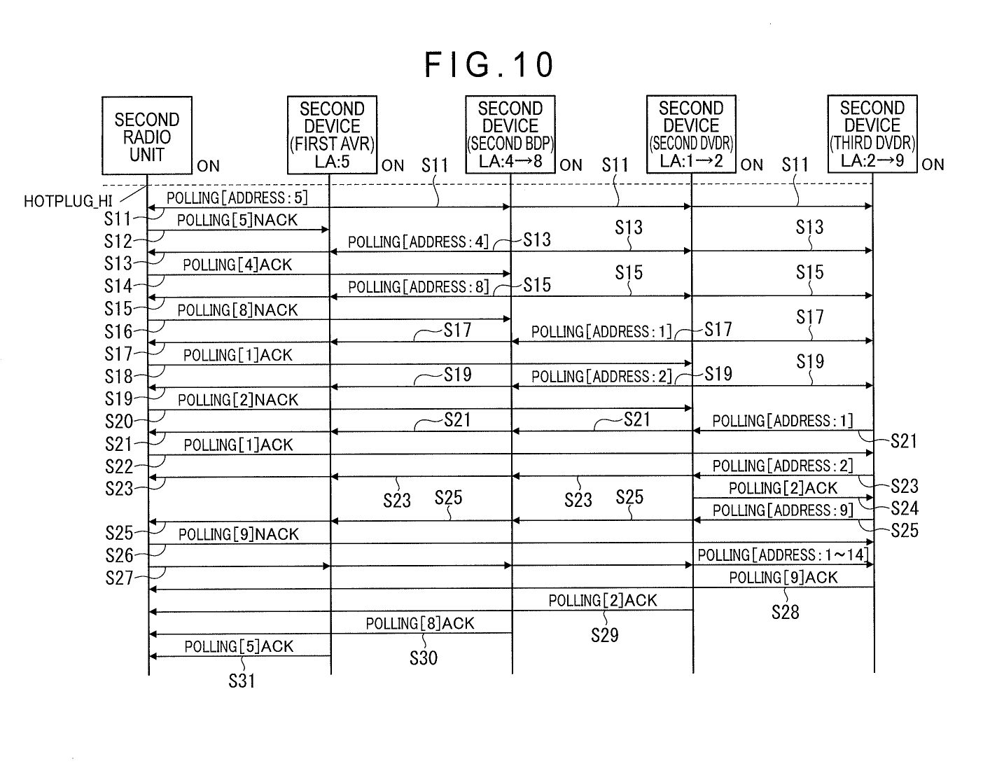

As shown in FIG. 10, the second radio unit 400 switches the hotplug from LOW to HIGH.

Subsequently, in order to reacquire an own logical address, the first AVR 500 enters the logical address “5” and performs the polling command [acquirement] process to the second CEC network 102 (step S11).

The response from each of the second devices 510, 520 and 530 (not shown) is a NACK response for reporting that its logical address is not “5”.

The second ACK response substitution executor 406 of the second radio unit 400 recognizes the absence of the first devices 310 and 320 assigned with the logical address “5” based on the first logical address information 211 from the first list manager 205 via the second CEC-side transmitter/receiver 401, and gives a NACK response (step S12).

When the first AVR 500 recognizes the NACK response from each of the second devices 510, 520 and 530 and the second radio unit 400, the first AVR 500 maintains “5” as its own logical address.

In order to acquire an own logical address, the second BDP 510 enters the logical address “4” and performs the polling command [acquirement] process to the second CEC network 102 in the same manner as the first AVR 500 (step S13).

In response to this polling command [acquirement] process, the each of the second devices 500, 520 and 530 gives a NACK response.

The second ACK response substitution executor 406 recognizes that the logical address of the first BDP 310 is “4” based on the first logical address information 211 via the second CEC-side transmitter/receiver 401, and gives an ACK response (step S14).

When recognizing the ACK response from the second radio unit 400, the second BDP 510, which is a playback device, determines that the logical address “4” has already been acquired by another device. Then, in order to confirm whether or not the logical address “8”, which is assignable to a playback device in accordance with the logical address assignment information 800, is available, the second BDP 510 enters the logical address “8” and again performs the polling command [acquirement] process to the second CEC network 102 (step S15).

In response to this polling command [acquirement] process, the each of the second devices 500, 520 and 530 gives a NACK response.

The second ACK response substitution executor 406 recognizes the absence of the first devices 310 and 320 assigned with the logical address “8” based on the first logical address information 211 via the second CEC-side transmitter/receiver 401, and gives a NACK response for reporting the absence (step S16).

When the second BDP 510 recognizes the NACK response from each of the second devices 500, 520 and 530 and the second radio unit 400, the second BDP 510 acquires and maintains “8” as its own logical address as shown in FIG. 8.

The second DVDR 520 performs the polling command [acquirement] process for acquiring its own logical address (step S17), and recognizes a NACK response from each of the second devices 500, 510 and 530 and an ACK response from the second radio unit 400 for reporting that the first DVDR 320 is assigned with “1” (step S18). Subsequently, the second DVDR 520, which is a recording device, again performs the polling command [acquirement] process so as to confirm whether or not “2”, which is assignable to a recording device, is available (step S19).

When the second DVDR 520 recognizes the NACK response from each of the second devices 500, 510 and 530 and the second radio unit 400 (step S20), the second DVDR 520 acquires and maintains “2” as its own logical address as shown in FIG. 8.

When the third DVDR 530 performs the polling command [acquirement] process for acquiring its own logical address (step S21), the third DVDR 530 recognizes an ACK response from the second radio unit 400 for reporting that the first DVDR 320 is assigned with “1” (step S22). Next, the third DVDR 530 performs the polling command [acquirement] process for confirming whether or not “2” is available (step S23), and recognizes an ACK response for reporting that the second DVDR 520 is assigned with “2” (step S24). Further, the third DVDR 530 performs the polling command [acquirement] process for confirming whether or not “9” is available (step S25), and recognizes a NACK response from the second radio unit 400 (step S26). Thus, the third DVDR 530 acquires and maintains “9” as its own logical address as shown in FIG. 8.

The second list manager 405 generates temporary second logical address information based on the above processes, the temporary second logical address information indicating that first AVR 500, the second BDP 510, the second DVDR 520 and the third DVDR 530 are respectively assigned with “5”, “8”, “2” and “9”.

Specifically, when receiving the CEC frame data 900 sent from a device connected to the second CEC network 102, the second list manager 405 of the second radio unit 400 recognizes the logical address entered in the transmission-side logical address area 911 and the logical address entered in the reception-side logical address area 912 of the header block 910 of the received CEC frame data 900. When determining that the received CEC frame data 900 is provided for the polling command [acquirement] process for acquiring an own logical address, the second list manager 405 monitors the logical address entered in the reception-side logical address area 912 and also in the transmission-side logical address 911 of the header block 910 as well as an ACK response/NACK response status of the ACK area 914. When this logical address is unregistered in the second logical address information 212 and a NACK response is given, the second list manager 405 generates the temporary second logical address information in association with this logical address. If “15” UNREGISTERED/BROADCAST based on the logical address assignment information 800 is entered in the reception-side logical address area 912, the second list manager 405 ends its operation without performing the above monitoring process.

Subsequently, the second radio unit 400 performs the polling command [recognition] process to the first AVR 500, the second BDP 510, the second DVDR 520 and the third DVDR 530 so as to generate the second logical address information 212 (step S27). When the second CEC-side transmitter/receiver 401 recognizes ACK responses given by each of the first AVR 500, the second BDP 510, the second DVDR 520 and the third DVDR 530 in response to the polling command [recognition] using the header block 910 in which the logical address “5” is entered, the polling command [recognition] using the header block 910 in which the logical address “8” is entered, the polling command [recognition] using the header block 910 in which the logical address “2” is entered, and the polling command [recognition] using the header block 910 in which the logical address “9” is entered (steps S28, S29, S30 and S31), the second list manager 405 compares the obtained result to the temporary second logical address information. When determining that the result coincides with the temporary second logical address information, the second list manager 405 generates the shared device list 210 having the temporary second logical address information as the second logical address information 212 and the first logical address information 211 obtained from the first list manager 205 as shown in FIG. 5, and stores the shared device list 210 in the second memory 404.

If not coincide, while repeating step S28 at an appropriate number of times, the processes of step S11 and the following steps may be again performed after switching the hotplug from HIGH to LOW and keeping the hotplug at LOW for an appropriate period of time. Alternatively, the second logical address information 212 may be provided based on information obtained by performing step S28. In some cases, a process described below in “Operation When There is Logical Address Duplication between First Devices and Second Devices” may be performed.

The second logical address may be generated without generating the temporary second logical address information and, thus, without performing the coincidence determining process.

Specifically, the second list manager 405 of the second radio unit 400 may generate the second logical address information 212 by associating the logical addresses entered in the reception-side logical address area 912 of the header block 910 of the sequentially performed polling command [recognition] process with ACK response/NACK response results in the ACK area 914.

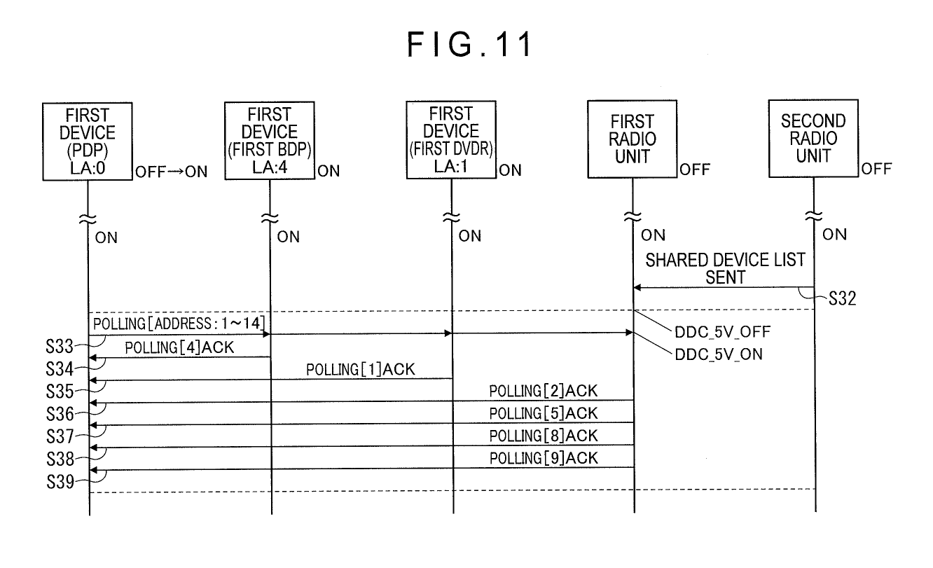

Further, as shown in FIG. 11, the second list manager 405 sends the shared device list 210 to the first list manager 205 of the first radio unit 200 (step S32).

At this time, based on the second logical address information 212, the first list manager 205 may perform and report the polling command [acquirement] process to the first CEC network 101, the polling command [acquirement] process using the header block 910 in which the respective logical addresses “5”, “8”, “2” and “9” of the devices connected to the second CEC network 102 are entered. In such a case, when the first list manager 205 recognizes an ACK response for reporting that at least one of the logical addresses “5”, “8”, “2” and “9” has already been assigned to another device, the first list manager 205 updates the first logical address information 211 after reconfirming at an appropriate number of times, and sends it to the second list manager 405 of the second radio unit 400 while reporting that the logical address has been assigned.

Here, the second radio unit 400 may again perform the processes of step S11 and the following steps after switching the hotplug from HIGH to LOW and keeping the hotplug at LOW for an appropriate period of time. In this case, the second CEC-side transmitter/receiver 401 functions as a hotplug processor according to the invention. In some cases, a process described below in “Operation When There is Logical Address Duplication between First Devices and Second Devices” may be performed. When the first list manager 205 recognizes NACK responses given in response to the polling command [acquirement] process for all the logical addresses “5”, “8”, “2” and “9”, the first list manager 205 recognizes that the acquirement has succeeded. Then, the DDC_{—}5V of the first radio unit 200 is then switched OFF.

The first list manager 205 of the first radio unit 200 instructs the first memory 204 to store the shared device list 210.

Further, the DDC_{—}5V of the first radio unit 200 is switched ON after the elapse of an appropriate period of time.

When the PDP 300 recognizes that the DDC_{—}5V of the first radio unit 200 is switched from OFF to ON, the PDP 300 sequentially performs the polling command [recognition] process to the first CEC network 101 in order to recognize a device or devices connected thereto (step S33).

The first BDP 310 gives an ACK response for reporting that the first BDP 310 is assigned with the logical address “4” and the first DVDR 320 gives an ACK response for reporting that the first DVDR 320 is assigned with the logical address “1” (steps S34 and S35). Further, the first ACK response substitution executor 206 of the first radio unit 200 gives ACK responses for reporting that the second DVDR 520, the first AVR 500, the second BDP 510 and the third DVDR 530 are respectively assigned with the logical addresses “2”, “5”, “8” and “9” based on the shared device list 210 via the first CEC-side transmitter/receiver 201 (steps S36, S37, S38 and S39).

Based on these ACK responses, the PDP 300 recognizes the first devices 310 and 320 and the second devices 500, 510, 520 and 530 to which the CEC frame data 900 can be sent as well as the respective logical addresses thereof, and generates and stores a PDP recognition list 301 shown in FIG. 12.

Operation when First Radio Unit and First BDP are Connected/Disconnected

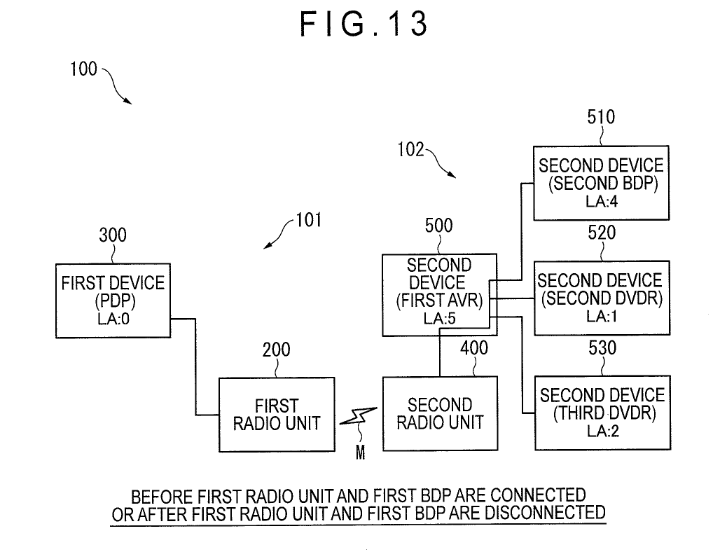

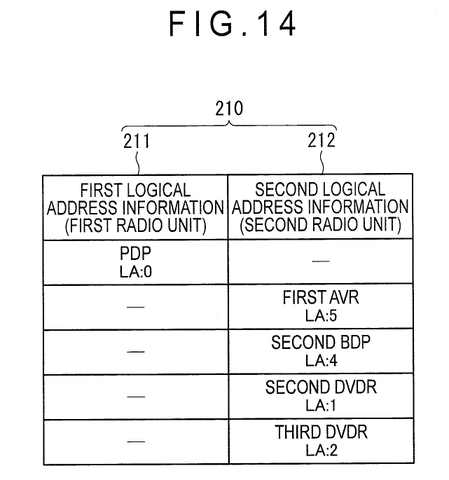

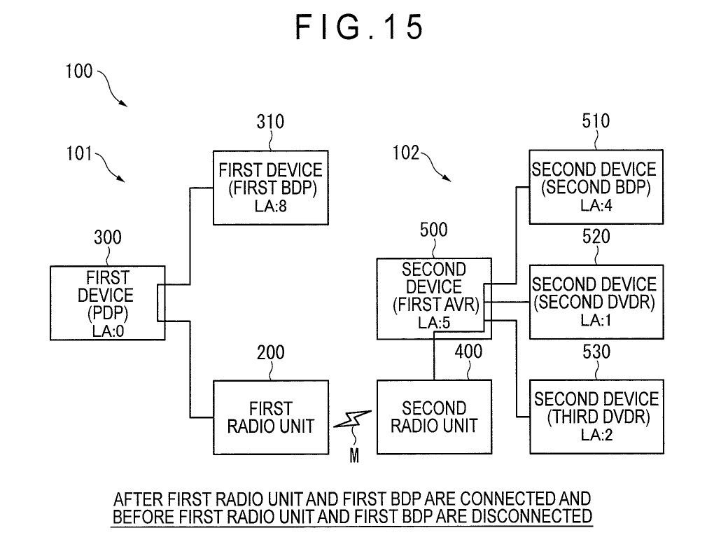

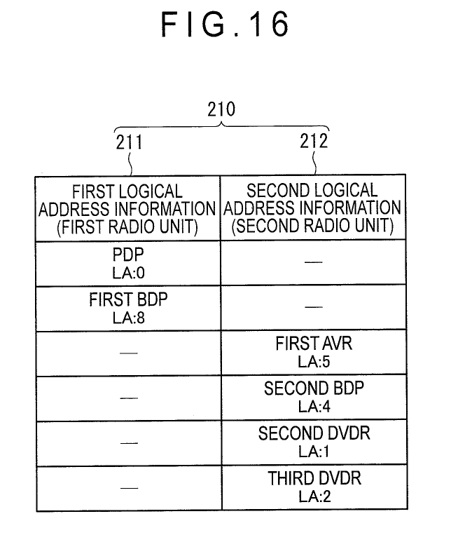

FIG. 13 schematically shows a device connection status and a logical address assignment status before the first radio unit and the first BDP are connected or after the first radio unit and the first BDP are disconnected. FIG. 14 schematically shows an updated status of the shared device list before the first radio unit and the first BDP are connected or after the first radio unit and the first BDP are disconnected. FIG. 15 schematically shows a device connection status and a logical address assignment status after the first radio unit and the first BDP are connected and before the first radio unit and the first BDP are disconnected. FIG. 16 schematically shows an updated status of the shared device list after the first radio unit and the first BDP are connected and before the first radio unit and the first BDP are disconnected

As shown in FIG. 13, when the first BDP 310 is disconnected from the first CEC network 101, the first memory 204 stores the shared device list 210 shown in FIG. 14. When the first BDP 310 is connected to the first CEC network 101 as shown in FIG. 15, the first BDP 310, which is a playback device, performs the polling command [acquirement] process to confirm whether or not there are devices assigned with the assignable logical addresses “1”, “2” and “8” for acquiring its own logical address.

In response to this polling command [acquirement] process, based on the shared device list 210, the first ACK response substitution executor 206 of the first radio unit 200 gives an ACK response for reporting that the second DVDR 520 and the third DVDR 530 are respectively assigned with “1” and “2” and gives a NACK response for reporting that no device is assigned with “8” via the first CEC-side transmitter/receiver 201. Thus, the first BDP 310 acquires and maintains “8” as its own logical address as shown in FIG. 15.

The first list manager 205 updates the shared device list 210 by adding the first logical address information 211 indicating that the logical address of the first BDP 310 is “8” as shown in FIG. 16. Further, the first list manager 205 sends the updated shared device list 210 to the second list manager 405 to update the shared device list 210 in the second memory 404 as needed.

Specifically, when receiving the CEC frame data 900 sent from a device connected to the first CEC network 101, the first list manager 205 of the first radio unit 200 recognizes the logical address entered in the transmission-side logical address area 911 and the logical address entered in the reception-side logical address area 912 of the header block 910 of the received CEC frame data 900. When determining that the received CEC frame data 900 is provided for the polling command [acquirement] process for acquiring an own logical address, the first list manager 205 monitors the logical address entered in the reception-side logical address area 912 and also in the transmission-side logical address 911 of the header block 910 as well as an ACK response/NACK response status of the ACK area 914. When this logical address is unregistered in the first logical address information 211 and a NACK response is given, the first list manager 205 performs a process for updating the shared device list 210 by adding an entry to the first logical address information 212 in association with the logical address. If “15” UNREGISTERED/BROADCAST based on the logical address assignment information 800 is entered in the reception-side logical address area 912, the first list manager 205 ends its operation without performing the above monitoring process.

At this time, the first CEC-side transmitter/receiver 201 may perform the polling command [recognition] process so as to reconfirm that the first BDP 310 has truly acquired “8”.

When the first BDP 310 in the above status is disconnected as shown in FIG. 13, the disconnection of the first BDP 310 cannot be recognized by the first list manager 205 of the first radio unit 200 because the first list manager 205 is not adapted to recognize such a change.

Accordingly, the first list manager 205 monitors ACK responses and NACK responses given in response to the commands based on the CEC frame data 900 sent and received by the PDP 300 and the second devices 500, 510, 520 and 530. When the first list manager 205 recognizes that NACK responses are given at a predetermined number of times in response to command transmission related to a logical address registered in the shared device list 210, the first list manager 205 performs the polling command [recognition] process for confirming whether or not this logical address exists. When recognizing that a NACK response is given in relation to, for instance, the first BDP 310, the first list manager 205 updates the shared device list 210 as shown in FIG. 14 by deleting the first logical address information 211 regarding the first BDP 310 therefrom, and sends this updated shared device list 210 to the second radio unit 400 so that the updated shared device list 210 is stored in the second memory 404 as needed.

Incidentally, without performing the polling command [recognition] process for confirming whether or not the logical address exists, the first list manager 205 may update the shared device list 210 by deleting the first logical address information 211 regarding the first BDP 310 therefrom upon recognizing that NACK responses are continuously given at the predetermined number of times in response to commands based on the CEC frame data 900 sent and received by the PDP 300 and the second devices 500, 510, 520 and 530.

Specifically, when receiving the CEC frame data 900 sent from a device connected to the first CEC network 101, the first list manager 205 of the first radio unit 200 checks the logical address entered in the reception-side logical address area 912 of the header block 910 of the CEC frame data 900 as long as the CEC frame data 900 is not provided for the polling command [acquirement] process for acquiring an own logical address. If the logical address has been registered in the first logical address information 211, the first list manager 205 may monitor an ACK response/NACK response status of the ACK area 914, and, in the case of a NACK response, the first list manager 205 may perform a process for updating the shared device list 210 by deleting this device from the first logical address information 211 in association with the logical address. If “15” UNREGISTERED/BROADCAST based on the logical address assignment information 800 is entered in the reception-side logical address area 912, the first list manager 205 ends its operation without performing the above monitoring process.

Operation when Second Radio Unit and Second BDP are Connected/Disconnected

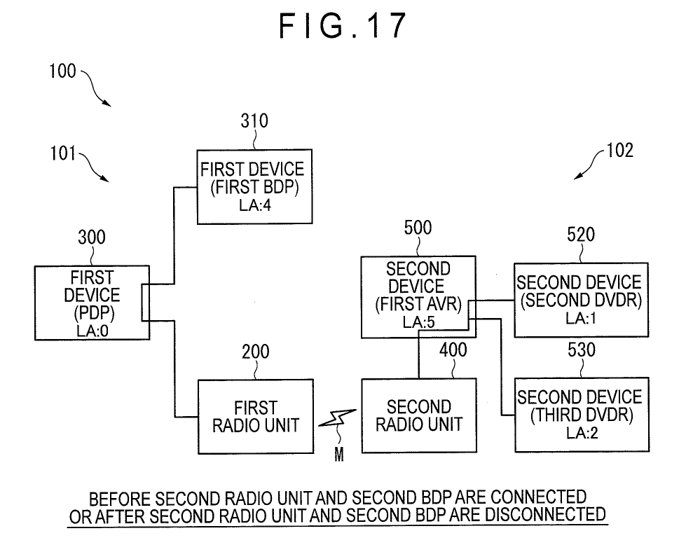

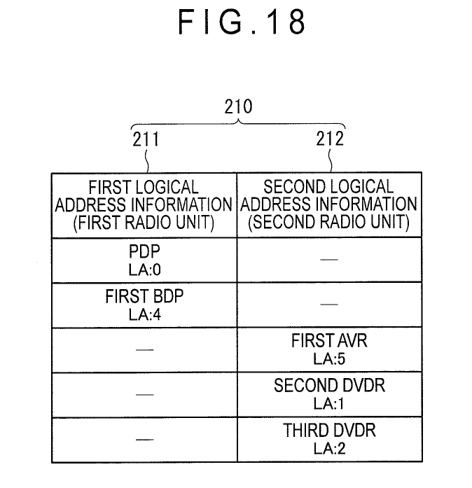

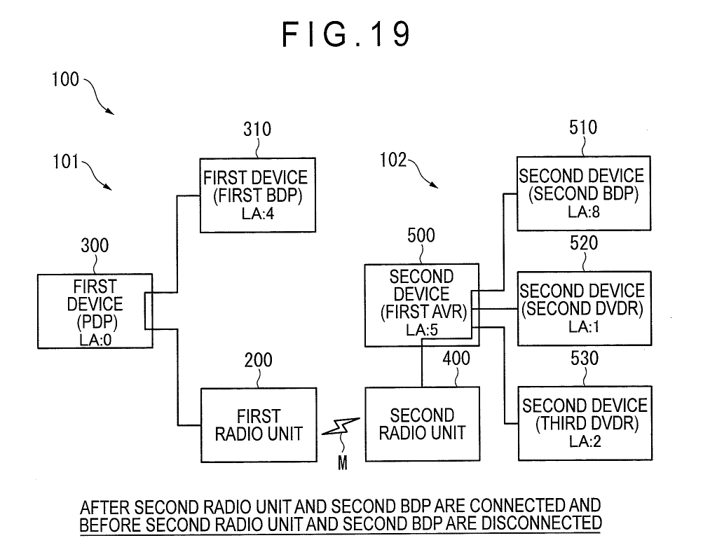

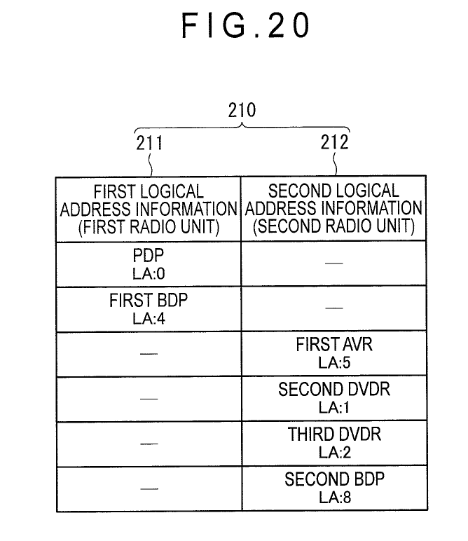

FIG. 17 schematically shows a device connection status and a logical address assignment status before the second radio unit and the second BDP are connected or after the second radio unit and the second BDP are disconnected. FIG. 18 schematically shows an updated status of the shared device list before the second radio unit and the second BDP are connected or after the second radio unit and the second BDP are disconnected. FIG. 19 schematically shows a device connection status and a logical address assignment status after the second radio unit and the second BDP are connected and before the second radio unit and the second BDP are disconnected. FIG. 20 schematically shows an updated status of the shared device list after the second radio unit and the second BDP are connected and before the second radio unit and the second BDP are disconnected

As shown in FIG. 17, when the second BDP 510 is disconnected from the second CEC network 102, the second memory 404 stores the shared device list 210 shown in FIG. 18. When the second BDP 510 is connected to the second CEC network 102 as shown in FIG. 19, the second BDP 510, which is a playback device, performs the polling command [acquirement] process to confirm whether or not there are devices assigned with the assignable logical addresses “1”, “2” and “8” for acquiring its own logical address. When the second BDP 510 recognizes NACK responses given from the second radio unit 400 and the like for reporting that there is no device assigned with “8”, the second BDP 510 acquires and maintains “8” as its own logical address.

Further, the second list manager 405 updates the shared device list 210 by adding the second logical address information 212 regarding the second BDP 510 thereto as shown in FIG. 20, and sends the updated shared device list 210 to the first radio unit 200 so that the updated shared device list 210 is stored in the first memory 204 as needed.

Specifically, when receiving the CEC frame data 900 sent from a device connected to the second CEC network 102, the second list manager 405 of the second radio unit 400 recognizes the logical address entered in the transmission-side logical address area 911 and the logical address entered in the reception-side logical address area 912 of the header block 910 of the received CEC frame data 900. When determining that the received CEC frame data 900 is provided for the polling command [acquirement] process for acquiring an own logical address, the second list manager 405 monitors the logical address entered in the reception-side logical address area 912 and also in the transmission-side logical address 911 of the header block 910 as well as an ACK response/NACK response status of the ACK area 914. When the logical address is unregistered in the second logical address information 212 and a NACK response is given, the second list manager 405 performs a process for updating the shared device list 210 by adding the device to the second logical address information 212 in association with the logical address. If “15” UNREGISTERED/BROADCAST based on the logical address assignment information 800 is entered in the reception-side logical address area 912, the second list manager 405 ends its operation without performing the above monitoring process.

At this time, the second list manager 405 may perform the polling command [recognition] process so as to reconfirm that the second BDP 510 has truly acquired “8”.

When the second BDP 510 in the above status is disconnected as shown in FIG. 17, the disconnection of the second BDP 510 cannot be recognized by the second list manager 405 of the second radio unit 400 because the second list manager 405 is not adapted to recognize such a change. Accordingly, the second list manager 405 monitors ACK responses and NACK responses given in response to commands sent and received by the first devices 300 and 310 and the second devices 500, 520 and 530. When the second list manager 405 recognizes that NACK responses are continuously given at a predetermined number of times in response to command transmission to the second BDP 510, the second list manager 405 performs the polling command [recognition] process for confirming whether or not the second BDP 510 exists. Further, when recognizing a NACK response, the second list manager 405 updates the shared device list 210 by deleting the second logical address information 212 regarding the second BDP 510 therefrom as shown in FIG. 18, and sends the updated shared device list 210 to the first radio unit 200 so that the updated shared device list 210 is stored in the first memory 204 as needed.

Incidentally, without performing the polling command [recognition] process for confirming whether or not the logical address exists, the second list manager 405 may update the shared device list 210 by deleting the second logical address information 212 regarding the second BDP 510 therefrom upon recognizing that NACK responses are continuously given at the predetermined number of times in response to commands based on the CEC frame data 900 sent and received by the PDP 300 and the second devices 310, 500, 520 and 530.

Specifically, when receiving the CEC frame data 900 sent from a device connected to the second CEC network 102, the second list manager 405 of the second radio unit 400 checks the logical address entered in the reception-side logical address area 912 of the header block 910 of the CEC frame data 900 as long as the CEC frame data 900 is not provided for the polling command [acquirement] process for acquiring an own logical address. If the logical address has been registered in the second logical address information 212, the second list manager 405 may monitor an ACK response/NACK response status of the ACK area 914, and, in the case of a NACK response, the second list manager 405 may perform a process for updating the shared device list 210 by deleting this device from the second logical address information 212 in association with the logical address. If “15” UNREGISTERED/BROADCAST based on the logical address assignment information 800 is entered in the reception-side logical address area 912, the second list manager 405 ends its operation without performing the above monitoring process.

Operation when there is Logical Address Duplication Between First Devices and Second Devices

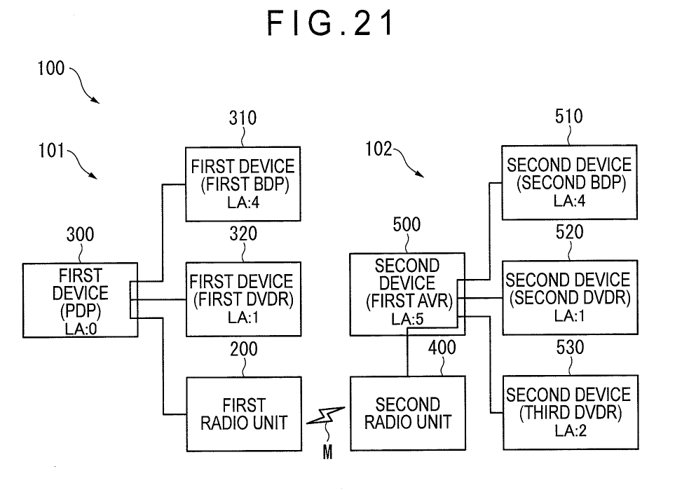

FIG. 21 schematically shows a device connection status and a logical address assignment status when there is logical address duplication between the first devices and the second devices. FIG. 22 schematically shows a shared device list generated when there is logical address duplication between the first devices and the second devices.

It is likely that the logical addresses of both the first BDP 310 and the second BDP 510 are “4” and the logical addresses of the first DVDR 320 and the second DVDR 520 are “1” as shown in FIG. 21 due to, for instance, a connection timing between the first and second radio units 200 and 400, a connection timing of each of the first devices 300, 310 and 320 and the second devices 500, 510, 520 and 530, or the presence of the first and second CEC networks 101 and 102.

In the above case, the processes of step S11 and the following steps may be again performed after switching the hotplug of the second radio unit 400 from HIGH to LOW and keeping the hotplug at LOW for an appropriate period of time. Alternatively, taking the following technique is also effective in terms of a reduction in processing time and simplification of the process.

In such a case, based on the connected device recognizing process for the first devices 300, 310 and 320 as described above, the first list manager 205 of the first radio unit 200 generates the first logical address information 211 indicating the respective addresses of these devices are “0”, “4” and “1”.

Based on the above connected device recognizing process for the second devices 500, 510, 520 and 530, the second list manager 405 of the second radio unit 400 generates the second logical address information 212 indicating the respective addresses of these devices are “5”, “4”, “1” and “2”, and sends it to the first list manager 205.

When receiving the second logical address information 212, the first list manager 205 confirms that a logical address duplication status based on the first logical address information 211 and the second logical address information 212. When the first list manager 205 determines that the respective logical addresses of the first BDP 310 and the second BDP 510, which are playback devices, are duplicately “4”, the first list manager 205 replaces the logical address of the second BDP 510 in the second logical address information 212 with any other logical address available for a playback device. In replacement, the first list manager 205 refers to the values representing logical addresses in ascending order to determine whether or not each logical address is replaceable. Here, the first list manager 205 initially confirms whether or not there is any one(s) of the first and second devices 300, 320, 500, 520 and 530 assigned with “8”. Since there is no such a device, the first list manager 205 determines to replace the logical address in the second logical address information 212 with “8”.

Likewise, the first list manager 205 determines to replace the logical address corresponding to the second DVDR 520 in the second logical address information 212, which is duplicated with the logical address of the first DVDR 320, with any other logical address available for a recording device. Here, the first list manager 205 initially confirms whether or not “2” is replaceable, and recognizes that “2” has already been acquired by the third DVDR 530. The first list manager 205 thus determines to replace the second logical address information 212 of the second DVDR 520 with the second smallest logical address “9” after confirming that “9” is unused.

Next, the first radio unit 200 performs the polling command [acquirement] process for confirming whether or not the replaced logical address is used for the first devices 300, 310 and 320. When recognizing that it is unused, the first radio unit 200 generates the shared device list 210 including not only the first logical address information 211 and the second logical address information 212 but also the replaced second logical address information 213 indicating that the respective logical addresses corresponding to the second BDP 510 and the second DVDR 520 in the second logical address information 212 are replaced with “8” and “9” as shown in FIG. 22. The first radio unit 200 then instructs the first memory 204 to store the shared device list 210 therein. Further, the first radio unit 200 sends the shared device list 210 to the second list manager 405 so that the shared device list 210 is stored in the second memory 404.

Incidentally, the second list manager 405 may generate the shared device list 210 including the replaced second logical address information 213.

An ON/OFF operation of the DDC_{—}5V of the first radio unit 200 stimulates a process for re-recognizing the connected devices and the PDP 300 performs the polling command [recognition] process for the first radio unit 200 and the first devices 310 and 320. In response to the polling command [recognition] process, the first radio unit 200 performs the following process based on the shared device list 210 shown in FIG. 22. Specifically, since the first AVR 500 and the third DVDR 530 are not assigned with duplicate logical addresses, the first AVR 500 and the third DVDR 530 give ACK responses in response to their actually acquired logical addresses, respectively. In contrast, since the second BDP 510 and the second DVDR 520 are assigned with duplicate logical addresses, the second BDP 510 and the second DVDR 520 give ACK responses in response not to their actually acquired logical addresses but to their replaced logical addresses registered in the replaced second logical address information 213, respectively.

Based on the result of the polling command [recognition] process, the PDP 300 generates and stores the PDP recognition list 301 shown in FIG. 12. Specifically, the PDP 300 stores the PDP recognition list 301 indicating that each of the second BDP 510 and the second DVDR 520 is assigned with a logical address different from its actually acquired logical address.

Operation when there is No Logical Address Duplication Between First Devices and Second Devices

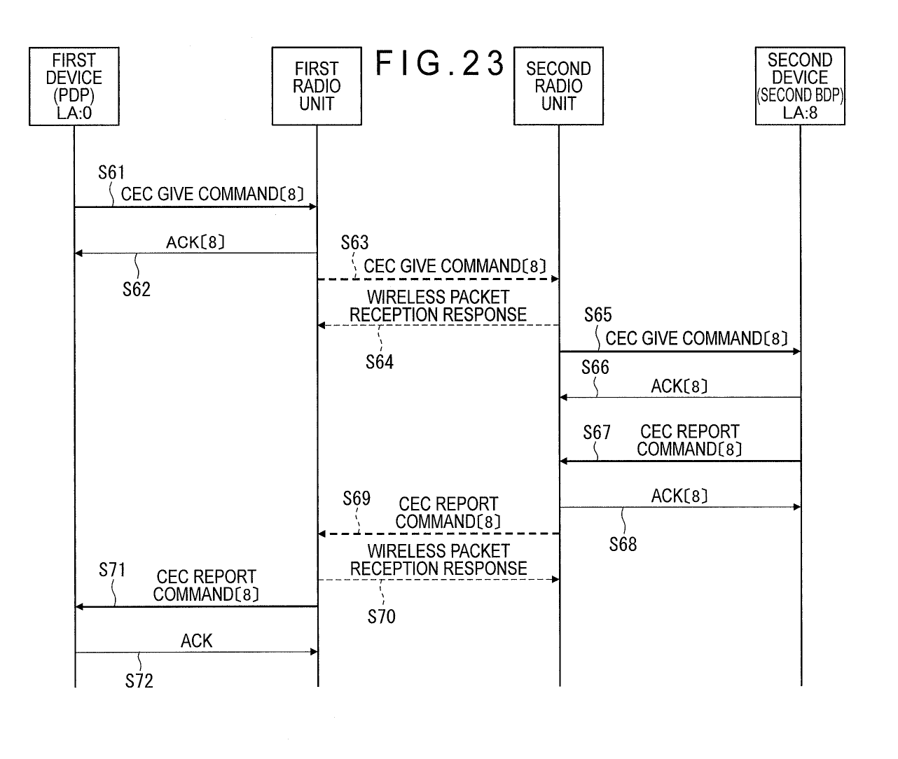

FIG. 23 is a timing chart showing an operation for sending and receiving CEC frame data when there is no logical address duplication between the first devices and the second devices. Here, only the related devices are shown. In FIG. 23, [8] represents a logical address entered in the reception-side logical address area 912 for a CEC Give command and represents a logical address entered in the transmission-side logical address area 911 for a CEC Report command.

When there is no logical address duplication between the first devices 300, 310 and 320 and the second devices 500, 510, 520 and 530 as shown in FIGS. 3 and 5, for instance, the PDP 300 generates the CEC frame data 900 based on the PDP recognition list 301 in order to perform a predetermined command to the second BDP 510 assigned with the logical address “8”. In the CEC frame data 900, the logical address “0” is entered in the transmission-side logical address area 911 of the header block 910, the logical address “8” is entered in the reception-side logical address area 912 of the header block 910, and the data block 920 is set for the predetermined command. Then, as shown in FIG. 23, the PDP 300 sends the CEC frame data 900 as a CEC Give command to the first radio unit 200 (step S61).

When receiving the CEC Give command, the first ACK response substitution executor 206 of the first radio unit 200 determines whether or not the second BDP 510 having the logical address “8” is connected to the second radio unit 400 based on the second logical address information 212 of the shared device list 210. When it is determined to be connected, the first ACK response substitution executor 206 substitutes for the second BDP 510 to perform an ACK response process related to the ACK area 914 of the header block 910 and the ACK area 923 of the data block 920 of the CEC frame data 900 so as to report the reception of the CEC Give command by the second BDP 510 to the PDP 300 (i.e., the initiator) (step S62). Even when the initiator of the CEC Give command is the first BDP 310 or the first DVDR 320, the same process is performed.

The first ACK response substitution executor 206 also sends the CEC Give command to the second radio unit 400 via the first radio-side transmitter/receiver 202 (step S63).

When receiving the CEC Give command, the second radio unit 400 gives a wireless packet reception response to the first radio unit 200 for reporting the reception of the CEC Give command (step S64). The second radio unit 400 also sends to the second BDP 510 the CEC Give Command in which “8” is entered in the reception-side logical address area 912 (step S65).

When receiving the CEC Give command, the second BDP 510 gives an ACK response for reporting the reception of the CEC Give Command (step S66). Subsequently, the second BDP 510 sends to the second radio unit 400 the CEC frame data 900 as a CEC Report command (i.e., a response command in response to the CEC Give command), CEC frame data 900 having the header block 910 in which the logical address “0” of the PDP 300 (i.e., the initiator of the CEC Give command) is entered in the reception-side logical address area 912 and its own logical address “8” is entered in the transmission-side logical address area 911, and the data block 920 related to the result of the execution of the CEC Give command (step S67).

When receiving the CEC Report command, the second ACK response substitution executor 406 determines whether or not the PDP 300 having the logical address “0” is connected to the first radio unit 200 based on the first logical address information 211 of the shared device list 210. When it is determined to be connected, the second ACK response substitution executor 406 substitutes for the PDP 300 to perform an ACK response process related to the ACK area 914 of the header block 910 and the ACK area 923 of the data block 920 of the CEC frame data 900 to report the reception of the CEC Report command by the PDP 300 to the second BDP 510 (i.e., the initiator) (step S68), and sends the CEC Report Command to the first radio unit 200 (step S69).

The first radio-side transmitter/receiver 202 of the first radio unit 200 relays the CEC Report command from the second radio unit 400 to the PDP 300 (step S71). The PDP 300 gives an ACK response for reporting the reception of the CEC Report command (step S72).

Operation for Sending and Receiving CEC Frame Data when there is Logical Address Duplication Between First Devices and Second Devices

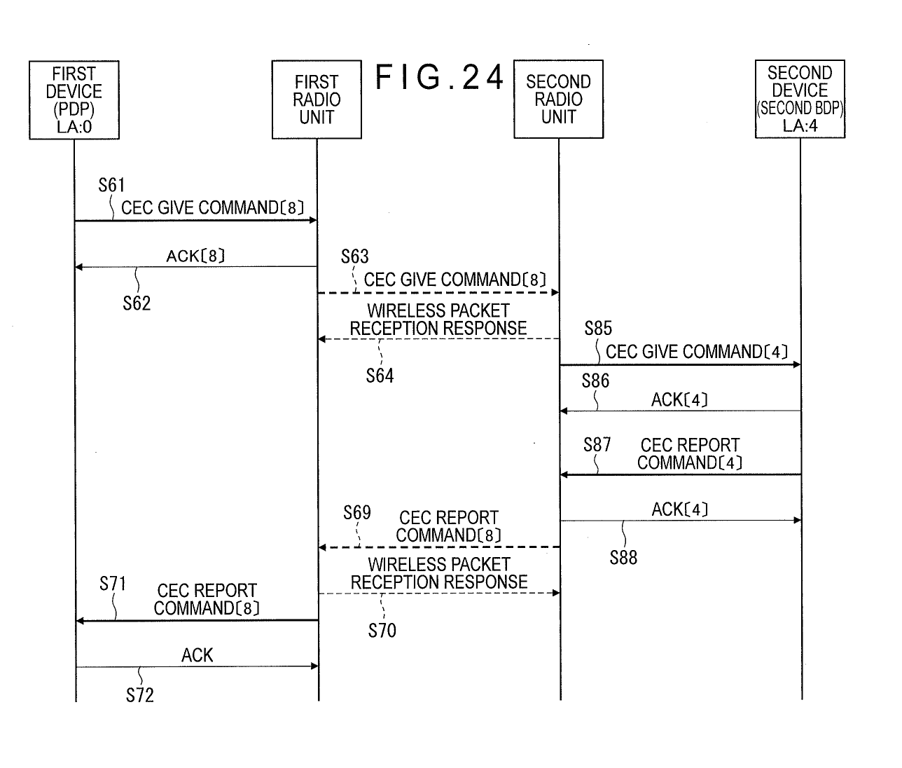

FIG. 24 is a timing chart showing an operation for sending and receiving CEC frame data when there is logical address duplication between the first devices and the second devices. Here, only the related devices are shown. In FIG. 24, each of [4] and [8] represents a logical address entered in the reception-side logical address area 912 for a CEC Give command and represents a logical address entered in the transmission-side logical address area 911 for a CEC Report command.

As shown in FIGS. 21 and 22, when the respective logical addresses of the first BDP 310 and the second BDP 510 are duplicately “4”, the PDP 300 enters “8” in the reception-side logical address area 912 of the logical address based on the PDP recognition list 301 for generating a CEC Give command to the second BDP 510. Then, as shown in FIG. 24, the PDP 300 sends the CEC Give command to the first radio unit 200 (step S61).

The first ACK response substitution executor 206 determines whether or not the second BDP 510 having the logical address “8” is connected to the second radio unit 400 based on the shared device list 210. The first ACK response substitution executor 206 refers to the replaced second logical address information 213 and the second logical address information 212, and recognizes that the logical address “8” on the shared device list 210 corresponds to the second BDP 510, which is replaced in association with “4” in the second logical address information 212. The first ACK response substitution executor 206 then substitutes for the second BDP 510 to perform an ACK response process related to the ACK area 914 of the header block 910 and the ACK area 923 of the data block 920 of the CEC frame data 900 for reporting the reception of the CEC Give command by the second BDP 510 to the PDP 300 (i.e., the initiator) (step S62), and sends to the second radio unit 400 the CEC Give command in which “8” is entered in the reception-side logical address area 912 (step S63).

When receiving the CEC Give command, the second radio unit 400 performs a process of step S64. The second ACK response substitution executor 406 refers to the replaced second logical address information 213 of the shared device list 210 shown in FIG. 22, and recognizes that although the logical address of the second BDP 510 entered in the reception-side logical address area 912 is “8”, the actual logical address of the second BDP 510 is “4”. The second ACK response substitution executor 406 replaces the content of the reception-side logical address area 912 from “8” to “4”, and sends this CEC Give command to the second BDP 510 via the first AVR 500 (step S85). At this time, since the content of the reception-side logical address area 912 is replaced, the first AVR 500 can send the CEC Give command to the second BDP 510 having the logical address “4”.

The second BDP 510 gives an ACK response for reporting the reception of the CEC Give Command (step S86). Subsequently, the second BDP 510 sends to the second radio unit 400 a CEC Report command (i.e., a response command in response to the CEC Give command) based on the CEC frame data 900 having the header block 910 in which the logical address “0” of the PDP 300 (i.e., the initiator of the CEC Give command) is entered in the reception-side logical address area 912 and its own logical address “4” is entered in the transmission-side logical address area 911, and the data block 920 related to the result of the execution of the CEC Give command (step S87).

When receiving the CEC Report command, the second ACK response substitution executor 406 of the second radio unit 400 determines whether or not the PDP 300 having the logical address “0” is connected to the first radio unit 200 based on the first logical address information 211 of the shared device list 210. When it is determined to be connected, the second ACK response substitution executor 406 substitutes for the PDP 300 to perform an ACK response process related to the ACK area 914 of the header block 910 and the ACK area 923 of the data block 920 of the CEC frame data 900 to report the reception of the CEC Report command by the PDP 300 to the second BDP 510 (i.e., the initiator) (step S88). The second ACK response substitution executor 406 also replaces the logical address in the transmission-side logical address area 911 from “4” to “8” based on the replaced second logical address information 213 (i.e., “8” is entered in the transmission-side logical address area 911), and sends the CEC Report command to the first radio unit 200 (step S69).

The first radio-side transmitter/receiver 202 of the first radio unit 200 relays the CEC Report command from the second radio unit 400 to the PDP 300 (step S71). The PDP 300 gives an ACK response for reporting the reception of the CEC Report command (step S72).

Through the above process, the PDP 300 recognizes that the process was performed by the second BDP 510 having the logical address “8” even though the process was actually performed by the second BDP 510 having the logical address “4”.

### Advantages of HDMI System of First Exemplary Embodiment

As described above, the first exemplary embodiment can achieve the following advantages.

1. When the first radio unit 200 of the HDMI system 100 receives the CEC frame data 900 directed to, for instance, the second BDP 510 from the PDP 300, the first radio unit 200 can recognize that the destination of the CEC frame data 900 is the second BDP 510 among a plurality of devices connected to the second radio unit 400 with reference to the content of the reception-side logical address area 912 and, in some cases, the content of the replaced second logical address information 213. When the first radio unit 200 recognizes that the second BDP 510 is connected to the second radio unit 400 based on the second logical address information 212 of the shared device list 210 and, in some cases, the replaced second logical address information 213 of the shared device list 210, the first radio unit 200 substitutes for the second BDP 510 to give an ACK response for reporting the reception of the CEC frame data 900 by the second BDP 510, and sends the CEC frame data 900 to the second BDP 510.

With the above arrangement, even when there are a plurality of possible destinations such as the second devices 500, 510, 520 and 530, the PDP 300 can receive the ACK response sent from the first ACK response substitution executor 206 with high responsivity, the ACK response being considered to be sent from the second BDP 510 intended to actually receives the CEC frame data 900. In addition, the CEC frame data 900 can be appropriately sent to the second BDP 510. Further, it is not required to provide each of the second devices 500, 510, 520 and 530 with a function to use the radio medium M, so that complication of the arrangements of the second devices 500, 510, 520 and 530 can be avoided.

2. When the first ACK response substitution executor 206 of the first radio unit 200 receives the CEC frame data 900 from any one of the first devices 300, 310 and 320 connected thereto, and determines that the destination of the received CEC frame data 900 is a device connected to the second radio unit 400 based on the shared device list 210, the first ACK response substitution executor 206 gives an ACK response to the initiator of this CEC frame data 900.

With the above arrangement, even when there are a plurality of possible initiators such as the first devices 300, 310 and 320, the first ACK response substitution executor 206 can give an ACK response for reporting that the CEC frame data 900 is received by the destination, i.e., one of the second devices 500, 510, 520 and 530, with accuracy and excellent responsivity.

3. When the first list manager 205 of the first radio unit 200 recognizes that, for instance, the respective logical addresses assigned to the first BDP 310 and the second BDP 510 are duplicately “4”, the first list manager 205 determines to replace the logical address “4” assigned to the second BDP 510 in the second logical address information 212 with any other available logical address in such a manner as to associate these logical addresses with each other, and thus acquires a logical address for replacement, e.g., “8”. The first list manager 205 generates the shared device list 210 including the replaced second logical address information 213 indicating that the second BDP 510 is assigned with the logical address “8”. The first list manager 205 then sends this shared device list 210 to the second radio unit 400. For instance, when the PDP 300 sends the CEC frame data 900 in which “8” is entered as the logical address of the destination in the reception-side logical address area 912, the first ACK response substitution executor 206 gives an ACK response for reporting that the command is received by the second BDP 510 having the logical address “8”. The first radio-side transmitter/receiver 202 sends the CEC frame data 900 via the second radio unit 400, and replaces the logical address “8” entered as the destination in the reception-side logical address area 912 with the logical address “4” based on the replaced second logical address information 213 of the shared device list 210, thereby allowing the second BDP 510 to receive the CEC frame data 900.

With the above arraignment, even if the respective logical addresses of the first BDP 310 and the second BDP 510 are duplicately “4”, an ACK response for substantially reporting reception by the second BDP 510 (i.e., the destination) can be given to the PDP 300 and the second BDP 510 can receive the CEC frame data 900 without altering the respective logical addresses of the first BDP 310 and the second BDP 510.

4. When the first radio unit 200 is switched from OFF to ON by supplying electric power thereto, the first list manager 205 of the first radio unit 200 recognizes the first devices 300, 310 and 320 and the like connected to the first radio unit 200, and newly generates the first logical address information 211. The first list manager 205 sends the first logical address information 211 to the second radio unit 400.

With the above arrangement, the first and second radio units 200 and 400 can reliably perform transmission and reception of the CEC frame data 900 based on the second logical address information 212 reflecting the latest connection status every time when the first radio unit 200 is switched ON.

When the first list manager 205 receives the CEC frame data 900 sent from a device connected to the first CEC network 101, the first list manager 205 recognizes a logical address entered in the transmission-side logical address area 911 and a logical address entered in the reception-side logical address area 912 of the header block 910 of the received CEC frame data 900. The first list manager 205 determines which process or command the CEC frame data 900 is provided for: the polling command [acquirement] process for acquiring an own logical address, a broadcasted command (i.e. “15” UNREGISTERED/BROADCAST is entered in the reception-side logical address area 912), or any other command.

In the case of the polling command [acquirement] process for acquiring an own logical address, the first list manager 205 recognizes the logical address entered in the reception-side logical address area 912, and determines whether or not this logical address is registered in the first logical address information 211. The first list manager 205 also monitors an ACK response/NACK response status of the ACK area 914. When this logical address is unregistered in the first logical address information 211 and a NACK response is given, the device is added in the first logical address information 211 in association with this logical address.

In the case of the broadcasted command, the first list manager 205 ends its operation without performing the above monitoring process.

In the case of any other command, the first list manager 205 recognizes the logical address entered in the reception-side logical address area 912, and determines whether or not this logical address is registered in the first logical address information 211. The first list manager 205 also monitors an ACK response/NACK response status of the ACK area 914.

With the above arrangement, when this logical address is unregistered in the first logical address information 211 and an ACK response is given, the shared device list 210 can be updated by adding the device to the first logical address information 211 in association with this logical address. When this logical address is registered in the first logical address information 211 and a NACK response is given, the shared device list 210 can be updated by deleting the device from the first logical address information 211 in association with this logical address. Thus, by sending the shared device list 210 to the second radio unit 400, the latest connection status can be always reflected, so that transmission and reception of the CEC frame data 900 can be reliably performed.

6. When the second ACK response substitution executor 406 of the second radio unit 400 receives the CEC frame data 900 from any one of the second devices 500, 510, 520 and 530 connected thereto, and determines that the destination of the received CEC frame data 900 is a device connected to the first radio unit 200 based on the shared device list 210, the second ACK response substitution executor 406 gives an ACK response to the initiator of this CEC frame data 900.

With the above arrangement, even when there are a plurality of possible initiators such as the second devices 500, 510, 520 and 530, the second ACK response substitution executor 406 can give an ACK response for reporting that the CEC frame data 900 is received by the destination (i.e., one of the first devices 300, 310 and 320) with high accuracy and responsivity.

7. For instance, when the second BDP 510 sends the CEC frame data 900 in which “4” is entered as the logical address of the initiator in the transmission-side logical address area 911, the second ACK response substitution executor 406 of the second radio unit 200 replaces the logical address “4” entered as the destination in the transmission-side logical address area 911 with the logical address “8” based on the replaced second logical address information 213 of the shared device list 210, thereby allowing the PDP 300 to receive the CEC frame data 900.

With the above arrangement, even when the respective logical addresses of the first BDP 310 and the second BDP 510 are duplicately “4”, it is possible to allow the PDP 300 to receive the CEC frame data 900 from the second BDP 510 (i.e., the initiator) without altering the respective logical addresses of the first BDP 310 and the second BDP 510.

8. When the second list manager 405 receives the CEC frame data 900 sent from a device connected to the second CEC network 102, the second list manager 405 recognizes the logical address entered in the transmission-side logical address area 911 and the logical address entered in the reception-side logical address area 912 of the header block 910 of the received CEC frame data 900. The second list manager 405 then determines which process or command the CEC frame data 900 is provided for: the polling command [acquirement] process for acquiring an own logical address, a broadcasted command (i.e. “15” UNREGISTERED/BROADCAST is entered in the reception-side logical address area 912), or any other command.

In the case of the polling command [acquirement] process for acquiring an own logical address, the second list manager 405 recognizes the logical address entered in the reception-side logical address area 912, and determines whether or not this logical address is registered in the second logical address information 212. The second list manager 405 also monitors an ACK response/NACK response status of the ACK area 914. When this logical address is unregistered in the second logical address information 212 and a NACK response is given, the device is added in the second logical address information 212 in association with this logical address.

In the case of the broadcasted command, the second list manager 405 ends its operation without performing the above monitoring process.

In the case of any other command, the second list manager 405 recognizes the logical address entered in the reception-side logical address area 912, and determines whether or not this logical address is registered in the second logical address information 212. The second list manager 405 also monitors an ACK response/NACK response status of the ACK area 914.

With the above arrangement, when this logical address is unregistered in the second logical address information 212 and an ACK response is given, the shared device list 210 can be updated by adding the device to the second logical address information 212 in association with this logical address. When this logical address is registered in the second logical address information 212 and a NACK response is given, the shared device list 210 can be updated by deleting the device from the second logical address information 212 in association with this logical address. Thus, by sending the shared device list 210 to the first radio unit 200, the latest connection status can be always reflected, so that transmission and reception of the CEC frame data 900 can be reliably performed.

9. When the second radio unit 400 is switched from OFF to ON by supplying electric power thereto, the second list manager 405 of the second radio unit 400 recognizes the second devices 500, 510, 520 and 530 and the like connected to the second radio unit 400, and newly generates the second logical address information 212. The second list manager 405 sends the second logical address information 212 to the first radio unit 200.

With the above arrangement, the first and second radio units 200 and 400 can reliably perform transmission and reception of the CEC frame data 900 based on the second logical address information 212 reflecting the latest connection status every time when the second radio unit 400 is switched ON.

10. When the second radio unit 400 is switched from OFF to ON and the second list manager 405 determines that connection between the first radio unit 200 and the second radio unit 400 is established, the second list manager 405 recognizes the second devices 500, 510, 520 and 530 connected to the second radio unit 400, and newly generates the second logical address information 212.

With the above arrangement, when the second radio unit 200 is switched ON and connection between the first radio unit 200 and the second radio unit 400 is established, the second list manager 405 generates the second logical address information 212 reflecting the latest connection status, thereby preventing the second logical address information 212 from being unnecessarily generated and sent when the first radio unit 200 is switched OFF and thus data cannot be received.

### Second Exemplary Embodiment

Next, description will be made on a second exemplary embodiment of the invention.

In the above first exemplary embodiment, in relation to the connection-establishing process of step S5 performed when the first and second radio units 200 and 400 are connected to each other, it is described that “[d]epending on a change in the hotplug status at this time, the second devices 500, 510, 520 and 530 discard respective own logical addresses having been acquired (i.e., the respective logical addresses of these devices become “15” UNREGISTERED).” However, in fact, it can be assumed that there is connected a device that holds the acquired logical address and physical address in a memory or the like to continuously maintain these addresses as long as power is supplied thereto. If so, the above result cannot be achieved.

Further, in the above description, what is referred to as the polling command [acquirement] is a polling command based on the CEC frame data 900 not having the data block 920 but only having the header block 910, in which a desired logical address is entered in both the transmission-side logical address area 911 and the reception-side logical address area 912, and what is referred to as the polling command [recognition] is a polling command based on the CEC frame data 900 not having the data block 920 but only having the header block 910 in which its own logical address is entered in the transmission-side logical address area 911 and a target logical address for connection confirmation is entered in the reception-side logical address area 912. However, in fact, it can be assumed that there is connected a device that does not use such different types of polling command for different purposes.

An example of such a device is a device that acquires its own logical address by using the polling command [recognition] process.

In the second exemplary embodiment, description will be made on an HDMI system 100A on the assumption that there is connected a device designed to operate as described above. Incidentally, in the description on the second exemplary embodiment and the below-described third exemplary embodiment, the polling command [acquirement] and the polling command [recognition] are not particularly differentiated from each other but referred to as polling commands.

### Operations of HDMI System

Initially, description will be made on operations of the HDMI system.

Operation when First Radio Unit and Second Radio Unit are Connected

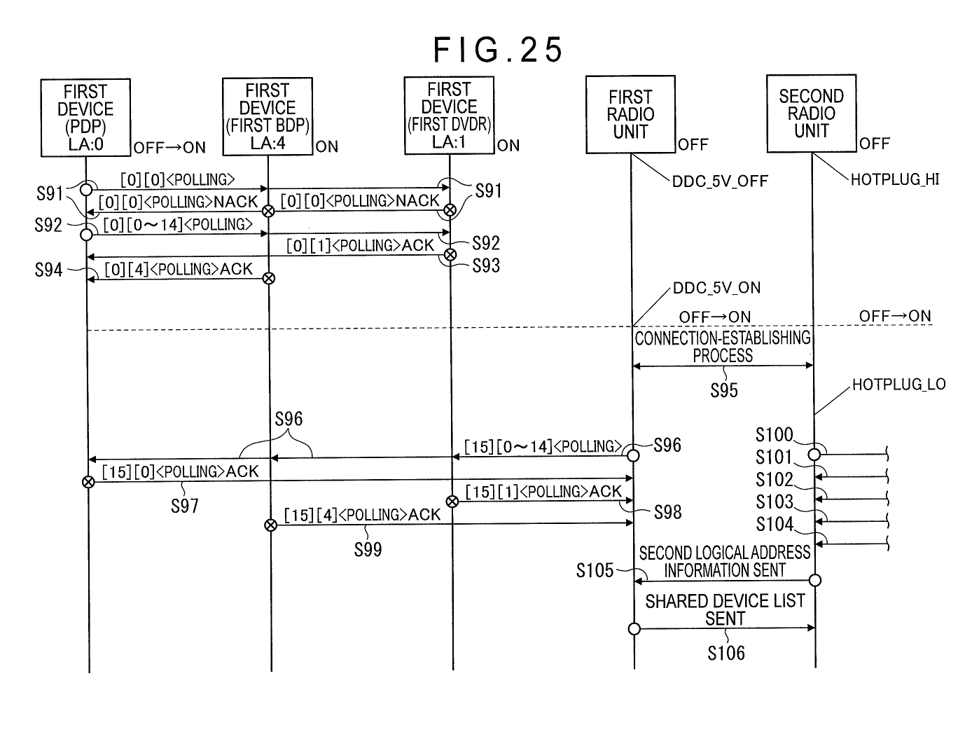

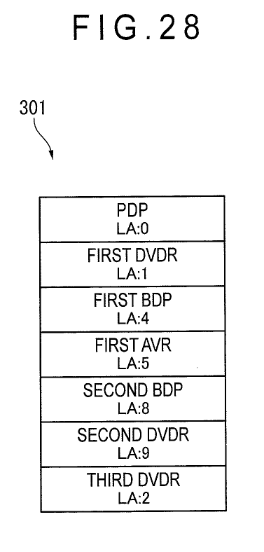

FIGS. 25 to 27 are timing charts showing an operation performed when the first radio unit and the second radio unit are connected. FIG. 28 schematically shows a PDP recognition list.

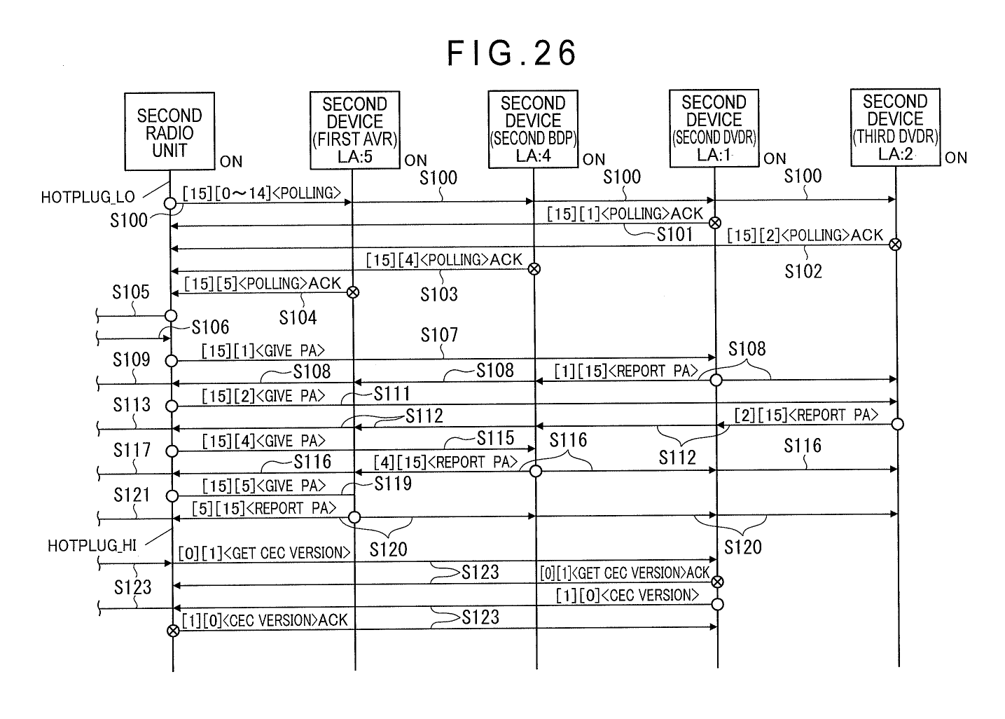

In the HDMI system 100A shown in FIG. 7, a first radio unit 200A to which the first devices 300, 310 and 320 are connected is disconnected from a second radio unit 400A to which the second devices 500, 510, 520 and 530 are connected, the first devices 310 and 320 having been switched ON to be connected to the first CEC network 101 as shown in FIG. 25, the second devices 500, 510, 520 and 530 also having been switched ON to be connected to the second CEC network 102 as shown in FIG. 26. At this time, the devices 300 to 320 and 500 to 530 have already acquired respective own logical addresses upon connection. Here, since the first and second CEC networks 101 and 102 are present, the respective logical addresses of the first BDP 310 and the second BDP 510 are both “4” and the respective logical addresses of the first DVDR 320 and the second DVDR 520 are both “1”.

As shown in FIG. 25, when the PDP 300 is switched from OFF to ON, the PDP 300 acquires its own logical address “0” (step S91). The PDP 300 performs a polling command process to the first radio unit 200A, the first BDP 310 and the first DVDR 320 so as to recognize a connected device or devices (step S92).

The first DVDR 320 gives an ACK response for reporting the reception of the header block 910 having the logical address “1” entered in the reception-side logical address area 912 (Step S93). Likewise, when the first BDP 310 receives the header block 910 having the logical address “4” entered in the reception-side logical address area 912, the first BDP 310 gives an ACK response for reporting the reception (Step S94). The first radio unit 200A gives a NACK response because the first radio unit 200A is OFF.

Based on these ACK responses, the PDP 300 recognizes the first devices 310 and 320 to which the CEC frame data 900 can be sent and the respective logical addresses thereof, and generates and stores the PDP recognition list 301.

Then, when the first and second radio units 200A and 400A are switched from OFF to ON, the DDC_{—}5V of the first radio unit 200A becomes ON. Further, the first radio unit 200A starts an initialization process, thereby providing a communicatable status via the radio medium M as shown in FIG. 8, and also performs a connection-establishing process relative to the second radio unit 400A (step S95). In the connection-establishing process, an HDMI repeater process is performed. The HDMI repeater process includes a process for switching the hotplug of the second radio unit 400A from HIGH to LOW, a process for reading or writing the EDID of the PDP 300, and the like.

Next, in order to recognize a connected device or devices, a first list manager 205A of the first radio unit 200A sequentially performs the polling command process to the first CEC network 101 in the same manner as the process by the PDP 300 in step S92 (Step S96). In response to the polling command process, the PDP 300 gives an ACK response for reporting the reception of the header block 910 with the logical address “0” being entered in the reception-side logical address area 912, the first DVDR 320 gives an ACK response for reporting the reception of the header block 910 with the logical address “1” being entered in the reception-side logical address area 912, and the first BDP 310 gives an ACK response for reporting the reception of the header block 910 with the logical address “4” being entered in the reception-side logical address area 912 (steps S97, S98 and S99). When the first CEC-side transmitter/receiver 201 confirms the ACK responses, the first list manager 205A generates the first logical address information 211 indicating that the PDP 300, the first BDP 310 and the first DVDR 320 are respectively assigned with the logical addresses “0”, “4” and “1”.

As shown in FIGS. 25 and 26, a second list manager 405A of the second radio unit 400A performs the polling command process to the second CEC network 102, to which the first AVR 500, the second BDP 510, the second DVDR 520 and the third DVDR 530 are connected, at substantially the same timing as the process by the first radio unit 200A in step S96 so as to generate the second logical address information 212 (step S100). When the second CEC-side transmitter/receiver 401 recognizes ACK responses given by the second DVDR 520, the third DVDR 530, the second BDP 510 and the first AVR 500 in response to the polling command using the header block 910 with “1” being entered in the reception-side logical address area 912, the polling command based on the header block 910 with “2” being entered in the reception-side logical address area 912, the polling command using the header block 910 with “4” being entered in the reception-side logical address area 912, and the polling command based on the header block 910 with “5” being entered in the reception-side logical address area 912 (steps S101, S102, S103 and S104), the second list manager 405A generates the second logical address information 212. The second list manager 405A sends the second logical address information 212 to the first list manager 205A of the first radio unit 200A (step S105).

When the first list manager 205A receives the second logical address information 212 and determines that the respective logical addresses of the first BDP 310 and the second BDP 510, which are playback devices, are duplicately “4” based on the first logical address information 211 and the second logical address information 212, the first list manager 205A replaces the logical address of the second BDP 510 in the second logical address information 212 with any other logical address available for a playback device. In replacement, the first list manager 205A refers to the values representing logical addresses in ascending order to determine whether or not each logical address is replaceable. Here, the first list manager 205A initially confirms whether or not there is any one(s) of the first and second devices 300, 320, 500, 520 and 530 assigned with “8”. Since there is no such a device, the first list manager 205A determines to replace the logical address in the second logical address information 212 with “8”.

Likewise, the first list manager 205A determines to replace the logical address corresponding to the second DVDR 520 in the second logical address 212 with any other logical address available for a recording device because this logical address is duplicated with the logical address of the first DVDR 320. Here, the first list manager 205A initially confirms whether or not “2” is replaceable, and recognizes that “2” has been acquired by the third DVDR 530. The first list manager 205A thus determines to replace the second logical address information 212 of the second DVDR 520 with the second smallest logical address “9” after confirming that “9” is unused. Here, the first radio unit 200A may perform the polling command process for reconfirming whether or not the replaced logical address is used for the first devices 300, 310 and 320.

As shown in FIG. 22, the first radio unit 200A generates the shared device list 210 including not only the first logical address information 211 and the second logical address information 212 but also the replaced second logical address information 213 indicating that the respective logical addresses corresponding to the second BDP 510 and the second DVDR 520 in the second logical address information 212 are replaced with “8” and “9”. The first radio unit 200A then instructs the first memory 204 to store the shared device list 210 therein. Further, the first radio unit 200A sends the shared device list 210 to the second list manager 405A so that the shared device list 210 is stored in the second memory 404 (step S106). Here, the second radio unit 400A may perform the polling command for reconfirming whether or not the replaced logical address is used for the second devices 500, 510, 520 and 530.

Since only the devices connected to the first CEC network 101 are registered in the PDP recognition list 301 of the PDP 300 at this stage, the following process is performed for additionally registering the first AVR 500, the second BDP 510, the second DVDR 520 and the third DVDR 530 of the second CEC network 102 in the PDP recognition list 301. When there is logical address duplication between the first and second CEC networks 101 and 102, it is required to register the logical address corresponding to the replaced second logical address information 213 in the PDP recognition list 301 of the PDP 300.

Here, in order to allow the PDP 300 to recognize devices connected to the second CEC network 102, a “Report Physical Address (hereinafter abbreviated as ‘Report PA’)” command complying with the HDMI standard is used. A “Report PA” command is a command used for reporting association between the logical address and physical address of a device to other devices. When a device is newly connected to a CEC network, such a command is sent to devices existing on the network. When a device needs to obtain information of the physical address associated with the logical address of a specific device, a “Give Physical Address (hereinafter abbreviated as ‘Give PA’)” command is sent, and a “Report PA” command is used as a response command thereto.

Initially, as shown in FIG. 26, the second radio unit 400A sets “1” in the reception-side logical address area 912 based on the second logical address information 212, and sends to the second DVDR 520 a “Give PA” command requiring response by a “Report PA” command (step S107). When receiving the “Give PA” command, the second DVDR 520 broadcasts a “Report PA” command, i.e., the CEC frame data 900, the CEC frame data 900 having the header block 910, in which “15” UNREGISTERED/BROADCAST is entered in the reception-side logical address area 912 and its own logical address “1” is entered in the transmission-side logical address area 911, and the data block 920 related to the result of the execution of “Give PA” (step S108).

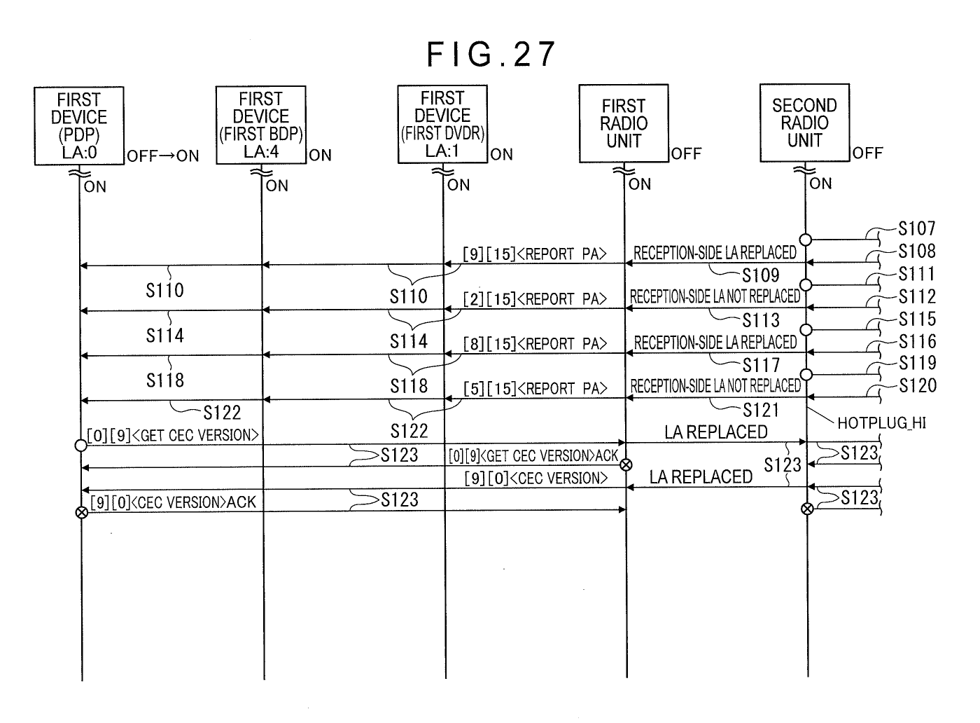

When receiving the “Report PA” command, the second radio unit 400A determines that the command was broadcasted, and thus gives a NACK response. In addition, as shown in FIG. 27, the second radio unit 400A replaces the content in the reception-side logical address area 912 from “1” to “9”, and sends the “Report PA” command to the first radio unit 200A (step S109). At this time, the physical address may also be stored in association with the logical address as needed.

The first radio-side transmitter/receiver 202 of the first radio unit 200A relays the “Report PA” command from the second radio unit 400A to the first CEC network 101 (step S110).

Upon receipt of the “Report PA” command from the second DVDR 520, the PDP 300 recognizes that a new device has been connected, and thus additionally registers the replaced logical address “9” for the second DVDR 520 in the PDP recognition list 301.

As shown in FIG. 26, the second radio unit 400A enters “2” in the reception-side logical address area 912, and sends a “Give PA” command to the third DVDR 530 (step S111). The third DVDR 530 enters its own logical address “2” in the transmission-side logical address area 911 of a “Report PA” command as a responding process to the “Give PA” command, and broadcasts the “Report PA” command (step S112).

When receiving the “Report PA” command, the second radio unit 400A gives a NACK response, and also sends the “Report PA” command to the first radio unit 200A without replacing the content in the transmission-side logical address area 911 as shown in FIG. 27 (step S113). At this time, the physical address may also be stored in association with the logical address as needed.

The first radio unit 200A sends the “Report PA” command to the first CEC network 101 (step S114).

When receiving the “Report PA” command from the third DVDR 530, the PDP 300 additionally registers the logical address “2” for the third DVDR 530 in the PDP recognition list 301.

As shown in FIG. 26, the second radio unit 400A enters “4” in the reception-side logical address area 912, and sends a “Give PA” command to the second BDP 510 (step S115). Upon receipt of the “Give PA” command, the second BDP 510 enters its own logical address “4” in the transmission-side logical address area 911 of a “Report PA” command, and broadcasts the “Report PA” command (step S116).

When receiving the “Report PA” command, the second radio unit 400A determines that the command was broadcasted, and thus gives a NACK response. Further, based on the second logical address information 212 and the replaced second logical address information 213 of the shared device list 210, the second radio unit 400A recognizes that a command in which the transmission-side logical address is set at “4” should be sent to the first radio unit 200A after replacing the transmission-side logical address with “8”. Thus, as shown in FIG. 27, the second radio unit 400A sends the “Report PA” command to the first radio unit 200A after replacing the content in the transmission-side logical address area 911 from “4” to “8” (step S117). At this time, the physical address may also be stored in association with the logical address as needed.

The first radio unit 200A sends the “Report PA” command from the second radio unit 400A to the first CEC network 101 (step S118).

Upon receipt of the “Report PA” command from the second BDP 510, the PDP 300 recognizes that a new device has been connected, and thus additionally registers the replaced logical address “8” for the second BDP 510 in the PDP recognition list 301.

As shown in FIG. 26, the second radio unit 400A enters “5” in the reception-side logical address area 912, and sends a “Give PA” command to the first AVR 500 (step S119). When receiving the “Give PA” command, the first AVR 500 enters its own logical address “5” in the transmission-side logical address area 911 of a “Report PA” command, and broadcasts the “Report PA” command (step S120).

When receiving the “Report PA” command, the second radio unit 400A gives a NACK response, and also sends the “Report PA” command without replacing the content in the reception-side logical address area 912 to the first radio unit 200A (step S121). At this time, the physical address may also be stored in association with the logical address as needed.

The first radio unit 200A sends the “Report PA” command from the second radio unit 400A to the first CEC network 101 (step S122).

When receiving the “Report PA” command from the first AVR 500, the PDP 300 additionally registers the logical address “5” for the first AVR 500 in the PDP recognition list 301.

Based on these “Report PA” commands, the PDP 300 not only recognizes the first devices 310 and 320 to which the CEC frame data 900 can be sent but also recognizes the second devices 500, 510, 520 and 530 and the respective logical addresses thereof, and generates and stores the PDP recognition list 301 shown in FIG. 28.

When the second radio unit 400A ends the above additional registration process to the PDP 300 for additionally registering the first AVR 500, the second BDP 510, the second DVDR 520 and the third DVDR 530, the second radio unit 400A switches the hotplug from LOW to HIGH as shown in FIG. 26. Incidentally, the second radio unit 400A operates the hotplug at this timing for the purpose of suppressing CEC communication from the devices connected to the second CEC network 102. If such suppression is not particularly necessary, the hotplug can be switched from LOW to HIGH at any other timing.

If the physical addresses need to be managed in the shared device list 210, “Give PA” command-based processes may be performed in place of the polling command processes of step S96 and step S100.

Then, the PDP 300 performs a process for checking the version of the second DVDR 520 and the like as shown in FIGS. 26 and 27 (step S123).

Operation when First Radio Unit and First BDP are Connected/Disconnected

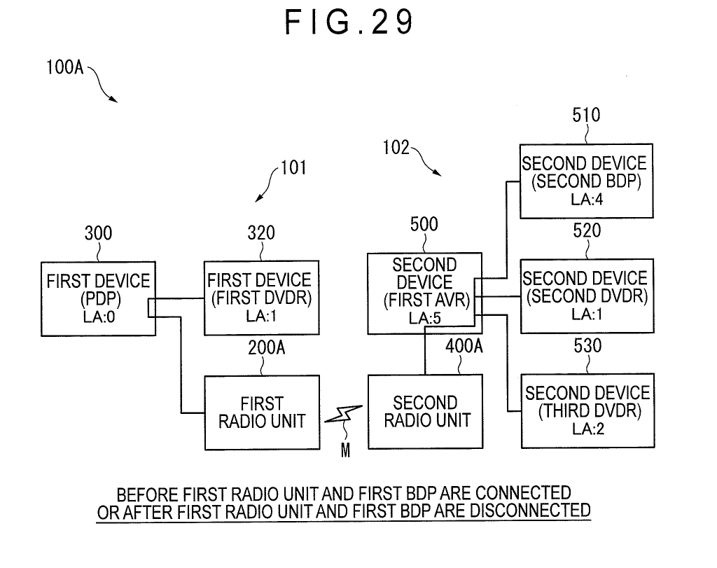

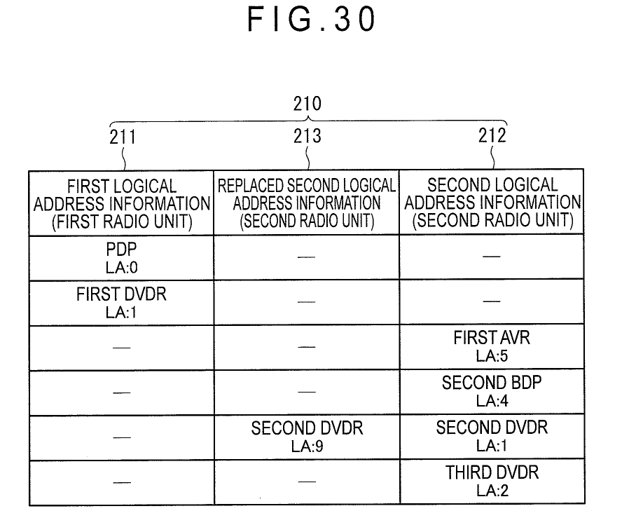

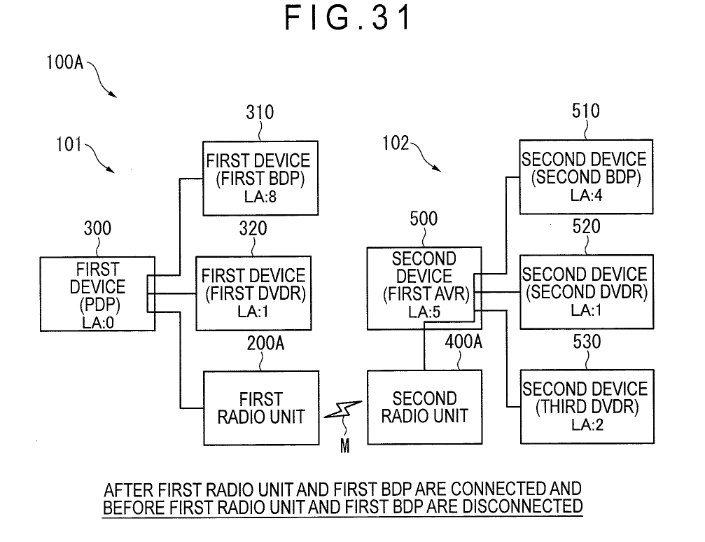

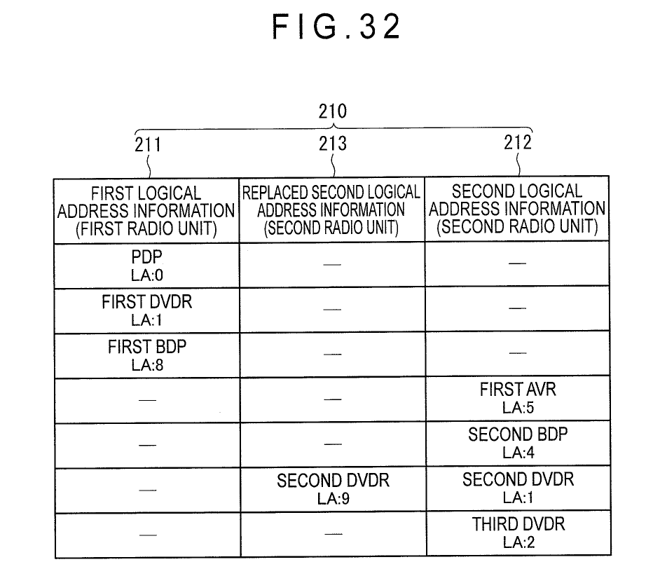

FIG. 29 schematically shows a device connection status and a logical address assignment status before the first radio unit and the first BDP are connected or after the first radio unit and the first BDP are disconnected. FIG. 30 schematically shows an updated status of the shared device list before the first radio unit and the first BDP are connected or after the first radio unit and the first BDP are disconnected. FIG. 31 schematically shows a device connection status and a logical address assignment status after the first radio unit and the first BDP are connected and before the first radio unit and the first BDP are disconnected. FIG. 32 schematically shows an updated status of the shared device list after the first radio unit and the first BDP are connected and before the first radio unit and the first BDP are disconnected

In the HDMI system 100A shown in FIG. 29, when the first BDP 310 is disconnected from the first CEC network 101, the first memory 204 stores the shared device list 210 shown in FIG. 30. When the first BDP 310 is connected to the first CEC network 101 as shown in FIG. 31, the first BDP 310, which is a playback device, performs the polling command process to confirm whether or not there are devices assigned with the assignable logical addresses “4”, “8” and “11” for acquiring its own logical address.

In response to this polling command process, based on the second logical address information 212 of the shared device list 210, a first ACK response substitution executor 206A of the first radio unit 200A gives an ACK response for reporting that the second BDP 510 is assigned with “4” and gives a NACK response for reporting that no device is assigned with “8” via the first CEC-side transmitter/receiver 201. Thus, the first BDP 310 acquires and maintains “8” as its own logical address as shown in FIG. 31.

The first BDP 310, which is newly connected to the CEC network, broadcasts a “Report PA” command for reporting association between its logical address and its physical address to other devices.

When receiving the “Report PA” command from the first BDP 310, the first list manager 205A gives a NACK response, and also updates the shared device list 210 by adding thereto the first logical address information 211 indicating that the logical address of the first BDP 310 is “8” as shown in FIG. 32. At this time, the physical address may also be stored in association with the logical address as needed.

Further, the first list manager 205A sends the updated shared device list 210 to the second list manager 405A to update the shared device list 210 in the second memory 404 as needed.

At this time, the first CEC-side transmitter/receiver 201 may perform the polling command process so as to reconfirm that the first BDP 310 has truly acquired “8”.

Upon receipt of the “Report PA” command from the first BDP 310, the PDP 300 recognizes the logical address of the first BDP 310, and adds the logical address of the first BDP 310 in the PDP recognition list 301 to store it.

When the first BDP 310 in the above status is disconnected as shown in FIG. 29, the disconnection of the first BDP 310 cannot be recognized by the first list manager 205A of the first radio unit 200A because the first list manager 205A is not adapted to recognize such a change.

Accordingly, the first list manager 205A monitors ACK responses and NACK responses given in response to the commands based on the CEC frame data 900 sent and received by the PDP 300 and the second devices 500, 510, 520 and 530. When the first list manager 205A recognizes that NACK responses are continuously given at a predetermined number of times in response to command transmission related to a logical address registered in the shared device list 210, the first list manager 205A performs the polling command process for confirming whether or not this logical address exists. When recognizing that a NACK response is given in relation to, for instance, the first BDP 310, as shown in FIG. 30, the first list manager 205A updates the shared device list 210 by deleting the first logical address information 211 regarding the first BDP 310 therefrom, and sends this updated shared device list 210 to the second radio unit 400A so that the updated shared device list 210 is stored in the second memory 404 as needed.

Incidentally, without performing the polling command process for confirming whether or not the logical address exists, the first list manager 205A may update the shared device list 210 by deleting the first logical address information 211 regarding the first BDP 310 therefrom upon recognizing that NACK responses are continuously given at a predetermined number of times in response to commands based on the CEC frame data 900 sent and received by the PDP 300 and the second devices 500, 510, 520 and 530.

Specifically, when receiving the CEC frame data 900 sent to a device connected to the first CEC network 101, the first list manager 205A of the first radio unit 200A checks the logical address entered in the reception-side logical address area 912 of the header block 910 of the received CEC frame data 900. If the logical address has been registered in the first logical address information 211, the first list manager 205A monitors an ACK response/NACK response status of the ACK area 914, and, in the case of a NACK response, the first list manager 205A performs a process for updating the shared device list 210 by deleting the device from the first logical address information 211 in association with the logical address. If “15” UNREGISTERED/BROADCAST based on the logical address assignment information 800 is entered in the reception-side logical address area 912, the first list manager 205A ends its operation without performing the above monitoring process.

If any other information such as a physical address is contained in association with the logical address, it may also be included in the updated shared device list 210.

Operation when Second Radio Unit and Second BDP are Connected/Disconnected

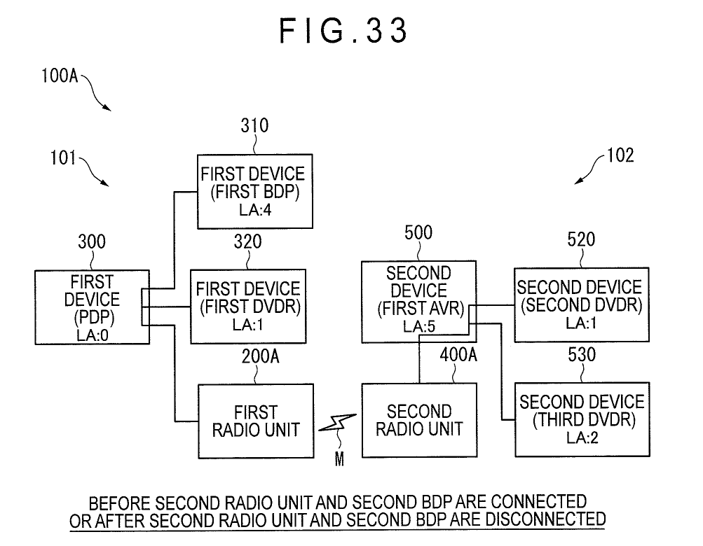

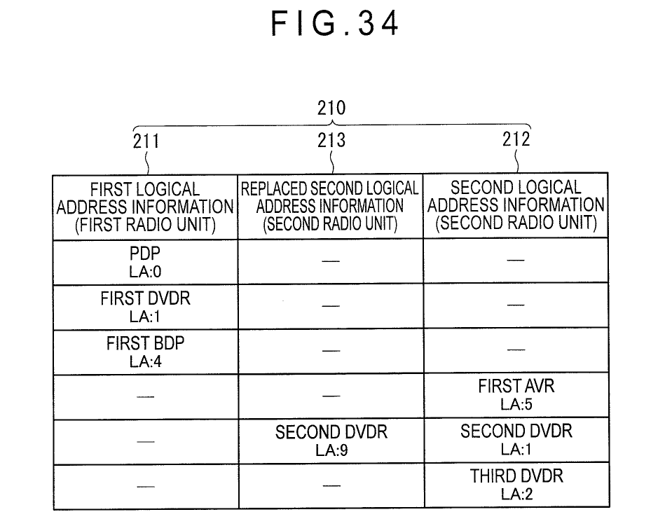

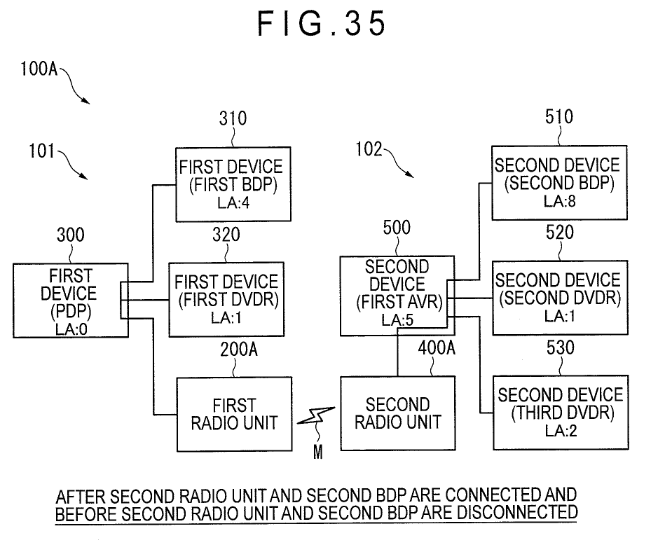

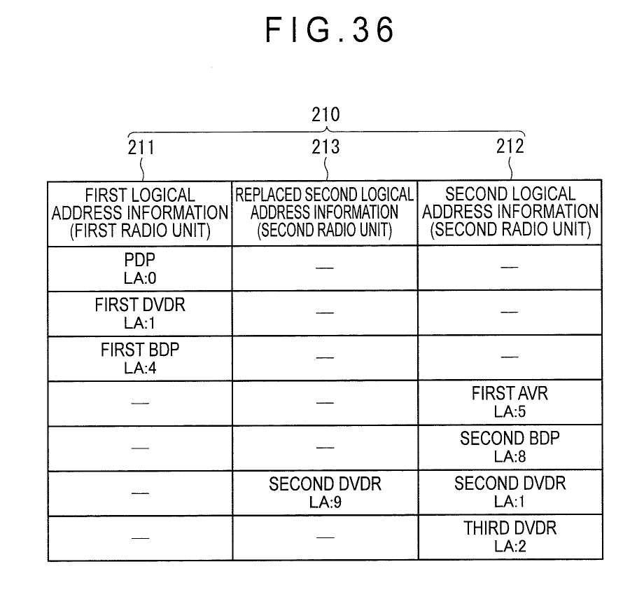

FIG. 33 schematically shows a device connection status and a logical address assignment status before the second radio unit and the second BDP are connected or after the second radio unit and the second BDP are disconnected. FIG. 34 schematically shows an updated status of the shared device list before the second radio unit and the second BDP are connected or after the second radio unit and the second BDP are disconnected. FIG. 35 schematically shows a device connection status and a logical address assignment status after the second radio unit and the second BDP are connected and before the second radio unit and the second BDP are disconnected. FIG. 36 schematically shows an updated status of the shared device list after the second radio unit and the second BDP are connected and before the second radio unit and the second BDP are disconnected

In the HDMI system 100A as shown in FIG. 33, when the second BDP 510 is disconnected from the second CEC network 102, the second memory 404 stores the shared device list 210 shown in FIG. 34. When the second BDP 510 is connected to the first CEC network 102 as shown in FIG. 35, the second BDP 510, which is a playback device, performs the polling command process to confirm whether or not there are devices assigned with the assignable logical addresses “4”, “8” and “11” for acquiring its own logical address. When the second BDP 510 recognizes NACK responses given from the second radio unit 400A and the like for reporting that there is no device assigned with “8”, the second BDP 510 acquires and maintains “8” as its own logical address.

The second BDP 510 then sends a “Report PA” command.

When receiving the “Report PA” command, the second list manager 405A gives a NACK response and updates the shared device list 210 by adding thereto the second logical address information 210 regarding the second BDP 510 and the associated physical address (as needed), and also sends the updated shared device list 210 to the first radio unit 200A so that the updated shared device list 210 is stored in the first memory 204 as needed.

Simultaneously, if logical address duplication is found, a logical address for replacement is set and added to the replaced second logical address information 213. Thereafter, the logical address replacing process will be performed based on this information.

At this time, the second list manager 405A may perform the polling command process so as to reconfirm that the second BDP 510 has truly acquired “8”.

When the second BDP 510 in the above status is disconnected as shown in FIG. 33, the disconnection of the second BDP 510 cannot be recognized by the second list manager 405A of the second radio unit 400A because the second list manager 405A is not adapted to recognize such a change. Accordingly, the second list manager 405A monitors ACK responses and NACK responses given in response to commands sent and received by the first devices 300 and 310 and the second devices 500, 520 and 530. When the second list manager 405A recognizes that NACK responses are continuously given at a predetermined number of times in response to the commands to the second BDP 510, the second list manager 405A performs the polling command process for confirming whether or not the second BDP 510 exists. Further, when recognizing a NACK response, the second list manager 405A updates the shared device list 210 by deleting the second logical address information 212 regarding the second BDP 510 therefrom as shown in FIG. 34, and sends the updated shared device list 210 to the first radio unit 200A so that the updated shared device list 210 is stored in the first memory 204 as needed.

At this time, if the logical address to be deleted is associated as a replaced logical address, the registered information in the second logical address information 212 and the registered information in the replaced second logical address information 213 are both deleted.

Incidentally, without performing the polling command process for confirming whether or not the logical address exists, the second list manager 405A may update the shared device list 210 by deleting therefrom the second logical address information 212 regarding the second BDP 510 and the replaced second logical address information 213 regarding the second BDP 510 (as needed) upon recognizing that NACK responses are continuously given at a predetermined number of times in response to commands based on the CEC frame data 900 sent and received by the PDP 300 and the second devices 310, 500, 520 and 530.

Specifically, when receiving the CEC frame data 900 sent to a device connected to the first CEC network 102, the first list manager 405A of the first radio unit 400A checks the logical address entered in the reception-side logical address area 912 of the header block 910 of the received CEC frame data 900. If the logical address has been registered in the second logical address information 212, the second list manager 405A may monitor an ACK response/NACK response status of the ACK area 914, and, in the case of a NACK response, the second list manager 405A may perform a process for updating the shared device list 210 by deleting the device from the second logical address information 212 and from the replaced second logical address information 213 (as needed) in association with the logical address. If “15” UNREGISTERED/BROADCAST based on the logical address assignment information 800 is entered in the reception-side logical address area 912, the second list manager 405A ends its operation without performing the above monitoring process.

If any other information such as a physical address is contained in association with the logical address, it may also be included in the updated shared device list 210.

### Advantages of HDMI System of Second Exemplary Embodiment

As described above, the second exemplary embodiment can achieve the following advantages.

11. In the HDMI system 100A including the first and second radio units 200A and 400A, the PDP 300, the first BDP 310, the first DVDR 320, the first AVR 500, the second BDP 510, the second DVDR 520 and the third DVDR 530, it is possible to execute a power-on timing of each device and a timing of connecting each device to the CEC network without any user's particular operation. In addition, the PDP 300 can accurately recognize the connected devices on the CEC network, and thus can reliably send the CEC frame data 900 to the device intended to actually receive it.

12. In the HDMI system 100A including the first and second radio units 200A and 400A, the PDP 300, the first BDP 310, the first DVDR 320, the first AVR 500, the second BDP 510, the second DVDR 520 and the third DVDR 530, the PDP 300 can accurately recognize the connected devices on the CEC network irrespective of how each device acquires its own logical address and how each device stores the acquired logical address, so that the PDP 300 can reliably send the CEC frame data 900 to the device intended to actually receive it.

### Third Exemplary Embodiment

Next, description will be made on a third exemplary embodiment of the invention.

In the third exemplary embodiment, description will be made on an HDMI system 100B provided on the assumption that a CEC network includes product devices adapted to process the below-described specific command.

The third exemplary embodiment relates to “product devices adapted to process a specific command” because a general CEC command complying with the current HDMI standard is not adapted to function as described below, so that the third exemplary embodiment is realized based on a CEC command usable in a vendor-unique manner (hereinafter referred to as “vendor command”).

Thus, an arrangement of the third exemplary embodiment is effective if a CEC network has at least two product devices, one of which is a transmitting/receiving device, having a common idea of behavior (e.g., products of the same manufacturer) and being adapted to process a vendor command at the current moment.

In the future, if a general command for the same purpose according to the HDMI standard is added and a command process therefor is compulsorily required, or is standardized as a vendor command for the same purpose by industry groups or the like, a large variety of product devices can enjoy the same advantages as those of this exemplary embodiment.

The “vendor command” described hereinabove is a CEC command capable of incorporating a unique specification into a parameter, thereby functioning as described below. Examples of such a command are “Vendor Command”, “Vendor Command With ID” and “Vendor Remote Button Down”.

Here, the specific vendor command is exemplified by a “Logical Address Reset (hereinafter abbreviated as ‘LA Reset’)” that is structured as follows: “Vendor Command With ID” is entered as the opcode in the command area 921 of the first data block 920 after the header block 910 in the CEC frame data 900 shown in FIG. 2; a manufacturer ID is entered as the operand in the next data block 920; and the operand of the data block 920 after the manufacturer ID provides a parameter for promoting an operation process in which a command-receiving device discards its already-acquired logical address and then reacquires its own logical address.

Description will also be made on another specific vendor command requiring a device that needs to recognize all the devices on the CEC network, mainly such as a TV, to perform a device re-recognition process. This specific vendor command is referred to as “Polling Request (hereinafter abbreviated as ‘Polling Req’)” command when described.

Upon receipt of an “LA Reset” command, a device performs a logical address reacquiring process. In terms of simplification of this process, the command may be structured such that an additional data block 920 for a command-sending device to beforehand designate a logical address to be reacquired is provided as a parameter.

For achieving the same advantage of an “LA Reset” command, the command may be structured, for instance, as follows: “15” is entered in the reception-side logical address area 912 of the header block 910 in the CEC frame data 900 as shown in FIG. 2; “Vendor Command With ID” is entered as the opcode in the command area 921 of the first data block 920 thereafter; a manufacturer ID is entered as the operand in the next data block 920; the operand of the data block 920 after the manufacturer ID provides a parameter for promoting an operation process in which a command-receiving device discards its already-acquired logical address and then reacquires its own logical address; and a parameter for designating a logical address to be reset is provided in at least one data block 920 thereafter. The command may also be structured such that the additional data block 920 in which a logical address to be reacquired is beforehand designated is provided as a parameter, as described above. In this case, even in attempt to reset the respective logical addresses of a plurality of devices, a single command can simultaneously reset the plural logical addresses. Further, since the command is broadcasted and thus any device other than the target devices can also receive it, the PDP 300 may delete the designated logical address from the PDP recognition list 301, for instance, upon receipt of the command.

In this case, since the command is broadcasted, reception confirmation cannot be provided using an ACK response. In view of this, a separate report command for reception confirmation may be provided by a vendor command.

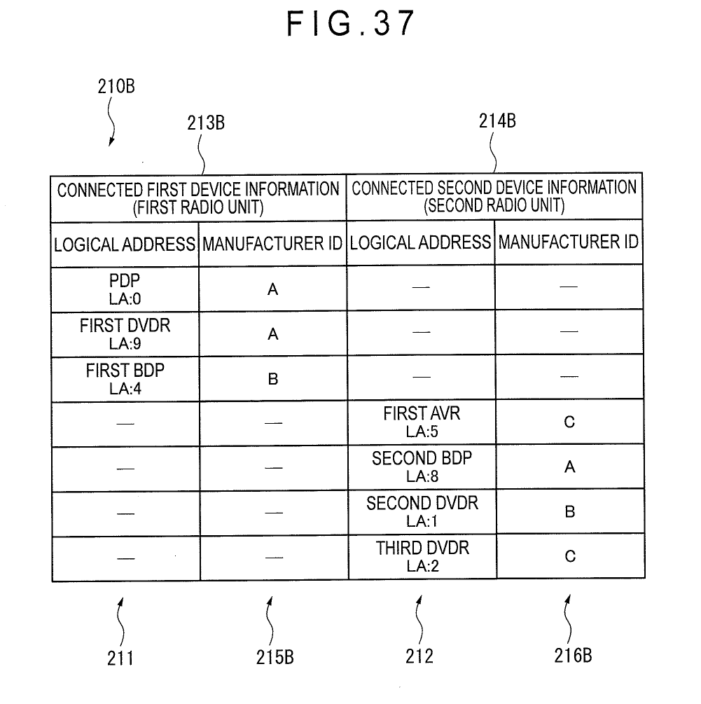

A command capable of obtaining the same result as that of a “Polling Req” command may be provided by a vendor command adapted to, for instance, directly edit the PDP recognition list 301 of the PDP 300 by adding or deleting a recognized logical address, or may be provided by a vendor command adapted to use the equivalent to a shared device list 210B (see FIG. 37) made and shared by first and second radio units 200B and 400B (see FIG. 7) as a parameter so that the shared device list 210 is transferred to be entirely or partly reflected in the PDP recognition list 301.

### Arrangement of Shared Device List

Initially, an arrangement of a shared device list used in the HDMI system 100B will be described.

FIG. 37 schematically shows a shared device list generated in relation to the first devices and the second devices.

As shown in FIG. 37, the shared device list 210B includes connected first device information 213B regarding devices connected to the first radio unit 200B and connected second device information 214B regarding devices connected to the second radio unit 400B.

In addition to the first logical address information 211, the connected first device information 213B includes first manufacturer ID information 215B showing the manufacturers IDs of the first devices shown in the first logical address information 211. In addition to the second logical address information 212, the connected second device information 214B includes second manufacturer ID information 216B showing the manufacturer IDs of the second devices shown in the second logical address information 212.

Incidentally, vendor command specification version information or the like may also be included because even if devices have the same manufacture ID, whether or not a command is processable is likely to depend on a difference in vendor command specification.

Here, the first CEC-side transmitter/receiver 201 and the second CEC-side transmitter/receiver 410 function as reset command transmitters of the invention and first and second list managers 205B and 405B function as reset command generators of the invention.

### Operations of HDMI System

Next, description will be made on operations of the HDMI system.

Incidentally, an operation performed when the first radio unit and the first BDP are connected or disconnected and an operation performed when the second radio unit and the second BDP are connected or disconnected are the same as those in the second exemplary embodiment, so that the descriptions thereof are omitted here.

Operation when First Radio Unit and Second Radio Unit are Connected

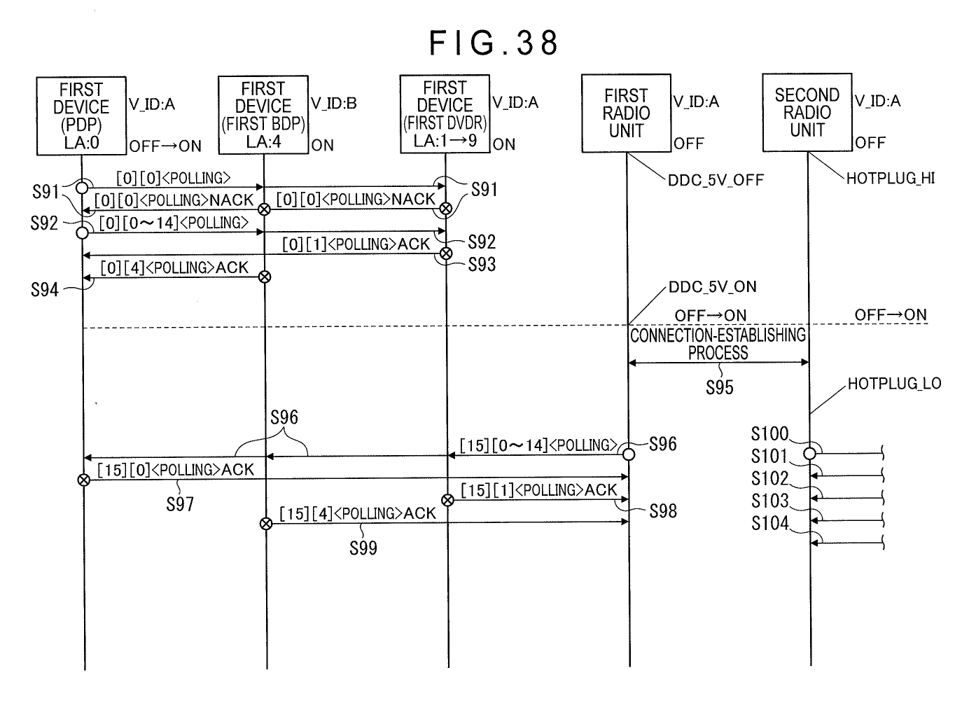

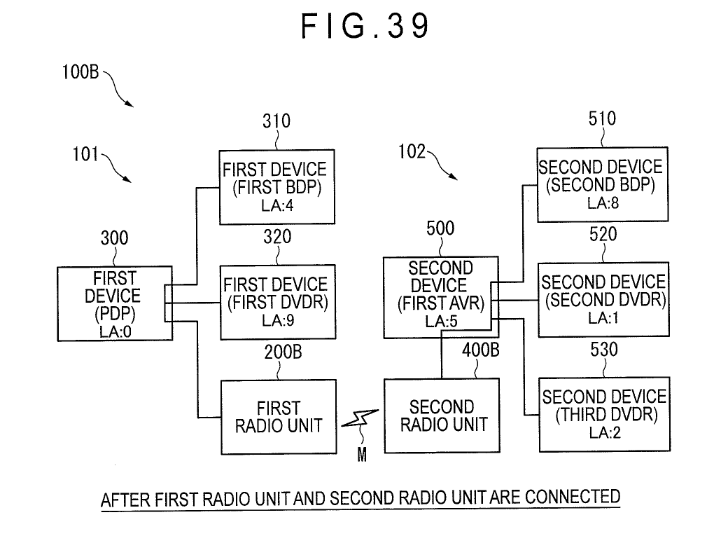

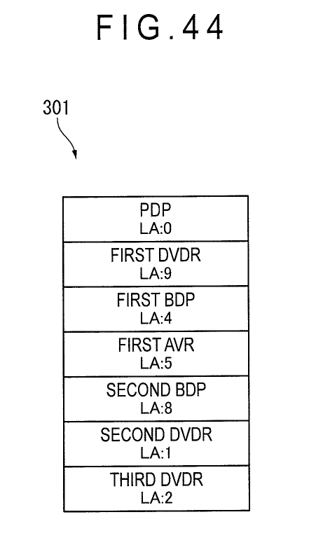

FIG. 38 and FIGS. 40 to 43 are timing charts showing an operation performed when the first radio unit and the second radio unit are connected. FIG. 39 schematically shows a device connection status and a logical address assignment status after the first radio unit and the second radio unit are connected to each other. FIG. 44 schematically shows a PDP recognition list.

Here, in the HDMI system 100B shown in FIG. 7, the first and second radio units 200B and 400B, the PDP 300, the first DVDR 320 and the second BDP 510 are product devices having the same manufacturer ID (i.e., the product devices are manufactured by the same manufacturer, for instance) and being adapted to recognize “LA Reset” commands and “Polling Req” commands.

Like reference numerals are attached to the same operations as those in the second exemplary embodiment, thereby omitting or simplifying the descriptions thereof.

FIG. 7 shows a situation where the first radio unit 200B to which the first devices 300, 310 and 320 are connected is disconnected from the second radio unit 400B to which the second devices 500, 510, 520 and 530, in which the first devices 310 and 320 have already been switched ON to be connected to the first CEC network 101, the second devices 500, 510, 520 and 530 have also already been switched ON to be connected to the second CEC network 102, and each device has already acquired its own logical address upon connection. Here, since the first and second CEC networks 101 and 102 are present, the respective logical addresses of the first BDP 310 and the second BDP 510 are both “4” and the respective logical addresses of the first DVDR 320 and the second DVDR 520 are both “1”.

As shown in FIG. 38, when the PDP 300 is switched from OFF to ON, the PDP 300, the first BDP 310, the first DVDR 320 perform steps S91 to S94 in the same manner as in the second exemplary embodiment. Based on the ACK responses, the PDP 300 recognizes the first devices 310 and 320 to which the CEC frame data 900 can be sent in the first CEC network 101 and the respective logical addresses thereof, and generates and stores the PDP recognition list 301.

Then, when the first and second radio units 200B and 400B are switched from OFF to ON, the DDC_{—}5V of the first radio unit 200B becomes ON. Further, the first connection processor 203 starts an initialization process, thereby providing a communicatable status via the radio medium M as shown in FIG. 39, and also performs the process of step S95 of the second exemplary embodiment (connection-establishing process).

The first list manager 205B of the first radio unit 200B, the PDP 300, the first BDP 310, and the first DVDR 320 perform steps S96 to S99 in the same manner as in the second exemplary embodiment. The first list manager 205B generates the first logical address information 211 indicating that the PDP 300, the first BDP 310 and the first DVDR 320 are respectively assigned with the logical addresses “0”, “4” and “1”.

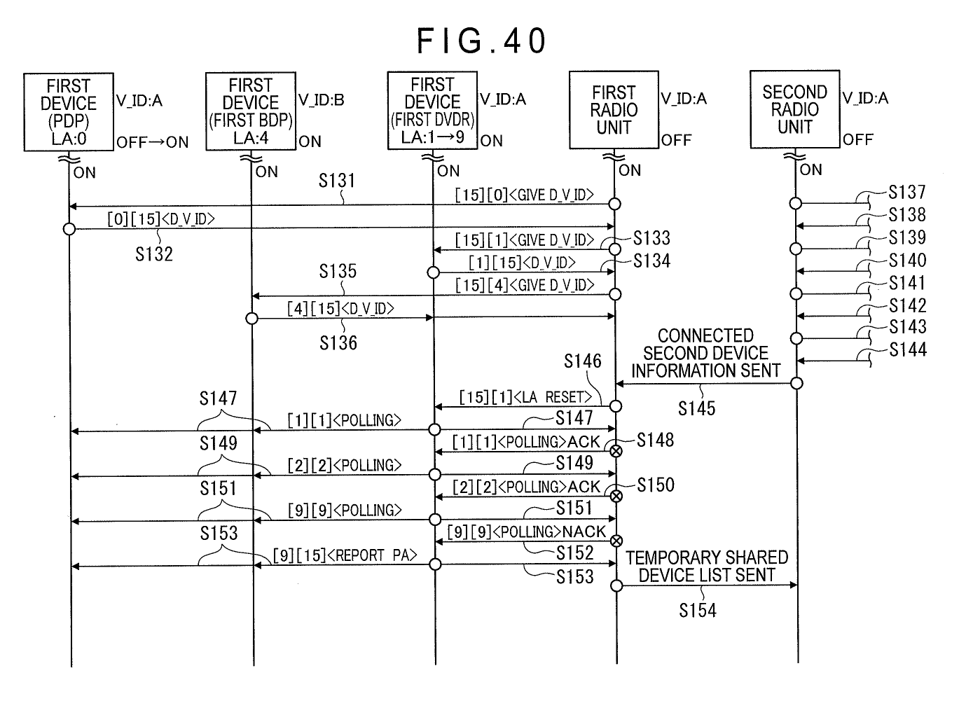

As shown in FIG. 40, based on the generated first logical address information 211, the first list manager 205B sends a “Give Device Vendor ID (hereinafter abbreviated as ‘Give D_V_ID’)” command to the PDP 300 of the first CEC network 101 in order to recognize the manufacturer ID (step S131). Here, a “Give D_V_ID” command is a general command according to the HDMI standard, and is used as a request command used to recognize the manufacturer ID. As a response command to a “Give D_V_ID”, a “Device Vendor ID (hereinafter abbreviated as ‘D_V_ID’)” command for reporting manufacturer ID information is also provided.

When receiving the “Give D_V_ID” command, the PDP 300 gives an ACK response for reporting the reception, and also broadcasts a report command, i.e., a “D_V_ID” command, for reporting that its manufacturer ID is “A” (step S132).

When receiving the “D_V_ID” command, the first list manager 205B of the first radio unit 200B adds the manufacturer ID (i.e., a command parameter) in the manufacturer ID information 215B of the connected first device information 213B of the shared device list 210B shown in FIG. 37 in association with the logical address entered in the transmission-side logical address area 911 of the header block 910. As a result, in the shared device list 210B, “0” is registered as the logical address of the PDP 300 and “A” is registered as the manufacturer ID.

Next, the first list manager 205B likewise sends a “Give D_V_ID” command to the first DVDR 320 (step S133). When receiving the “Give D_V_ID” command, the PDP 300 gives an ACK response, and also broadcasts a “D_V_ID” command for reporting its manufacturer ID is “A” (step S134). When receiving the “D_V_ID” command, the first list manager 205B adds the manufacturer ID “A” in the manufacturer ID information 215B of the connected first device information 213B in association with the logical address “1” of the first DVDR 320.

The first list manager 205B likewise sends a “Give D_V_ID” command to the first BDP 310 (step S135). When receiving this command, the first BDP 310 gives an ACK response, and also broadcasts a “D_V_ID” command for reporting its manufacturer ID is “B” (step S136). When receiving this command, the first list manager 200B adds the manufacturer ID “B” in the manufacturer ID information 215B of the connected first device information 213B in association with the logical address “4” of the first BDP 310.

As a result, the connected first device information 213B indicates as follows: the logical address of the PDP 300 is “0” and the manufacturer ID thereof is “1”; the logical address of the first DVDR 320 is “1” and the manufacturer ID thereof is “A”; and the logical address of the first BDP 310 is “4” and the manufacturer ID thereof is “B”.

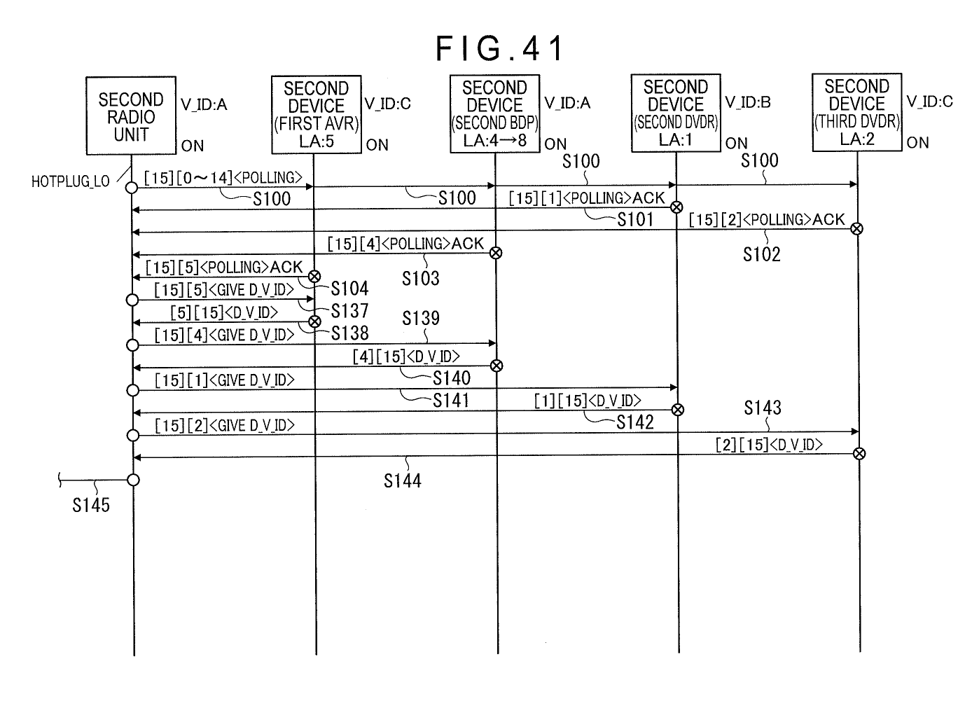

The second list manager 405B, the second DVDR 520, the third DVDR 530, the second BDP 510 and the first AVR 500 of the second radio unit 400B perform steps S100 to S104 in the same manner as in the second exemplary embodiment so that the second list manager 405B recognizes the connected devices as shown in FIGS. 38 and 41. When ACK responses are confirmed, the second list manager 405B generates the second logical address information 212 indicating that the respective logical addresses of the second DVDR 520, the third DVDR 530, the second BDP 510 and the first AVR 500 are “1”, “2”, “4” and “5”.

Further, as shown in FIGS. 40 and 41, based on the generated second logical address information 212, the second list manager 405B sequentially sends “Give D_V_ID” commands to the first AVR 500, the second BDP 510, the second DVDR 520 and the third DVDR 530 of the second CEC network 102 at substantially the same timing as that of the first radio unit 200B in step S131 so as to recognize the manufacturer IDs (steps S137, S139, S141 and S143).

When receiving the Give D_V_ID″ command, the first AVR 500 gives an ACK response, and also broadcasts a “D_V_ID” command for reporting its manufacturer ID is “C” (step S138). When receiving the “D_V_ID” command, the first list manager 400B registers the manufacturer ID “C” in the manufacturer ID information 216B of the connected second device information 214B in association with the logical address “5” of the first AVR 500. Likewise, the second BDP 510 broadcasts a “D_V_ID” command for reporting its manufacturer ID is “A”, the second DVDR 520 broadcasts a “D_V_ID” command for reporting its manufacturer ID is “B”, and the third DVDR 530 broadcasts a “D_V_ID” command for reporting its manufacturer ID is “C” (steps S140, S142 and S144). Upon receipt of these commands, the second radio unit 400B sequentially registers the manufacturer IDs in the manufacturer ID information 216B of the connected second device information 214B in association with the logical addresses.

As a result, the connected second device information 214B indicates as follows: the logical address of the first AVR 500 is “5” and the manufacturer ID thereof is “C”; the logical address of the second BDP is “4” and the manufacturer ID thereof is “A”; the logical address of the second DVDR 520 is “1” and the manufacturer ID thereof is “B”; and the logical address of the third DVDR 530 is “2” and the manufacturer ID thereof is “C”.

When the second list manager 405B of the second radio unit 400B completes generation of the connected second device information 214B regarding the second CEC network 102, the second list manager 405B sends the connected second device information 214B to the first list manager 205B of the first radio unit 200B (step S145).

As shown in FIG. 40, when receiving the connected second device information 214B, the first list manager 205B of the first radio unit 200B generates a temporary shared device list 210B based on the first logical address information 211 and the second logical address information 212 in order to check logical address duplication status and manufacturer ID information. As a result, the first list manager 205B determines that the respective logical addresses of the first BDP 310 and the second BDP 510, which are playback devices, are duplicately “4” and the respective logical addresses of the first DVDR 320 and the second DVDR 520 are duplicately “1”. Next, the first list manager 205B checks the respective manufacturer IDs of the first BDP 310 and the second BDP 510 having the duplicate logical address and the respective manufacturer IDs of the first DVDR 320 and the second DVDR 520 having the duplicate logical address. Based on the connected first device information 213B and the connected second device information 214B, the first list manager 205B determines that the first DVDR 320 and the second BDP 510 have the same manufacturer ID as that of the first and second radio units 200B and 400B, i.e., the manufacturer ID “A”.

Subsequently, since the first DVDR 320 has the manufacturer ID “A” in the first CEC network 101 and is capable of recognizing and processing a vendor command based on the connected first device information 213B, the first list manager 205B requests the first DVDR 320 to reacquire its own logical address because of logical address duplication. Specifically, the first list manager 205B sends an “LA Reset” command as a first reset command in which “1” is entered in the reception-side logical address area 912 (step S146).

Specifically, the first radio unit 200B checks the shared device list 210B managed thereby for logical address duplication. If the logical-address-duplicated device (i.e., a device having a duplicate logical address) is adapted to deal with an “LA Reset” command, the first radio unit 200B prompts reacquisition of a logical address to eliminate the logical address duplication between the first and second CEC networks 101 and 102.

Even though the logical address duplication is recognized based on the first logical address information 211 and the second logical address information 212, if the logical-address-duplicated device is not adapted to recognize and process a vendor command, the first list manager 205B of the first radio unit 200B does not send an “LA Reset” command but sends the temporary shared device list 210B to the second list manager 405B of the second radio unit 400B.

When receiving the “LA Reset” command, the first DVDR 320 gives an ACK response. The first DVDR 320 also discards its own logical address, and then starts a logical address reacquiring process. The first list manager 205B confirms the ACK response from the first DVDR 320, and updates the temporary shared device list 210B by deleting a logical address to be reacquired (i.e., the logical address “1”) from the first logical address information 211 or by treating it as a reserved logical address.

The first DVDR 320 initially enters a logical address available for a recording device, i.e., the logical address “1”, and performs the polling command process to the first CEC network 101 (step S147).

In response to this polling process, each of the PDP 300 and the first BDP 310 gives a NACK response.

Based on the second logical address information 212 of the temporary shared device list 210B, the first radio unit 200B recognizes that the logical address of the second DVDR 520 is “1”, and gives an ACK response (step S148).

When recognizing the ACK response from the first radio unit 200B, the first DVDR 320, which is a recording device, determines that the logical address “1” has already been acquired by another device. Then, in order to confirm whether or not another assignable logical address “2” based on the logical address assignment information 800 is available, the first DVDR 320 enters the logical address “2”, and again performs the polling command process to the first CEC network 101 (step S149).

In response to this polling process, each of the PDP 300 and the first BDP 310 gives a NACK response.

Based on the temporary shared device list 210B, the first radio unit 200B recognizes that the logical address of the third DVDR 530 is “2” and gives an ACK response (step S150).

When recognizing this ACK response, the first DVDR 320 determines that the logical address “2” has already been acquired by another device. Then, in order to confirm whether or not another assignable logical address “9” based on the logical address assignment information 800 is available, the first DVDR 320 enters the logical address “9”, and again performs the polling command process (step S151).

In response to this polling process, each of the PDP 300 and the first BDP 310 gives a NACK response.

Based on the temporary shared device list 210B, the first radio unit 200B recognizes that no device has acquired the logical address “9”, and gives a NACK response for reporting to the effect (step S152).

When receiving the NACK responses from the PDP 300, the first BDP 310 and the first radio unit 200B, the first DVDR 320 acquires and maintains “9” as its own logical address.

The first DVDR 320 then broadcasts a “Report Physical Address (hereinafter abbreviated as ‘Report PA’)” command for reporting association between its logical address and its physical address to other devices (step S153).

Upon receipt of the “Report PA” command from the first DVDR 320, the first radio unit 200B gives a NACK response, and also registers “9” as the logical address of the first DVDR 320 in the first logical address information 211 to update the temporary shared device list 210B. Now, the logical addresses registered in the first logical address information 211 are “0”, “4” and “9”. At this time, in order to check that the logical address of the first DVDR 320 has been truly updated, information such as a physical address may also be managed in association therewith.

Upon receipt of the “Report PA” command from the first DVDR 320, the PDP 300 recognizes that a new device has been connected, and thus additionally registers the logical address “9” for the first DVDR 320 in the PDP recognition list 301. The PDP 300 has not yet recognized that the logical address of the first DVDR 320 has been reacquired and changed from “1” to “9”. Thus, the logical address “9” is registered in addition to the already-registered logical addresses “1” and “4”.

When the first logical address information 211 is updated, the first radio unit 200B sends the temporary shared device list 210B to the second radio unit 400B (step S154). At this time, although the temporary shared device list 210B may be sent along with information regarding logical address duplication and the coincidence of the manufacturer IDs determined by the first radio unit 200B, in this third exemplary embodiment, the temporary shared device list 210B is solely sent.

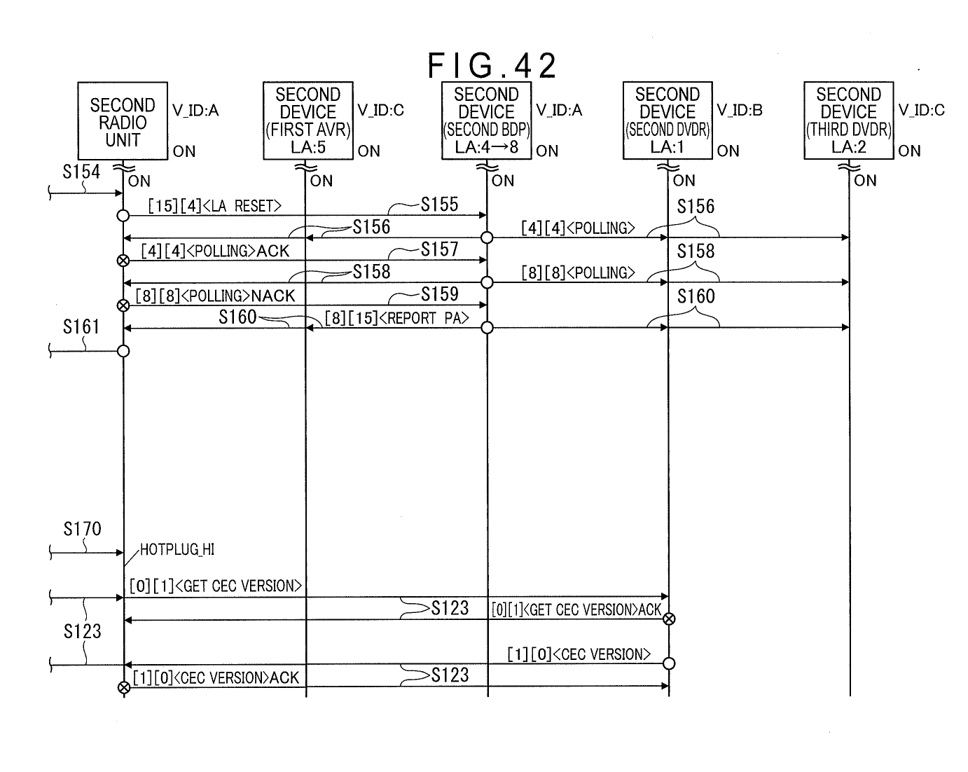

When receiving the temporary shared device list 210B, the second list manager 405B of the second radio unit 400B checks logical address duplication status and the manufacturer IDs as shown in FIG. 42. The second list manager 405B determines that the respective logical addresses of the first BDP 310 and the second BDP 510, which are playback devices, are duplicately “4”. Next, the second list manager 405B checks the respective manufacturer IDs of the first BDP 310 and the second BDP 510 having the duplicate logical addresses. Based on the connected second device information 214B, the second list manager 405B determines that the second BDP 510 has the same manufacturer ID as that of the first and second radio units 200B and 400B, i.e., the manufacturer ID “A”.

Then, based on the connected second device information 214B, since the second BDP 510 has the manufacturer ID “A” in the second CEC network 102 and is capable of recognizing and processing a vendor command, the second list manager 405B sends to the second BDP 510 an “LA Reset” command as a second reset command in which “4” is entered in the reception-side logical address area 912 (step S155).

Specifically, the second radio unit 400B checks the shared device list 210B managed thereby for any logical address duplication. If a logical-address-duplicated device is adapted to deal with an “LA Reset” command, the second radio unit 400B prompts reacquisition of a logical address to eliminate the logical address duplication between the first and second CEC networks 101 and 102. If neither of the devices having the duplicate logical address is adapted to recognize and process an “LA Reset” command, the logical address replacing process described in the second exemplary embodiment may be performed to eliminate the logical address duplication between the first and second CEC networks 101 and 102.

When receiving the “LA Reset” command, the second BDP 510 gives an ACK response. The second BDP 510 also discards its logical address, and then starts a logical address reacquiring process. Here, the second list manager 405B confirms the ACK response from the second BDP 510, and updates the temporary shared device list 210B by deleting a logical address to be reacquired, i.e., the logical address “4”, from the second logical address information 212 or by treating it as a reserved logical address.

The second BDP 510 first enters a logical address available for a playback device, i.e., the logical address “4”, and performs the polling command process to the second CEC network 102 (step S156).

In response to the polling command, each of the first AVR 500, the second DVDR 520 and the third DVDR 530 gives a NACK response. Based on the first logical address information 211 of the temporary shared device list 210B, the first radio unit 400B recognizes that the logical address of the first BDP 310 is “4” and gives an ACK response (step S157).

When recognizing this ACK response, the second BDP 510 determines that the logical address “4” has already been acquired by another device. Then, in order to confirm whether or not another assignable logical address “8” based on the logical address assignment information 800 is available, the second BDP 510 enters the logical address “8”, and again performs the polling command process to the second CEC network 102 (step S158).

In response to the polling command, each of the first AVR 500, the second DVDR 520 and the third DVDR 530 gives a NACK response. Based on the temporary shared device list 210B, the second radio unit 400B recognizes that no device is assigned with the logical address “8”, and gives a NACK response for reporting to the effect (step S159).

When receiving the NACK responses from the first AVR 500, the second DVDR 520, the third DVDR 530 and the second radio unit 400B, the second BDP 510 acquires and maintains “8” as its own logical address.

The second BDP 510 then broadcasts a “Report PA” command for reporting association between its logical address and its physical address to other devices (step S160).

When receiving the “Report PA” command from the second BDP 510, the second radio unit 400B gives a NACK response, and also registers “8” as the logical address of the second BDP 510 in the second logical address information 212 to update the temporary shared device list 210B, thereby obtaining the shared device list 210B. At this time, in order to check that the logical address of the second BDP 510 has been truly updated, information such as a physical address may also be managed in association therewith. Now that the logical addresses registered in the second logical address information 212 are “1”, “2”, “5” and “8”, the registration in the shared device list 210B is as shown in FIG. 37.

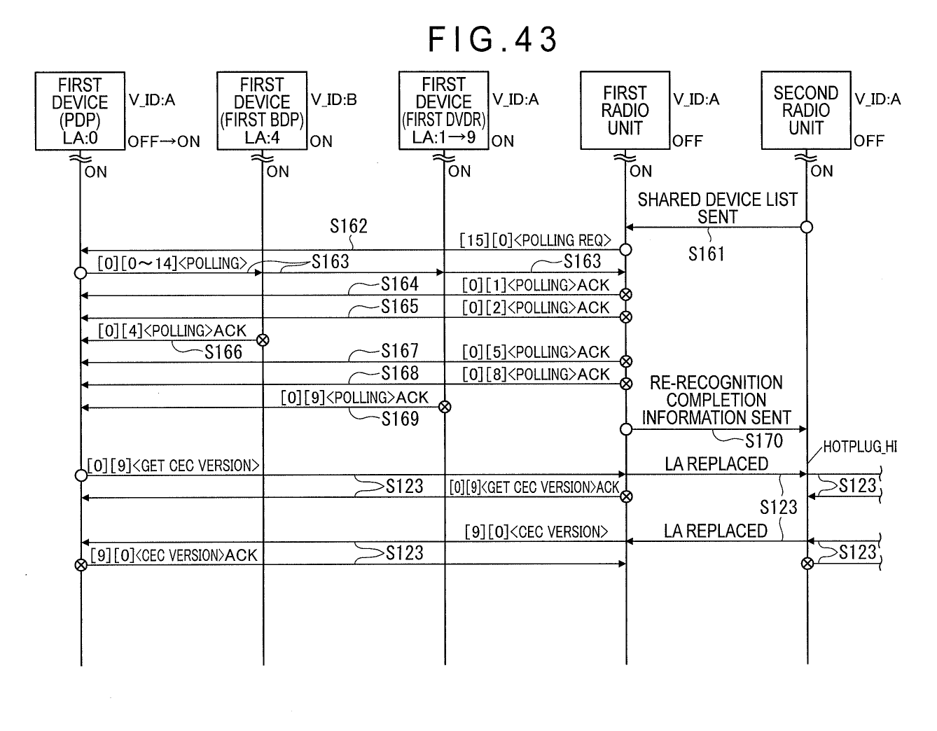

As shown also in FIG. 43, since the second logical address information 212 is updated, the second radio unit 400B sends the shared device list 210B to the first radio unit 200B (step S161). At this time, the second radio unit 400B may send the shared device list 210B along with the logical address duplication eliminating process completion information, the determination information of the shared device list 210B, and the like.

When receiving the shared device list 210B, the first list manager 205B of the first radio unit 200B requests the device re-recognition process for updating the PDP recognition list 301 based on a change of the logical address of the first DVDR 320 in the CEC network 101 from “1” to “9” by reacquisition and for additionally registering in the PDP recognition list 301 the first AVR 500, the second BDP 510, the second DVDR 520 and the third DVDR 530 of the second CEC network 102. Specifically, since the PDP 300 has the manufacturer ID “A” and is capable of recognizing and processing a vendor command, a “Polling Req” command is sent to the PDP 300 (step S162). If the PDP 300 is not capable of recognizing and processing a “Polling Req” command, the first and second radio units 200B and 400B may update the PDP recognition list 301 by sending “Give PA” commands to the devices of the first and second CEC networks 101 and 102 in accordance with the shared device list 210B and prompting the devices to send response commands, i.e., “Report PA” commands, as already described in the second exemplary embodiment.

When receiving the “Polling Req” command, the PDP 300 performs the polling command process to re-recognize the connected devices (step S163).

When the first radio unit 200B receives the header block 910 in which the logical address “1” among the logical addresses registered in the second logical address information 212 of the shared device list 210B is entered in the reception-side logical address area 912, the second radio unit 200B gives an ACK response for reporting the reception in place of the second DVDR 520; when receiving the header block 910 in which the logical address “2” is entered, the second radio unit 200B gives an ACK response in place of the third DVDR 530; when receiving the header block in which the logical address “5” is entered, the second radio unit 200B gives an ACK response in place of the first AVR 500; and when receiving the header block 910 in which the logical address “8” is entered, the second radio unit 200B gives an ACK response in place of the second BDP 510 (steps S164, S165, S167 and S168). Likewise, when the first BDP 310 receives the header block 910 in which the logical address “4” is entered in the reception-side logical address area 912, the first BDP 310 gives an ACK response for reporting the reception (step S166). When the first DVDR 320 receives the header block 910 in which the logical address “9” is entered in the reception-side logical address area 912, the first DVDR 320 gives an ACK response for reporting the reception (step S169).

Based on these ACK responses, the PDP 300 re-recognizes the respective logical addresses of the first BDP 310, the first DVDR 320, the first AVR 500, the second BDP 510, the second DVDR 520 and the third DVDR 530. The PDP 300 then generates and stores the PDP recognition list 301 shown in FIG. 44.

When the first radio unit 200B completes the logical address re-recognizing process to the PDP 300, the first radio unit 200B sends information for reporting the completion to the second radio unit 400B (step S170). When receiving the information, the second radio unit 400B switches the hotplug from LOW to HIGH as shown also in FIG. 42. Incidentally, the second radio unit 400B operates the hotplug at this timing for the purpose of suppressing CEC communication from the devices connected to the second CEC network 102. If such suppression is not particularly necessary, the hotplug can be switched from LOW to HIGH at any other timing.

Subsequently, the PDP 300 performs the process of step S123 for checking the version of the second DVDR 520 and the like in the same manner as in the second exemplary embodiment (step S123).

### Advantages of HDMI System of Third Exemplary Embodiment

As described above, the third exemplary embodiment can achieve the following advantages.

13. In the HDMI system 100B including the first and second radio units 200B and 400B, the PDP 300, the first BDP 310, the first DVDR 320, the first AVR 500, the second BDP 510, the second DVDR 520 and the third DVDR 530, when there are a plurality of devices of the same device type, and one of the plurality of devices and a device that needs to recognize all the devices on the CEC network, mainly such as a TV, are adapted to recognize and process vendor commands sent from the first and second radio units 200B and 400B, the following advantages are expected. Without any user's particular attention to a power-on timing of each device and a timing of connecting each device to the CEC network, it is possible to assign logical addresses to the devices on the CEC network without any duplication. Further, the PDP 300 can accurately recognize the connected devices on the CEC network, so that the PDP 300 can reliably send the CEC frame data 900 to the device intended to actually receive it.

14. In the HDMI system 100B including the first and second radio units 200B and 400B, the PDP 300, the first BDP 310, the first DVDR 320, the first AVR 500, the second BDP 510 and the second DVDR 420, when there are a plurality of devices of the same device type, and one of the plurality of devices and a device that needs to recognize all the devices on the CEC network, mainly such as a TV, are adapted to recognize and process vendor commands sent from the first and second radio units 200B and 400B, the following advantages are expected. Without any user's particular attention to how each device acquires an own logical address and how each device stores the acquired logical address, it is possible to assign logical addresses to the devices on the CEC network without any duplication. Further, the PDP 300 can accurately recognize the connected devices on the CEC network, so that the PDP 300 can reliably send the CEC frame data 900 to the device intended to actually receive it.

### Modifications of Exemplary Embodiments

Incidentally, the scope of the invention is not restricted to the above first and second exemplary embodiments, but includes the following modifications as long as an object of the invention can be achieved.

The first CEC network 101 may only include the PDP 300 and the second CEC network 102 may only include at least one of the second BDP 510, the second DVDR 520 and the third DVDR 530.

In each of the first and second CEC networks 101, 102, devices more than those in the above exemplary embodiments may be connected.

Each of the first CEC-side transmitter/receiver 201 of the first radio unit 200 and the second CEC-side transmitter/receiver 401 of the second radio unit 400 may be connected to the CEC signal line 103 at one or more wired medium connectors. For instance, when an HDMI cable is used as the wired medium, each of the first and second radio units 200 and 400 may be provided with a plurality of HDMI connectors.

The process performed by the first radio unit 200 to switch the DDC_{—}5V from OFF to ON after the elapse of an appropriate period of time may be omitted.

Although it is described above that the first list manager 205 is not adapted to recognize a change resulting from disconnection of the first devices 300, 310 and 320 and the second list manager 405 is not adapted to recognize a change resulting from disconnection of the second devices 500, 510, 520 and 530, the following technique may be employed. Specifically, in order to recognize a change of disconnection, the first list manager 204 may periodically send to the first CEC network 101 the polling command [recognition] process based on the CEC frame data 900 in which a logical address in accordance with the first logical address information 211 is entered in the reception-side logical address area 912 and the second list manager 405 may periodically send to the second CEC network 102 the polling command [recognition] process based on the CEC frame data 900 in which a logical address in accordance with the second logical address information 212 is entered in the reception-side logical address area 912.

The polling command intentionally sent from each of the first and second radio units 200 and 400 is not limited to either the polling command [acquirement] process for acquiring an own logical address or the polling command [recognition] process for recognizing the connected devices because both the polling command [acquirement] process and the polling command [recognition] process can provide the same result.

The first list manager 205 may not be provided with the function to generate the shared device list 210 including the replaced second logical address information 213. Further, the second radio unit 400 may be provided with the function to generate the shared device list 210 including the replaced second logical address information 213.

The first radio unit 200 may be provided with the function to replace the content of the reception-side logical address area 912 in accordance with the replaced second logical address information 213 for transmitting and receiving the CEC frame data 900.

The temporary second logical address information may be used as the second logical address information 212 without performing the processes of steps S27 to S31.

The second radio unit 400 may start the process for generating the second logical address information 212 after being turned on and before being connected. The second radio unit 400 may not perform the process for generating the second logical address information 212 even after being turned on.

The replacing process may be applied not only to the logical addresses but also to any information unique to connected devices, such as the physical addresses.

A wired medium such as an optical fiber or an HDMI cable may be used for transmission and reception of data between the first radio unit 200 and the second radio unit 400.

While the functions are realized in the form of programs in the above description, the functions may be realized in any form, e.g., a hardware such as a circuit board, an element such as an IC (Integrated Circuit), or the like. In view of easy handling and promotion of the use, the functions are preferably stored and read from programs or separate storage media.

The arrangements and the operating procedures for realizing the invention may be appropriately modified as long as an object of the invention can be achieved.

### Advantages of Exemplary Embodiments

As described above, in the above exemplary embodiments, when the first radio unit 200 receives the CEC frame data 900 from the PDP 300, the first radio unit 200 refers to the content of the reception-side logical address area 912 and recognizes that the initiator of this CEC frame data 900 is the second BDP 510 among a plurality of devices connected to the second radio unit 400. When the first radio unit 200 recognizes that the second BDP 510 is connected to the second radio unit 400 based on the second logical address information 212 of the shared device list 210, the first radio unit 200 substitutes for the second BDP 510 to give an ACK response for reporting the reception of the CEC frame data 900 by the second BDP 510, and sends the CEC frame data 900 to the second BDP 510.

With the above arrangement, even when there are a plurality of possible destinations such as the second devices 500, 510, 520 and 530, the PDP 300 can receive an ACK response sent from the first ACK response substitution executor 206 with high responsivity, the ACK response being considered to be sent from the second BDP 510 that actually receives the CEC frame data 900. Further, the CEC frame data 900 can be appropriately sent to the second BDP 510 from the PDP 300. It is not required to provide each of the second devices 500, 510, 520 and 530 with a function to use the radio medium M, so that complication of the arrangements of the second devices 500, 510, 520 and 530 can be avoided.

Even when the flow of the transmission and reception is inverted, i.e., the second BDP 510 is the transmission-side and the PDP 300 is the reception-side, by allowing the second radio unit 400 to operate in the same manner as the first radio unit 200, the second BDP 510 can receive an ACK response with high responsivity, the ACK response being considered to be sent from the PDP 300 that actually receives the CEC frame data 900 even when there are a plurality of possible destinations such as the first devices 300, 310 and 320. In addition, the second BDP 510 can appropriately send the CEC frame data 900 to the PDP 300.

It is not required to provide each of the first devices 300, 310 and 320 with a function to use the radio medium M, so that complication of the arrangements of the first devices 300, 310 and 320 can be avoided.

### INDUSTRIAL APPLICABILITY

The invention can be used as a data processor, a system therefor, a method therefor, a program therefor, and a storage medium storing the program.

### EXPLANATION OF CODES

100 . . . HDMI system as a data processing system
200 . . . first radio unit as a data processor and a computer
201 . . . first CEC-side transmitter/receiver as a data receiver or a reset command transmitter
202 . . . first radio-side transmitter/receiver as a data transmitter
204 . . . first memory as a processing-side memory
205 . . . first list manager also functioning as a replaced information association processor
205B . . . first list manager also functioning as a reset command generator
206 . . . first ACK response substitution executor
300, 310 and 320 . . . first devices
400 . . . second radio unit as a data transfer device
401 . . . second CEC-side transmitter/receiver also capable of functioning as a hotplug processor or a reset command transmitter
404 . . . second memory as a transfer-side memory
405 . . . second list manager also functioning as a second device information generator
405B . . . second list manager also functioning as a reset command generator
406 . . . second ACK response substitution executor also functioning as a data transferer
500, 510, 420 and 530 . . . second devices
900 . . . CEC frame data as processing data

1-14. (canceled)

15. A data processor that is connected to a plurality of first devices and a data transferer connected to a second device, and receive CEC frame data from any one of the plurality of first devices and transmit the CEC frame data to one of the rest of the first devices or the second device, the CEC frame data containing device information that is generated based on first device information as device information assigned to each of the first devices or second device information as device information assigned to the second device to specify a destination device, and command information that represents a command directed to the destination device, the device information having a content selected from a plurality of contents preset depending on types of device, the data processor comprising:
a processing-side memory that stores the first device information, first recognition ability information that represents whether or not each of the first devices is adapted to recognize a first reset command for instructing resetting the first device information to a different content, and the second device information;
a processing-side device information updater that updates the first device information in the processing-side memory in accordance with setting of the first device information of each of the first devices while updating the second device information in the processing-side memory to second device information updated by the data transferer;
a first reset command generator that operates when the first device information of one of the first devices is the same as the second device information in the processing-side memory to determine whether or not the first device corresponding to the first device information is adapted to recognize the first reset command based on the first recognition ability information, and the first reset command generator sending the first reset command to the first device when determining that the first device is adapted to recognize but not sending the first reset command to the first device when determining that the first device is not adapted to recognize;
a processing-side data transmitter that transmits the CEC frame data to each of the first devices when the information stored in the processing-side memory indicates that the device information in the CEC frame data is the same as the first device information, and transmits the CEC frame data to the second device via the data transferer when the information stored in the processing-side memory indicates that the device information in the CEC frame data is the same as the second device information; and
a processing-side device information transmitter that transmits the first device information in the processing-side memory to the data transferer.

16. A data processing system comprising: a data processor connected to a plurality of first devices; and
a data transferer connected to the data processor and a second device so that the data processor receives CEC frame data from one of the plurality of first devices and transmits the CEC frame data to one of the rest of the first devices or the second device, wherein
the CEC frame data contains device information that is generated based on first device information as device information assigned to each of the first devices or second device information as device information assigned to the second device to specify a destination device and command information that represents a command directed to the destination device,
the device information has a content selected from a plurality of contents preset depending on types of device,
the data processor comprises:
a processing-side memory that stores the first device information, first recognition ability information that represents whether or not each of the first devices is adapted to recognize a first reset command for instructing resetting the first device information to a different content, and the second device information;
a processing-side device information updater that updates the first device information in the processing-side memory in accordance with setting of the first device information of each of the first devices while updating the second device information in the processing-side memory to second device information updated by the data transferer;
a first reset command generator that operates when the first device information of one of the first devices is the same as the second device information in the processing-side memory to determine whether or not the first device corresponding to the first device information is adapted to recognize the first reset command based on the first recognition ability information, the first reset command generator sending the first reset command to the first device when determining that the first device is adapted to recognize but not sending the first reset command to the first device when determining that the first device is not adapted to recognize;
a processing-side data transmitter that transmits the CEC frame data to each of the first devices when the information stored in the processing-side memory indicates that the device information in the CEC frame data is the same as the first device information, and transmits the CEC frame data to the second device via the data transferer when the information stored in the processing-side memory indicates that the device information in the CEC frame data is the same as the second device information; and
a processing-side device information transmitter that transmits the first device information in the processing-side memory to the data transferer, and
the data transferer comprises:
a transfer-side memory that stores the first device information, the second device information and second recognition ability information that represents whether or not the second device is adapted to recognize a second reset command for instructing resetting the second device information to a different content;
a transfer-side device information updater that updates the second device information in the transfer-side memory in accordance with setting of the second device information of the second device while updating the first device information in the transfer-side memory to first device information sent from the data processor;
a second reset command generator that operates when the second device information is the same as the first device information of one of the first devices in the transfer-side memory to determine whether or not the second device corresponding to the second device information is adapted to recognize the second reset command based on the second recognition ability information, the second reset command generator sending the second reset command to the second device when determining that the second device is adapted to recognize but not sending the second reset command to the second device when determining that the second device is not adapted to recognize;
a transfer-side data transmitter that transmits the CEC frame data to the second device when the information stored in the transfer-side memory indicates that the device information in the CEC frame data is the same as the second device information; and
a transfer-side device information transmitter that transmits the second device information in the transfer-side memory to the data processor.

17. The data processing system according to claim 16, wherein
the data processor comprises:
a replaced information association processor that operates when recognizing that the second device information is the same as the first device information of one of the first devices in the processing-side memory to instruct the processing-side memory to store replaced second device information in association with the second device information that is the same as the first device information, the replaced second device information having a content different from the content of the second device information and being assignable to the type of the second device; and
an ACK response substitution executor that substitutes for the second device to give an ACK response for reporting to the effect that the CEC frame data was received by the second device specified by the second device information when the information stored in the processing-side memory indicates that the device information contained in the CEC frame data is the same as the second device information not associated with the replaced second device information, and substitutes for the second device to give an ACK response to the effect that the CEC frame data was received by the second device information specified by the second device information associated with the replaced second device information when the device information contained in the CEC frame data is the same as the replaced second device information,
the CEC frame data is generated based on the first device information, the replaced second device information, or the second device information not associated with the replaced second device information,
the processing-side data transmitter of the data processor transmits the CEC frame data to the data transferer when the device information in the CEC frame data is the same as the second device information not associated with the replaced second device information or as the replaced second device information,
the processing-side device information transmitter of the data processor transmits the replaced second device information and the second device information associated with the replaced second device information to the data transferer,
the transfer-side device information updater of the data transferer updates the second device information in the transfer-side memory to the second device information sent from the data processor while instructing the transfer-side memory to store the replaced second device information with which the second device information is associated, and
the transfer-side data transmitter of the data transferer transmits the CEC frame data to the second device when the information stored in the transfer-side memory indicates that the device information in the CEC frame data is the same as the second device information not associated with the replaced second device information, and transmits the CEC frame data to the second device specified by the second device information associated with the replaced second device information when the device information in the CEC frame data is the same as the replaced second device information.

18. The data processing system according to claim 16, wherein
the second device includes a plurality of second devices,
the data transfer device further comprises a second device information generator that confirms the plurality of second devices upon recognizing that power is supplied, generates a plurality of second device information as device information assigned to the confirmed plurality of second devices, and sends the plurality of second device information to the data processor, and
the data processor instructs the processing-side memory to store the second device information sent from the second device information generator.

19. The data processing system according to claim 16, wherein
the second device information generator generates the second device information when recognizing that the second device information generator is connected to the data processor.

20. The data processing system according to claim 16, wherein
the second device information generator generates the second device information when detecting that connection relationship of any one of the plurality of second devices has been changed.

21. A data processing method using a data transferer connected to a second device and a computer connected to a plurality of first devices for receiving CEC frame data from any one of the plurality of the first devices and transmitting the CEC frame data to one of the rest of the first devices or the second device, the CEC frame data containing device information that is generated based on first device information as device information assigned to each of the first devices or second device information as device information assigned to the second device to specify a destination device, and command information that represents a command directed to the destination device, the device information having a content selected from a plurality of contents preset depending on types of device, the computer comprising a processing-side memory that stores the first device information, first recognition ability information that represents whether or not each of the first devices is adapted to recognize a first reset command for instructing resetting the first device information to a different content, and the second device information, the method comprising:
a processing-side device information updating step updating the first device information in the processing-side memory in accordance with setting of the first device information of each of the first devices while updating the second device information in the processing-side memory to second device information updated by the data transferer;
a first reset command generating step performed when the first device information of one of the first devices is the same as the second device information in the processing-side memory to determine whether or not the first device corresponding to the first device information is adapted to recognize the first reset command based on the first recognition ability information, and sending the first reset command to the first device when determining that the first device is adapted to recognize but not sending the first reset command to the first device when determining that the first device is not adapted to recognize;
a processing-side data transmitting step transmitting the CEC frame data to each of the first devices when the information stored in the processing-side memory indicates that the device information in the CEC frame data is the same as the first device information, and transmitting the CEC frame data to the second device via the data transferer when the information stored in the processing-side memory indicates that the device information in the CEC frame data is the same as the second device information; and
a processing-side device information transmitting step transmitting the first device information in the processing-side memory to the data transferer.

22. A data processing method using a first computer connected to a plurality of first devices and a second computer connected to the first computer and a second device for receiving CEC frame data from any one of the plurality of first devices by the first computer and transmitting the CEC frame data to one of the rest of the first devices or the second device, wherein the CEC frame data contains device information that is generated based on first device information as device information assigned to each of the first devices or second device information as device information assigned to the second device to specify a destination device, and command information that represents a command directed to the destination device,
the device information has a content selected from a plurality of contents preset depending on types of device,
the first computer comprises a processing-side memory that stores the first device information, first recognition ability information that represents whether or not each of the first devices is adapted to recognize a first reset command for instructing resetting the first device information to a different content, and the second device information, and performs:
a processing-side device information updating step updating the first device information in the processing-side memory in accordance with setting of the first device information of each of the first devices while updating the second device information in the processing-side memory to second device information updated by the second computer;
a first reset command generating step performed when the first device information of one of the first devices is the same as the second device information in the processing-side memory to determine whether or not the first device corresponding to the first device information is adapted to recognize the first reset command based on the first recognition ability information, and sending the first reset command to the first device when determining that the first device is adapted to recognize but not sending the first reset command to the first device when determining that the first device is not adapted to recognize;
a processing-side data transmitting step transmitting the CEC frame data to each of the first devices when the information stored in the processing-side memory indicates that the device information in the CEC frame data is the same as the first device information, and transmitting the CEC frame data to the second device via the second computer when the device information in the CEC frame data is the same as the second device information; and
a processing-side device information transmitting step transmitting the first device information in the processing-side memory to the second computer, and
the second computer comprises a transfer-side memory that stores the first device information, the second device information and second recognition ability information that represents whether or not the second device is adapted to recognize a second reset command for instructing resetting the second device information to a different content, and performs:
a transfer-side device information updating step updating the second device information in the transfer-side memory in accordance with setting of the second device information of the second device while updating the first device information in the transfer-side memory to first device information sent from the first computer;
a second reset command generating step performed when the second device information is the same as the first device information of one of the first devices in the transfer-side memory to determine whether or not the second device corresponding to the second device information is adapted to recognize the second reset command based on the second recognition ability information, and sending the second reset command to the second device when determining that the second device is adapted to recognize but not sending the second reset command to the second device when determining that the second device is not adapted to recognize;
a transfer-side data transmitting step transmitting the CEC frame data to the second device when the information stored in the transfer-side memory indicates that the device information in the CEC frame data is the same as the second device information; and
a transfer-side device information transmitting step transmitting the second device information in the transfer-side memory to the first computer.

23. A storage medium storing a data processing program allowing a computer to perform the data processing method according to claim 21 in a computer-readable manner.
